(19) United States
(12) Patent Application Publication
(10) Pub. No.: US 2022/0383552 A1
(43) Pub. Date: Dec. 1, 2022

(54) POINT CLOUD DATA TRANSMISSION DEVICE, POINT CLOUD DATA TRANSMISSION METHOD, POINT CLOUD DATA RECEPTION DEVICE, AND POINT CLOUD DATA RECEPTION METHOD

(71) Applicant: LG Electronics Inc., Seoul (KR)

(72) Inventors: Hyejung HUR, Seoul (KR); Sejin OH, Seoul (KR)

(21) Appl. No.: 17/640,695

(22) PCT Filed: Sep. 7, 2020
(86) PCT No.: PCT/KR2020/012065

§ 371 Date: Mar. 4, 2022

(30) Foreign Application Priority Data
Sep. 5, 2019 (KR) 10-2019-0109876

(51) Int. Cl. G06T 9/00; G06T 17/00

(52) U.S. Cl. CPC G06T 9/001; G06T 17/00; G06T 2210/36

(57) ABSTRACT

A point cloud data transmission method according to embodiments may comprise the steps of: acquiring point cloud data; encoding geometry information of the point cloud data; encoding attribute information of the point cloud data on the basis of the geometry information; and transmitting a bitstream including the encoded geometry information, the encoded attribute information, and signaling information.

### TECHNICAL FIELD

Embodiments relate to a method and apparatus for processing point cloud content.

### BACKGROUND ART

Point cloud content is content represented by a point cloud, which is a set of points belonging to a coordinate system representing a three-dimensional space. The point cloud content may express media configured in three dimensions, and is used to provide various services such as virtual reality (VR), augmented reality (AR), mixed reality (MR), XR (Extended Reality), and self-driving services. However, tens of thousands to hundreds of thousands of point data are required to represent point cloud content. Therefore, there is a need for a method for efficiently processing a large amount of point data.

### DISCLOSURE

### Technical Problem

An object of the present disclosure devised to solve the above-described problems is to provide a point cloud data transmission device, a point cloud data transmission method, a point cloud data reception device, and a point cloud data reception method for efficiently transmitting and receiving a point cloud

Another object of the present disclosure is to provide a point cloud data transmission device, a point cloud data transmission method, a point cloud data reception device, and a point cloud data reception method for addressing latency and encoding/decoding complexity.

Another object of the present disclosure is to provide a point cloud data transmission device, a point cloud data transmission method, a point cloud data reception device, and a point cloud data reception method for improving the compression performance of the point cloud by improving the encoding technique for the geometry of geometry-based point cloud compression (G-PCC).

Another object of the present disclosure is to provide a point cloud data transmission device, a point cloud data transmission method, a point cloud data reception device, and a point cloud data reception method for improving processing of duplicated points generated through geometry quantization and voxelization in the G-PCC geometry encoding and decoding process, such that the degree of geometry loss may be predictably adjusted.

Objects of the present disclosure are not limited to the aforementioned objects, and other objects of the present disclosure which are not mentioned above will become apparent to those having ordinary skill in the art upon examination of the following description.

### Technical Solution

To achieve these objects and other advantages and in accordance with the purpose of the disclosure, as embodied and broadly described herein, a method of transmitting point cloud data may include acquiring the point cloud data, encoding geometry information of the point cloud data, encoding attribute information of the point cloud data based on the geometry information, and transmitting a bitstream containing the encoded geometry information, the encoded attribute information, and signaling information.

According to embodiments, the encoding of the geometry information may include voxelizing the geometry information, partitioning the voxel into sub-voxels according to a number of points included in the voxel when a plurality of points are included in a voxel through voxelization, generating occupancy bits of the partitioned sub-voxels, and reconstructing a geometry by performing geometry information prediction based on the generated occupancy bits.

According to embodiments, the encoding of the attribute information may include generating levels of detail (LODs) by sorting all points of the reconstructed geometry based on a Morton code, searching for neighbor points for each of the points based on the LODs, acquiring a predicted attribute value of each of the points based on a prediction mode of each of the points, and acquiring a residual attribute value based on the predicted attribute value and an original attribute value for each of the points.

According to embodiments, the signaling information includes duplicated point processing related option information, and the duplicated point processing related option information includes at least one of information for indicating whether the voxel is partitioned into the sub-voxels, information for indicating a partitioning method for the sub-voxels, information for indicating a sorting method for the sub-voxels, or information for indicating whether to apply points of the sub-voxels to attribute encoding.

According to embodiments, the signaling information including the duplicated point processing related option information is at least one of a geometry parameter set, a tile parameter set, or a geometry slice header.

According to embodiments, an apparatus for transmitting point cloud data may included an acquirer configured to acquire the point cloud data, a geometry encoder configured to encode geometry information of the point cloud data, an attribute encoder configured to encode attribute information of the point cloud data based on the geometry information, and a transmitter configured to transmit a bitstream containing the encoded geometry information, the encoded attribute information, and signaling information.

According to embodiments, the geometry encoder may include a voxelization processor configured to voxelize the geometry information, a partitioner configured to partition the voxel into sub-voxels according to a number of points included in the voxel when a plurality of points are included in a voxel through voxelization, an occupancy bit generator configured to generate occupancy bits of the partitioned sub-voxels, and a reconstructor configured to reconstruct a geometry by performing geometry information prediction based on the generated occupancy bits.

According to embodiments, the attribute encoder may include an LOD configurator configured to generate levels of detail (LODs) by sorting all points of the reconstructed geometry based on a Morton code, a neighbor set configurator configured to search for neighbor points for each of the points based on the LODs, an attribute information predictor configured to acquire a predicted attribute value of each of the points based on a prediction mode of each of the points, and a residual attribute information acquirer configured to acquire a residual attribute value based on the predicted attribute value and an original attribute value for each of the points.

According to embodiments, the signaling information includes duplicated point processing related option information, and the duplicated point processing related option information includes at least one of information for indicating whether the voxel is partitioned into the sub-voxels, information for indicating a partitioning method for the sub-voxels, information for indicating a sorting method for the sub-voxels, or information for indicating whether to apply points of the sub-voxels to attribute encoding.

According to embodiments, the signaling information including the duplicated point processing related option information is at least one of a geometry parameter set, a tile parameter set, or a geometry slice header.

According to embodiments, a method of receiving point cloud data may include receiving a bitstream containing geometry information, attribute information, and signaling information, decoding the geometry information based on the signaling information, decoding the attribute information based on the signaling information and the geometry information, and rendering point cloud data restored based on the decoded geometry information and the decoded attribute information.

According to embodiments, the decoding of the geometry information may include reconstructing points based on occupancy bits of received sub-voxels based on the signaling information, and reconstructing a geometry by performing geometry information prediction based on the reconstructed points.

According to embodiments, the decoding of the attribute information may include generating levels of detail (LODs) by sorting all points of the reconstructed geometry based on a Morton code, searching for neighbor points for each of the points based on the LODs, acquiring a predicted attribute value of each of the points based on a prediction mode of each of the points, and restoring original attribute values based on the predicted attribute value of each of the points and received residual attribute values.

According to embodiments, the signaling information includes duplicated point processing related option information, and the duplicated point processing related option information includes at least one of information for indicating whether the voxel is partitioned into the sub-voxels, information for indicating a partitioning method for the sub-voxels, information for indicating a sorting method for the sub-voxels, or information for indicating whether to apply points of the sub-voxels to attribute encoding.

According to embodiments, the signaling information including the duplicated point processing related option information is at least one of a geometry parameter set, a tile parameter set, or a geometry slice header.

According to embodiments, an apparatus for receiving point cloud data may include a receiver configured to receive a bitstream containing geometry information, attribute information, and signaling information, a geometry decoder configured to decode the geometry information based on the signaling information, an attribute decoder configured to decode the attribute information based on the signaling information and the geometry information, and a renderer configured to render point cloud data restored based on the decoded geometry information and the decoded attribute information.

According to embodiments, the geometry decoder may include a point reconstructor configured to reconstruct points based on occupancy bits of received sub-voxels based on the signaling information, and a geometry reconstructor configured to reconstruct a geometry by performing geometry information prediction based on the reconstructed points.

According to embodiments, the attribute decoder may include an LOD configurator configured to generate levels of detail (LODs) by sorting all points of the reconstructed geometry based on a Morton code, a neighbor set configurator configured to search for neighbor points for each of the points based on the LODs, an attribute information predictor configured to acquire a predicted attribute value of each of the points based on a prediction mode of each of the points, and an attribute information restorer configured to restore original attribute values based on the predicted attribute value of each of the points and received residual attribute values.

According to embodiments, the signaling information includes duplicated point processing related option information, and the duplicated point processing related option information includes at least one of information for indicating whether the voxel is partitioned into the sub-voxels, information for indicating a partitioning method for the sub-voxels, information for indicating a sorting method for the sub-voxels, or information for indicating whether to apply points of the sub-voxels to attribute encoding.

According to embodiments, the signaling information including the duplicated point processing related option information is at least one of a geometry parameter set, a tile parameter set, or a geometry slice header.

### Advantageous Effects

A point cloud data transmission method, a point cloud data transmission device, a point cloud data reception method, and a point cloud data reception device according to embodiments may provide a good-quality point cloud service.

A point cloud data transmission method, a point cloud data transmission device, a point cloud data reception method, and a point cloud data reception device according to embodiments may achieve various video codec methods.

A point cloud data transmission method, a point cloud data transmission device, a point cloud data reception method, and a point cloud data reception device according to embodiments may provide universal point cloud content such as a self-driving service (or an autonomous driving service).

A point cloud data transmission method, a point cloud data transmission device, a point cloud data reception method, and a point cloud data reception device according to embodiments may perform space-adaptive partition of point cloud data for independent encoding and decoding of the point cloud data, thereby improving parallel processing and providing scalability.

A point cloud data transmission method, a point cloud data transmission device, a point cloud data reception method, and a point cloud data reception device according to embodiments may perform encoding and decoding by spatially partitioning the point cloud data in units of tiles and/or slices, and signal necessary data therefore, thereby improving encoding and decoding performance of the point cloud.

A point cloud data transmission device, a point cloud data transmission method, a point cloud data reception device, and a point cloud data reception method according to embodiments may improve the compression performance of the point cloud by improving the encoding technique for the geometry of G-PCC.

A point cloud data transmission device, a point cloud data transmission method, a point cloud data reception device, and a point cloud data reception method according to embodiments may improve processing of a plurality of points included in a voxel, thereby reducing the degree to which geometry loss changes unpredictably according to the characteristics of content and the geometry quantization value.

A point cloud data transmission device, a point cloud data transmission method, a point cloud data reception device, and a point cloud data reception method according to embodiments may improve processing of a plurality of points included in a voxel, thereby increasing a peak signal-to-noise ratio (PSNR).

A point cloud data transmission device, a point cloud data transmission method, a point cloud data reception device, and a point cloud data reception method according to embodiments may improve processing of a plurality of points included in a voxel, thereby improving visual quality.

A point cloud data transmission device, a point cloud data transmission method, a point cloud data reception device, and a point cloud data reception method according to embodiments may improve processing of a plurality of points included in a voxel, thereby providing better visual quality without significantly increasing the bitstream size.

A point cloud data transmission device, a point cloud data transmission method, a point cloud data reception device, and a point cloud data reception method according to embodiments may improve processing of a plurality of points included in a voxel. Thereby, the degree of geometry loss may be predictably adjusted.

A point cloud data transmission device, a point cloud data transmission method, a point cloud data reception device, and a point cloud data reception method according to embodiments may improve processing of a plurality of points included in a voxel, thereby adjusting a degree of damage and an increasing size of a bitstream. Accordingly, the compression efficiency of geometry or attributes may be increased.

A point cloud data transmission device, a point cloud data transmission method, a point cloud data reception device, and a point cloud data reception method according to embodiments may perform lossy compression on a geometry according to a quantization value for predicting a loss of the geometry regardless of the density of content or a region of the content, and may virtually extend the length of the tree when the density is high, and thus the number of points belonging to one voxel is greater than a limit of the maximum number of points that may be included, thereby enabling predictable geometry loss.

### DESCRIPTION OF DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 illustrates an exemplary point cloud content providing system according to embodiments.

FIG. 2 is a block diagram illustrating a point cloud content providing operation according to embodiments.

FIG. 3 illustrates an exemplary process of capturing a point cloud video according to embodiments.

FIG. 4 illustrates an exemplary block diagram of point cloud video encoder according to embodiments.

FIG. 5 illustrates an example of voxels in a 3D space according to embodiments.

FIG. 6 illustrates an example of octree and occupancy code according to embodiments.

FIG. 7 illustrates an example of a neighbor node pattern according to embodiments.

FIG. 8 illustrates an example of point configuration of a point cloud content for each LOD according to embodiments.

FIG. 9 illustrates an example of point configuration of a point cloud content for each LOD according to embodiments.

FIG. 10 illustrates an example of a block diagram of a point cloud video decoder according to embodiments.

FIG. 11 illustrates an example of a point cloud video decoder according to embodiments.

FIG. 12 illustrates a configuration for point cloud video encoding of a transmission device according to embodiments.

FIG. 13 illustrates a configuration for point cloud video decoding of a reception device according to embodiments.

FIG. 14 illustrates an exemplary structure operatively connectable with a method/device for transmitting and receiving point cloud data according to embodiments.

FIG. 15 illustrates an example of a point cloud transmission device according to embodiments.

FIGS. 16a to 16c illustrate an embodiment of partitioning a bounding box into one or more tiles.

FIG. 17 illustrates an example of a geometry encoder and an attribute encoder according to embodiments.

FIG. 18 is a table showing an example of presence of a plurality of points in a voxel of specific content according to embodiments.

FIGS. 19a and 19b are graphs depicting examples of presence of a different number of points in different voxels of the same content according to embodiments.

FIGS. 20a and 20b illustrate a case where duplicated points are merged after quantization by applying the same quantization parameter to the same image and a case where the duplicated points are not merged after the quantization according to embodiments.

FIG. 21 is a table showing examples of a difference in image quality according to whether duplicated points are merged according to embodiments.

FIG. 22a shows an example of sorting sub-voxels according to a scheme of Morton code generation according to embodiments.

FIG. 22b shows an example of sorting sub-voxels according to a scheme of octree occupancy bit generation according to embodiments.

FIG. 23 is a block diagram illustrating an exemplary device for adaptive duplicated point processing according to embodiments.

FIG. 24 is a flowchart illustrating an example of a method for adaptive duplicated point processing according to embodiments.

FIG. 25 illustrates another example of a point cloud reception device according to embodiments.

FIG. 26 is a detailed block diagram illustrating an example of a geometry decoder and an attribute decoder for adaptive duplicated point processing according to embodiments.

FIG. 27 is a flowchart illustrating an example of a method for adaptive duplicated point processing by the geometry decoder according to embodiments.

FIG. 28 illustrates an exemplary bitstream structure for point cloud data for transmission/reception according to embodiments.

FIG. 29 illustrates an exemplary bitstream structure for point cloud data according to embodiments.

FIG. 30 illustrates a connection relationship between components in a bitstream of point cloud data according to embodiments.

FIG. 31 illustrates an embodiment of a syntax structure of a sequence parameter set according to embodiments.

FIG. 32 illustrates an embodiment of a syntax structure of a geometry parameter set according to embodiments.

FIG. 33 illustrates an embodiment of a syntax structure of an attribute parameter set according to embodiments.

FIG. 34 illustrates an embodiment of a syntax structure of a tile parameter set according to embodiments.

FIG. 35 illustrates an embodiment of a syntax structure of geometry slice bitstream( ) according to embodiments.

FIG. 36 illustrates an embodiment of a syntax structure of geometry slice header according to embodiments.

FIG. 37 illustrates an embodiment of a syntax structure of geometry slice data according to embodiments.

FIG. 38 illustrates an embodiment of a syntax structure of attribute slice bitstream( ) according to embodiments.

FIG. 39 illustrates another embodiment of a syntax structure of attribute slice bitstream( ) according to embodiments.

FIG. 40 illustrates an embodiment of a syntax structure of attribute slice header according to embodiments.

FIG. 41 illustrates an embodiment of a syntax structure of attribute slice data according to embodiments.

FIG. 42 is a flowchart of a method of transmitting point cloud data according to embodiments.

FIG. 43 is a flowchart of a method of receiving point cloud data according to embodiments.

### BEST MODE

Description will now be given in detail according to exemplary embodiments disclosed herein, with reference to the accompanying drawings. For the sake of brief description with reference to the drawings, the same or equivalent components may be assigned the same reference numbers, and description thereof will not be repeated. It should be noted that the following examples are only for embodying the present disclosure and do not limit the scope of the present disclosure. What can be easily inferred by an expert in the technical field to which the present invention belongs from the detailed description and examples of the present disclosure is to be interpreted as being within the scope of the present disclosure.

The detailed description in this present specification should be construed in all aspects as illustrative and not restrictive. The scope of the disclosure should be determined by the appended claims and their legal equivalents, and all changes coming within the meaning and equivalency range of the appended claims are intended to be embraced therein.

Reference will now be made in detail to the preferred embodiments of the present disclosure, examples of which are illustrated in the accompanying drawings. The detailed description, which will be given below with reference to the accompanying drawings, is intended to explain exemplary embodiments of the present disclosure, rather than to show the only embodiments that can be implemented according to the present disclosure. The following detailed description includes specific details in order to provide a thorough understanding of the present disclosure. However, it will be apparent to those skilled in the art that the present disclosure may be practiced without such specific details. Although most terms used in this specification have been selected from general ones widely used in the art, some terms have been arbitrarily selected by the applicant and their meanings are explained in detail in the following description as needed. Thus, the present disclosure should be understood based upon the intended meanings of the terms rather than their simple names or meanings. In addition, the following drawings and detailed description should not be construed as being limited to the specifically described embodiments, but should be construed as including equivalents or substitutes of the embodiments described in the drawings and detailed description.

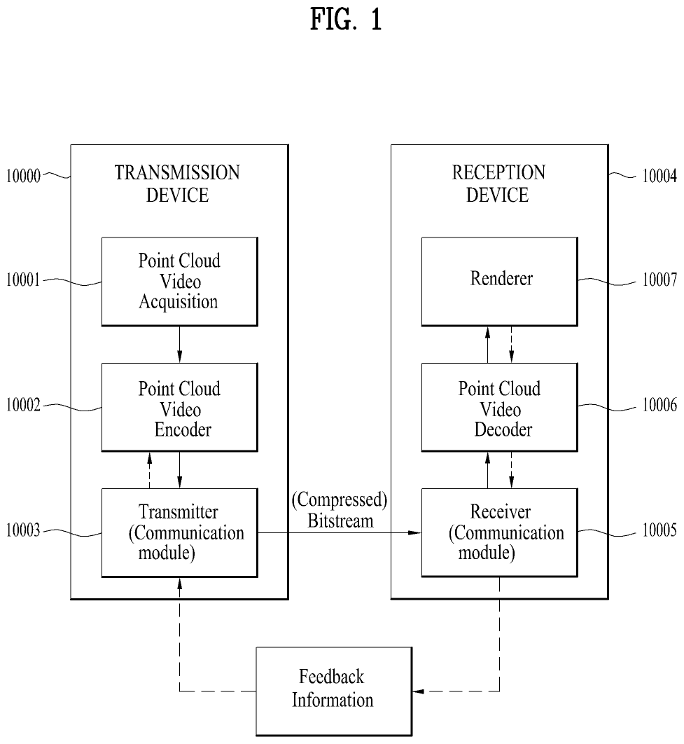

FIG. 1 shows an exemplary point cloud content providing system according to embodiments.

The point cloud content providing system illustrated in FIG. 1 may include a transmission device 10000 and a reception device 10004. The transmission device 10000 and the reception device 10004 are capable of wired or wireless communication to transmit and receive point cloud data.

The point cloud data transmission device 10000 according to the embodiments may secure and process point cloud video (or point cloud content) and transmit the same. According to embodiments, the transmission device 10000 may include a fixed station, a base transceiver system (BTS), a network, an artificial intelligence (AI) device and/or system, a robot, an AR/VR/XR device and/or server. According to embodiments, the transmission device 10000 may include a device, a robot, a vehicle, an AR/VR/XR device, a portable device, a home appliance, an Internet of Thing (IoT) device, and an AI device/server which are configured to perform communication with a base station and/or other wireless devices using a radio access technology (e.g., 5G New RAT (NR), Long Term Evolution (LTE)).

The transmission device 10000 according to the embodiments includes a point cloud video acquisition unit 10001, a point cloud video encoder 10002, and/or a transmitter (or communication module) 10003.

The point cloud video acquisition unit 10001 according to the embodiments acquires a point cloud video through a processing process such as capture, synthesis, or generation. The point cloud video is point cloud content represented by a point cloud, which is a set of points positioned in a 3D space, and may be referred to as point cloud video data. The point cloud video according to the embodiments may include one or more frames. One frame represents a still image/picture. Therefore, the point cloud video may include a point cloud image/frame/picture, and may be referred to as a point cloud image, frame, or picture.

The point cloud video encoder 10002 according to the embodiments encodes the acquired point cloud video data. The point cloud video encoder 10002 may encode the point cloud video data based on point cloud compression coding. The point cloud compression coding according to the embodiments may include geometry-based point cloud compression (G-PCC) coding and/or video-based point cloud compression (V-PCC) coding or next-generation coding. The point cloud compression coding according to the embodiments is not limited to the above-described embodiment. The point cloud video encoder 10002 may output a bitstream containing the encoded point cloud video data. The bitstream may contain not only the encoded point cloud video data, but also signaling information related to encoding of the point cloud video data.

The transmitter 10003 according to the embodiments transmits the bitstream containing the encoded point cloud video data. The bitstream according to the embodiments is encapsulated in a file or segment (for example, a streaming segment), and is transmitted over various networks such as a broadcasting network and/or a broadband network. Although not shown in the figure, the transmission device 10000 may include an encapsulator (or an encapsulation module) configured to perform an encapsulation operation. According to embodiments, the encapsulator may be included in the transmitter 10003. According to embodiments, the file or segment may be transmitted to the reception device 10004 over a network, or stored in a digital storage medium (e.g., USB, SD, CD, DVD, Blu-ray, HDD, SSD, etc.). The transmitter 10003 according to the embodiments is capable of wired/wireless communication with the reception device 10004 (or the receiver 10005) over a network of 4G, 5G, 6G, etc. In addition, the transmitter may perform a necessary data processing operation according to the network system (e.g., a 4G, 5G or 6G communication network system). The transmission device 10000 may transmit the encapsulated data in an on-demand manner.

The reception device 10004 according to the embodiments includes a receiver 10005, a point cloud video decoder 10006, and/or a renderer 10007. According to embodiments, the reception device 10004 may include a device, a robot, a vehicle, an AR/VR/XR device, a portable device, a home appliance, an Internet of Things (IoT) device, and an AI device/server which are configured to perform communication with a base station and/or other wireless devices using a radio access technology (e.g., 5G New RAT (NR), Long Term Evolution (LTE)).

The receiver 10005 according to the embodiments receives the bitstream containing the point cloud video data or the file/segment in which the bitstream is encapsulated from the network or storage medium. The receiver 10005 may perform necessary data processing according to the network system (for example, a communication network system of 4G, 5G, 6G, etc.). The receiver 10005 according to the embodiments may decapsulate the received file/segment and output a bitstream. According to embodiments, the receiver 10005 may include a decapsulator (or a decapsulation module) configured to perform a decapsulation operation. The decapsulator may be implemented as an element (or component or module) separate from the receiver 10005.

The point cloud video decoder 10006 decodes the bitstream containing the point cloud video data. The point cloud video decoder 10006 may decode the point cloud video data according to the method by which the point cloud video data is encoded (for example, in a reverse process of the operation of the point cloud video encoder 10002). Accordingly, the point cloud video decoder 10006 may decode the point cloud video data by performing point cloud decompression coding, which is the inverse process of the point cloud compression. The point cloud decompression coding includes G-PCC coding.

The renderer 10007 renders the decoded point cloud video data. The renderer 10007 may output point cloud content by rendering not only the point cloud video data but also audio data. According to embodiments, the renderer 10007 may include a display configured to display the point cloud content. According to embodiments, the display may be implemented as a separate device or component rather than being included in the renderer 10007.

The arrows indicated by dotted lines in the drawing represent a transmission path of feedback information acquired by the reception device 10004. The feedback information is information for reflecting interactivity with a user who consumes the point cloud content, and includes information about the user (e.g., head orientation information, viewport information, and the like). In particular, when the point cloud content is content for a service (e.g., self-driving service, etc.) that requires interaction with the user, the feedback information may be provided to the content transmitting side (e.g., the transmission device 10000) and/or the service provider. According to embodiments, the feedback information may be used in the reception device 10004 as well as the transmission device 10000, or may not be provided.

The head orientation information according to embodiments is information about the user's head position, orientation, angle, motion, and the like. The reception device 10004 according to the embodiments may calculate the viewport information based on the head orientation information. The viewport information may be information about a region of a point cloud video that the user is viewing. A viewpoint is a point through which the user is viewing the point cloud video, and may refer to a center point of the viewport region. That is, the viewport is a region centered on the viewpoint, and the size and shape of the region may be determined by a field of view (FOV). Accordingly, the reception device 10004 may extract the viewport information based on a vertical or horizontal FOV supported by the device in addition to the head orientation information. Also, the reception device 10004 performs gaze analysis or the like to check the way the user consumes a point cloud, a region that the user gazes at in the point cloud video, a gaze time, and the like. According to embodiments, the reception device 10004 may transmit feedback information including the result of the gaze analysis to the transmission device 10000. The feedback information according to the embodiments may be acquired in the rendering and/or display process. The feedback information according to the embodiments may be secured by one or more sensors included in the reception device 10004. According to embodiments, the feedback information may be secured by the renderer 10007 or a separate external element (or device, component, or the like). The dotted lines in FIG. 1 represent a process of transmitting the feedback information secured by the renderer 10007. The point cloud content providing system may process (encode/decode) point cloud data based on the feedback information. Accordingly, the point cloud video decoder 10006 may perform a decoding operation based on the feedback information. The reception device 10004 may transmit the feedback information to the transmission device 10000. The transmission device 10000 (or the point cloud video encoder 10002) may perform an encoding operation based on the feedback information. Accordingly, the point cloud content providing system may efficiently process necessary data (e.g., point cloud data corresponding to the user's head position) based on the feedback information rather than processing (encoding/decoding) the entire point cloud data, and provide point cloud content to the user.

According to embodiments, the transmission device 10000 may be called an encoder, a transmitting device, a transmitter, a transmission system, or the like, and the reception device 10004 may be called a decoder, a receiving device, a receiver, a reception system, or the like.

The point cloud data processed in the point cloud content providing system of FIG. 1 according to embodiments (through a series of processes of acquisition/encoding/transmission/decoding/rendering) may be referred to as point cloud content data or point cloud video data. According to embodiments, the point cloud content data may be used as a concept covering metadata or signaling information related to the point cloud data.

The elements of the point cloud content providing system illustrated in FIG. 1 may be implemented by hardware, software, a processor, and/or a combination thereof.

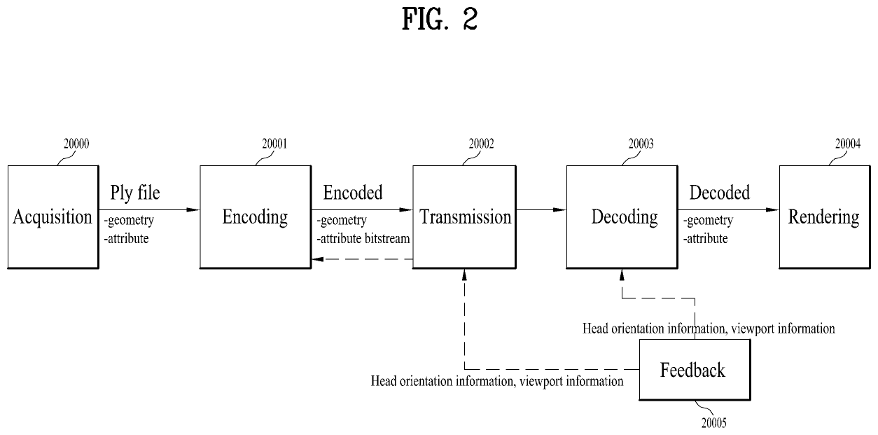

FIG. 2 is a block diagram illustrating a point cloud content providing operation according to embodiments.

The block diagram of FIG. 2 shows the operation of the point cloud content providing system described in FIG. 1. As described above, the point cloud content providing system may process point cloud data based on point cloud compression coding (e.g., G-PCC).

The point cloud content providing system according to the embodiments (for example, the point cloud transmission device 10000 or the point cloud video acquisition unit 10001) may acquire a point cloud video (20000). The point cloud video is represented by a point cloud belonging to a coordinate system for expressing a 3D space. The point cloud video according to the embodiments may include a Ply (Polygon File format or the Stanford Triangle format) file. When the point cloud video has one or more frames, the acquired point cloud video may include one or more Ply files. The Ply files contain point cloud data, such as point geometry and/or attributes. The geometry includes positions of points. The position of each point may be represented by parameters (for example, values of the X, Y, and Z axes) representing a three-dimensional coordinate system (e.g., a coordinate system composed of X, Y and Z axes). The attributes include attributes of points (e.g., information about texture, color (in YCbCr or RGB or YUV), reflectance, transparency, etc. of each point). A point has one or more attributes. For example, a point may have an attribute that is a color, or two attributes that are color and reflectance. According to embodiments, the geometry may be called positions, geometry information, geometry data, or the like, and the attribute may be called attributes, attribute information, attribute data, or the like. The point cloud content providing system (for example, the point cloud transmission device 10000 or the point cloud video acquisition unit 10001) may secure point cloud data from information (e.g., depth information, color information, etc.) related to the acquisition process of the point cloud video.

The point cloud content providing system (for example, the transmission device 10000 or the point cloud video encoder 10002) according to the embodiments may encode the point cloud data (20001). The point cloud content providing system may encode the point cloud data based on point cloud compression coding. As described above, the point cloud data may include the geometry and attributes of a point. Accordingly, the point cloud content providing system may perform geometry encoding of encoding the geometry and output a geometry bitstream. The point cloud content providing system may perform attribute encoding of encoding attributes and output an attribute bitstream. According to embodiments, the point cloud content providing system may perform the attribute encoding based on the geometry encoding. The geometry bitstream and the attribute bitstream according to the embodiments may be multiplexed and output as one bitstream. The bitstream according to the embodiments may further contain signaling information related to the geometry encoding and attribute encoding.

The point cloud content providing system (for example, the transmission device 10000 or the transmitter 10003) according to the embodiments may transmit the encoded point cloud data (20002). As illustrated in FIG. 1, the encoded point cloud data may be represented by a geometry bitstream and an attribute bitstream. In addition, the encoded point cloud data may be transmitted in the form of a bitstream together with signaling information related to encoding of the point cloud data (for example, signaling information related to the geometry encoding and the attribute encoding). The point cloud content providing system may encapsulate a bitstream that carries the encoded point cloud data and transmit the same in the form of a file or segment.

The point cloud content providing system (for example, the reception device 10004 or the receiver 10005) according to the embodiments may receive the bitstream containing the encoded point cloud data. In addition, the point cloud content providing system (for example, the reception device 10004 or the receiver 10005) may demultiplex the bitstream.

The point cloud content providing system (e.g., the reception device 10004 or the point cloud video decoder 10005) may decode the encoded point cloud data (e.g., the geometry bitstream, the attribute bitstream) transmitted in the bitstream. The point cloud content providing system (for example, the reception device 10004 or the point cloud video decoder 10005) may decode the point cloud video data based on the signaling information related to encoding of the point cloud video data contained in the bitstream. The point cloud content providing system (for example, the reception device 10004 or the point cloud video decoder 10005) may decode the geometry bitstream to reconstruct the positions (geometry) of points. The point cloud content providing system may reconstruct the attributes of the points by decoding the attribute bitstream based on the reconstructed geometry. The point cloud content providing system (for example, the reception device 10004 or the point cloud video decoder 10005) may reconstruct the point cloud video based on the positions according to the reconstructed geometry and the decoded attributes.

The point cloud content providing system according to the embodiments (for example, the reception device 10004 or the renderer 10007) may render the decoded point cloud data (20004). The point cloud content providing system (for example, the reception device 10004 or the renderer 10007) may render the geometry and attributes decoded through the decoding process, using various rendering methods. Points in the point cloud content may be rendered to a vertex having a certain thickness, a cube having a specific minimum size centered on the corresponding vertex position, or a circle centered on the corresponding vertex position. All or part of the rendered point cloud content is provided to the user through a display (e.g., a VR/AR display, a general display, etc.).

The point cloud content providing system (for example, the reception device 10004) according to the embodiments may secure feedback information (20005). The point cloud content providing system may encode and/or decode point cloud data based on the feedback information. The feedback information and the operation of the point cloud content providing system according to the embodiments are the same as the feedback information and the operation described with reference to FIG. 1, and thus detailed description thereof is omitted.

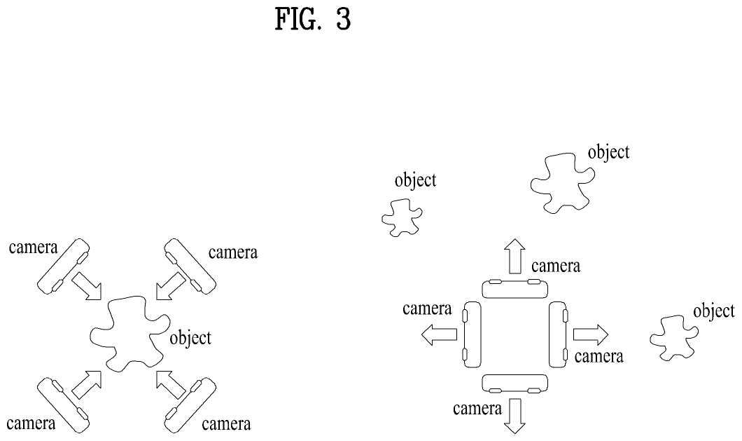

FIG. 3 illustrates an exemplary process of capturing a point cloud video according to embodiments.

FIG. 3 illustrates an exemplary point cloud video capture process of the point cloud content providing system described with reference to FIGS. 1 to 2.

Point cloud content includes a point cloud video (images and/or videos) representing an object and/or environment located in various 3D spaces (e.g., a 3D space representing a real environment, a 3D space representing a virtual environment, etc.). Accordingly, the point cloud content providing system according to the embodiments may capture a point cloud video using one or more cameras (e.g., an infrared camera capable of securing depth information, an RGB camera capable of extracting color information corresponding to the depth information, etc.), a projector (e.g., an infrared pattern projector to secure depth information), a LiDAR, or the like. The point cloud content providing system according to the embodiments may extract the shape of geometry composed of points in a 3D space from the depth information and extract the attributes of each point from the color information to secure point cloud data. An image and/or video according to the embodiments may be captured based on at least one of the inward-facing technique and the outward-facing technique.

The left part of FIG. 3 illustrates the inward-facing technique. The inward-facing technique refers to a technique of capturing images a central object with one or more cameras (or camera sensors) positioned around the central object. The inward-facing technique may be used to generate point cloud content providing a 360-degree image of a key object to the user (e.g., VR/AR content providing a 360-degree image of an object (e.g., a key object such as a character, player, object, or actor) to the user).

The right part of FIG. 3 illustrates the outward-facing technique. The outward-facing technique refers to a technique of capturing images an environment of a central object rather than the central object with one or more cameras (or camera sensors) positioned around the central object. The outward-facing technique may be used to generate point cloud content for providing a surrounding environment that appears from the user's point of view (e.g., content representing an external environment that may be provided to a user of a self-driving vehicle).

As shown in FIG. 3, the point cloud content may be generated based on the capturing operation of one or more cameras. In this case, the coordinate system may differ among the cameras, and accordingly the point cloud content providing system may calibrate one or more cameras to set a global coordinate system before the capturing operation. In addition, the point cloud content providing system may generate point cloud content by synthesizing an arbitrary image and/or video with an image and/or video captured by the above-described capture technique. The point cloud content providing system may not perform the capturing operation described in FIG. 3 when it generates point cloud content representing a virtual space. The point cloud content providing system according to the embodiments may perform post-processing on the captured image and/or video. In other words, the point cloud content providing system may remove an unwanted area (for example, a background), recognize a space to which the captured images and/or videos are connected, and, when there is a spatial hole, perform an operation of filling the spatial hole.

The point cloud content providing system may generate one piece of point cloud content by performing coordinate transformation on points of the point cloud video secured from each camera. The point cloud content providing system may perform coordinate transformation on the points based on the coordinates of the position of each camera. Accordingly, the point cloud content providing system may generate content representing one wide range, or may generate point cloud content having a high density of points.

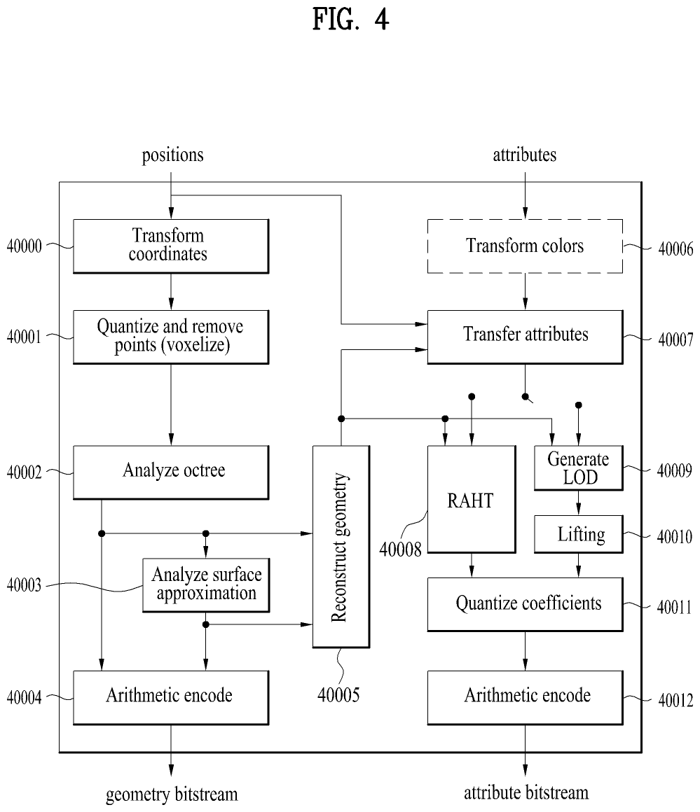

FIG. 4 illustrates an exemplary point cloud video encoder according to embodiments.

FIG. 4 shows an example of the point cloud video encoder 10002 of FIG. 1. The point cloud video encoder reconstructs and encodes point cloud data (e.g., positions and/or attributes of the points) to adjust the quality of the point cloud content (to, for example, lossless, lossy, or near-lossless) according to the network condition or applications. When the overall size of the point cloud content is large (e.g., point cloud content of 60 Gbps is given for 30 fps), the point cloud content providing system may fail to stream the content in real time. Accordingly, the point cloud content providing system may reconstruct the point cloud content based on the maximum target bitrate to provide the same in accordance with the network environment or the like.

As described with reference to FIGS. 1 to 2, the point cloud video encoder may perform geometry encoding and attribute encoding. The geometry encoding is performed before the attribute encoding.

The point cloud video encoder according to the embodiments includes a coordinates transformation unit 40000, a quantization unit 40001, an octree analysis unit 40002, and a surface approximation analysis unit 40003, an arithmetic encoder 40004, a geometry reconstruction unit 40005, a color transformation unit 40006, an attribute transformation unit 40007, a RAHT transformation unit 40008, an LOD generation unit 40009, a lifting transformation unit 40010, a coefficient quantization unit 40011, and/or an arithmetic encoder 40012.

The coordinates transformation unit 40000, the quantization unit 40001, the octree analysis unit 40002, the surface approximation analysis unit 40003, the arithmetic encoder 40004, and the geometry reconstruction unit 40005 may perform geometry encoding. The geometry encoding according to the embodiments may include octree geometry coding, direct coding, trisoup geometry encoding, and entropy encoding. The direct coding and trisoup geometry encoding are applied selectively or in combination. The geometry encoding is not limited to the above-described example.

As shown in the figure, the coordinates transformation unit 40000 according to the embodiments receives positions and transforms the same into coordinates. For example, the positions may be transformed into position information in a three-dimensional space (for example, a three-dimensional space represented by an XYZ coordinate system). The position information in the three-dimensional space according to the embodiments may be referred to as geometry information.

The quantization unit 40001 according to the embodiments quantizes the geometry information. For example, the quantization unit 40001 may quantize the points based on a minimum position value of all points (for example, a minimum value on each of the X, Y, and Z axes). The quantization unit 40001 performs a quantization operation of multiplying the difference between the minimum position value and the position value of each point by a preset quantization scale value and then finding the nearest integer value by rounding the value obtained through the multiplication. Thus, one or more points may have the same quantized position (or position value). The quantization unit 40001 according to the embodiments performs voxelization based on the quantized positions to reconstruct quantized points. The voxelization means a minimum unit representing position information in 3D spacePoints of point cloud content (or 3D point cloud video) according to the embodiments may be included in one or more voxels. The term voxel, which is a compound of volume and pixel, refers to a 3D cubic space generated when a 3D space is divided into units (unit=1.0) based on the axes representing the 3D space (e.g., X-axis, Y-axis, and Z-axis). The quantization unit 40001 may match groups of points in the 3D space with voxels. According to embodiments, one voxel may include only one point. According to embodiments, one voxel may include one or more points. In order to express one voxel as one point, the position of the center point of a voxel may be set based on the positions of one or more points included in the voxel. In this case, attributes of all positions included in one voxel may be combined and assigned to the voxel.

The octree analysis unit 40002 according to the embodiments performs octree geometry coding (or octree coding) to present voxels in an octree structure. The octree structure represents points matched with voxels, based on the octal tree structure.

The surface approximation analysis unit 40003 according to the embodiments may analyze and approximate the octree. The octree analysis and approximation according to the embodiments is a process of analyzing a region containing a plurality of points to efficiently provide octree and voxelization.

The arithmetic encoder 40004 according to the embodiments performs entropy encoding on the octree and/or the approximated octree. For example, the encoding scheme includes arithmetic encoding. As a result of the encoding, a geometry bitstream is generated.

The color transformation unit 40006, the attribute transformation unit 40007, the RAHT transformation unit 40008, the LOD generation unit 40009, the lifting transformation unit 40010, the coefficient quantization unit 40011, and/or the arithmetic encoder 40012 perform attribute encoding. As described above, one point may have one or more attributes. The attribute encoding according to the embodiments is equally applied to the attributes that one point has. However, when an attribute (e.g., color) includes one or more elements, attribute encoding is independently applied to each element. The attribute encoding according to the embodiments includes color transform coding, attribute transform coding, region adaptive hierarchical transform (RAHT) coding, interpolation-based hierarchical nearest-neighbor prediction (prediction transform) coding, and interpolation-based hierarchical nearest-neighbor prediction with an update/lifting step (lifting transform) coding. Depending on the point cloud content, the RAHT coding, the prediction transform coding and the lifting transform coding described above may be selectively used, or a combination of one or more of the coding schemes may be used. The attribute encoding according to the embodiments is not limited to the above-described example.

The color transformation unit 40006 according to the embodiments performs color transform coding of transforming color values (or textures) included in the attributes. For example, the color transformation unit 40006 may transform the format of color information (for example, from RGB to YCbCr). The operation of the color transformation unit 40006 according to embodiments may be optionally applied according to the color values included in the attributes.

The geometry reconstruction unit 40005 according to the embodiments reconstructs (decompresses) the octree and/or the approximated octree. The geometry reconstruction unit 40005 reconstructs the octree/voxels based on the result of analyzing the distribution of points. The reconstructed octree/voxels may be referred to as reconstructed geometry (restored geometry).

The attribute transformation unit 40007 according to the embodiments performs attribute transformation to transform the attributes based on the reconstructed geometry and/or the positions on which geometry encoding is not performed. As described above, since the attributes are dependent on the geometry, the attribute transformation unit 40007 may transform the attributes based on the reconstructed geometry information. For example, based on the position value of a point included in a voxel, the attribute transformation unit 40007 may transform the attribute of the point at the position. As described above, when the position of the center of a voxel is set based on the positions of one or more points included in the voxel, the attribute transformation unit 40007 transforms the attributes of the one or more points. When the trisoup geometry encoding is performed, the attribute transformation unit 40007 may transform the attributes based on the trisoup geometry encoding.

The attribute transformation unit 40007 may perform the attribute transformation by calculating the average of attributes or attribute values of neighboring points (e.g., color or reflectance of each point) within a specific position/radius from the position (or position value) of the center of each voxel. The attribute transformation unit 40007 may apply a weight according to the distance from the center to each point in calculating the average. Accordingly, each voxel has a position and a calculated attribute (or attribute value).

The attribute transformation unit 40007 may search for neighboring points existing within a specific position/radius from the position of the center of each voxel based on the K-D tree or the Morton code. The K-D tree is a binary search tree and supports a data structure capable of managing points based on the positions such that nearest neighbor search (NNS) can be performed quickly. The Morton code is generated by presenting coordinates (e.g., (x, y, z)) representing 3D positions of all points as bit values and mixing the bits. For example, when the coordinates representing the position of a point are (5, 9, 1), the bit values for the coordinates are (0101, 1001, 0001). Mixing the bit values according to the bit index in order of z, y, and x yields 010001000111. This value is expressed as a decimal number of 1095. That is, the Morton code value of the point having coordinates (5, 9, 1) is 1095. The attribute transformation unit 40007 may order the points based on the Morton code values and perform NNS through a depth-first traversal process. After the attribute transformation operation, the K-D tree or the Morton code is used when the NNS is needed in another transformation process for attribute coding.

As shown in the figure, the transformed attributes are input to the RAHT transformation unit 40008 and/or the LOD generation unit 40009.

The RAHT transformation unit 40008 according to the embodiments performs RAHT coding for predicting attribute information based on the reconstructed geometry information. For example, the RAHT transformation unit 40008 may predict attribute information of a node at a higher level in the octree based on the attribute information associated with a node at a lower level in the octree.

The LOD generation unit 40009 according to the embodiments generates a level of detail (LOD). The LOD according to the embodiments is a degree of detail of point cloud content. As the LOD value decrease, it indicates that the detail of the point cloud content is degraded. As the LOD value increases, it indicates that the detail of the point cloud content is enhanced. Points may be classified by the LOD.

The lifting transformation unit 40010 according to the embodiments performs lifting transform coding of transforming the attributes a point cloud based on weights. As described above, lifting transform coding may be optionally applied.

The coefficient quantization unit 40011 according to the embodiments quantizes the attribute-coded attributes based on coefficients.

The arithmetic encoder 40012 according to the embodiments encodes the quantized attributes based on arithmetic coding.

Although not shown in the figure, the elements of the point cloud video encoder of FIG. 4 may be implemented by hardware including one or more processors or integrated circuits configured to communicate with one or more memories included in the point cloud content providing apparatus, software, firmware, or a combination thereof. The one or more processors may perform at least one of the operations and/or functions of the elements of the point cloud video encoder of FIG. 4 described above. Additionally, the one or more processors may operate or execute a set of software programs and/or instructions for performing the operations and/or functions of the elements of the point cloud video encoder of FIG. 4. The one or more memories according to the embodiments may include a high speed random access memory, or include a non-volatile memory (e.g., one or more magnetic disk storage devices, flash memory devices, or other non-volatile solid-state memory devices).

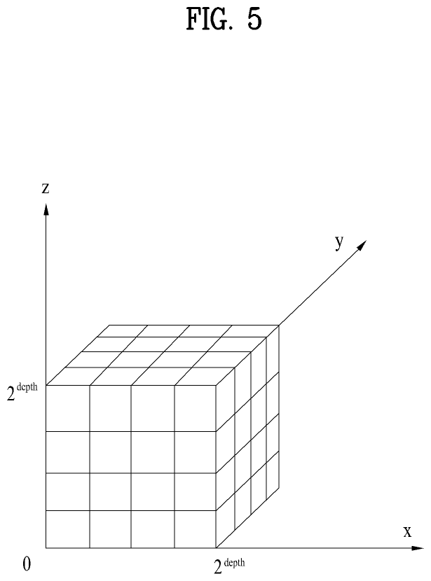

FIG. 5 shows an example of voxels according to embodiments.

FIG. 5 shows voxels positioned in a 3D space represented by a coordinate system composed of three axes, which are the X-axis, the Y-axis, and the Z-axis. As described with reference to FIG. 4, the point cloud video encoder (e.g., the quantization unit 40001) may perform voxelization. Voxel refers to a 3D cubic space generated when a 3D space is divided into units (unit=1.0) based on the axes representing the 3D space (e.g., X-axis, Y-axis, and Z-axis). FIG. 5 shows an example of voxels generated through an octree structure in which a cubical axis-aligned bounding box defined by two poles (0, 0, 0) and (2^{d}, 2^{d}, 2^{d}) is recursively subdivided. One voxel includes one or more points. The spatial coordinates of a voxel may be estimated from the positional relationship with a voxel group. As described above, a voxel has an attribute (such as color or reflectance) like pixels of a 2D image/video. The details of the voxel are the same as those described with reference to FIG. 4, and therefore a description thereof is omitted.

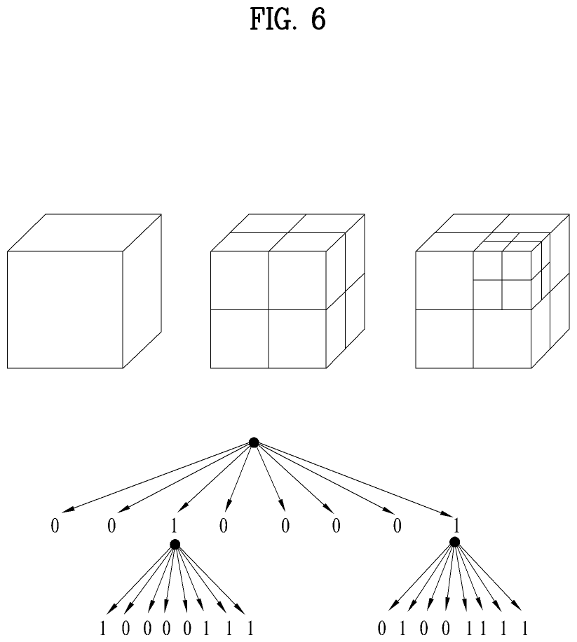

FIG. 6 shows an example of an octree and occupancy code according to embodiments.

As described with reference to FIGS. 1 to 4, the point cloud content providing system (point cloud video encoder 10002) or the octree analysis unit 40002 of the point cloud video encoder performs octree geometry coding (or octree coding) based on an octree structure to efficiently manage the region and/or position of the voxel.

The upper part of FIG. 6 shows an octree structure. The 3D space of the point cloud content according to the embodiments is represented by axes (e.g., X-axis, Y-axis, and Z-axis) of the coordinate system. The octree structure is created by recursive subdividing of a cubical axis-aligned bounding box defined by two poles (0, 0, 0) and (2^{d}, 2^{d}, 2^{d}). Here, 2^{d} may be set to a value constituting the smallest bounding box surrounding all points of the point cloud content (or point cloud video). Here, d denotes the depth of the octree. The value of d is determined in Equation 1. In Equation 1, (x^{int}ₙ, y^{int}ₙ, z^{int}ₙ) denotes the positions (or position values) of quantized points.

d=Ceil(Log 2(Max(xₙ^{int},yₙ^{int},zₙ^{int},n=1, . . . ,N)+1)) Equation 1

As shown in the middle of the upper part of FIG. 6, the entire 3D space may be divided into eight spaces according to partition. Each divided space is represented by a cube with six faces. As shown in the upper right of FIG. 6, each of the eight spaces is divided again based on the axes of the coordinate system (e.g., X-axis, Y-axis, and Z-axis). Accordingly, each space is divided into eight smaller spaces. The divided smaller space is also represented by a cube with six faces. This partitioning scheme is applied until the leaf node of the octree becomes a voxel.

The lower part of FIG. 6 shows an octree occupancy code. The occupancy code of the octree is generated to indicate whether each of the eight divided spaces generated by dividing one space contains at least one point. Accordingly, a single occupancy code is represented by eight child nodes. Each child node represents the occupancy of a divided space, and the child node has a value in 1 bit. Accordingly, the occupancy code is represented as an 8-bit code. That is, when at least one point is contained in the space corresponding to a child node, the node is assigned a value of 1. When no point is contained in the space corresponding to the child node (the space is empty), the node is assigned a value of 0. Since the occupancy code shown in FIG. 6 is 00100001, it indicates that the spaces corresponding to the third child node and the eighth child node among the eight child nodes each contain at least one point. As shown in the figure, each of the third child node and the eighth child node has eight child nodes, and the child nodes are represented by an 8-bit occupancy code. The figure shows that the occupancy code of the third child node is 10000111, and the occupancy code of the eighth child node is 01001111. The point cloud video encoder (for example, the arithmetic encoder 40004) according to the embodiments may perform entropy encoding on the occupancy codes. In order to increase the compression efficiency, the point cloud video encoder may perform intra/inter-coding on the occupancy codes. The reception device (for example, the reception device 10004 or the point cloud video decoder 10006) according to the embodiments reconstructs the octree based on the occupancy codes.

The point cloud video encoder (for example, the octree analysis unit 40002) according to the embodiments may perform voxelization and octree coding to store the positions of points. However, points are not always evenly distributed in the 3D space, and accordingly there may be a specific region in which fewer points are present. Accordingly, it is inefficient to perform voxelization for the entire 3D space. For example, when a specific region contains few points, voxelization does not need to be performed in the specific region.

Accordingly, for the above-described specific region (or a node other than the leaf node of the octree), the point cloud video encoder according to the embodiments may skip voxelization and perform direct coding to directly code the positions of points included in the specific region. The coordinates of a direct coding point according to the embodiments are referred to as direct coding mode (DCM). The point cloud video encoder according to the embodiments may also perform trisoup geometry encoding, which is to reconstruct the positions of the points in the specific region (or node) based on voxels, based on a surface model. The trisoup geometry encoding is geometry encoding that represents an object as a series of triangular meshes. Accordingly, the point cloud video decoder may generate a point cloud from the mesh surface. The direct coding and trisoup geometry encoding according to the embodiments may be selectively performed. In addition, the direct coding and trisoup geometry encoding according to the embodiments may be performed in combination with octree geometry coding (or octree coding).

To perform direct coding, the option to use the direct mode for applying direct coding should be activated. A node to which direct coding is to be applied is not a leaf node, and points less than a threshold should be present within a specific node. In addition, the total number of points to which direct coding is to be applied should not exceed a preset threshold. When the conditions above are satisfied, the point cloud video encoder (or the arithmetic encoder 40004) according to the embodiments may perform entropy coding on the positions (or position values) of the points.

The point cloud video encoder (for example, the surface approximation analysis unit 40003) according to the embodiments may determine a specific level of the octree (a level less than the depth d of the octree), and the surface model may be used staring with that level to perform trisoup geometry encoding to reconstruct the positions of points in the region of the node based on voxels (Trisoup mode). The point cloud video encoder according to the embodiments may specify a level at which trisoup geometry encoding is to be applied. For example, when the specific level is equal to the depth of the octree, the point cloud video encoder does not operate in the trisoup mode. In other words, the point cloud video encoder according to the embodiments may operate in the trisoup mode only when the specified level is less than the value of depth of the octree. The 3D cube region of the nodes at the specified level according to the embodiments is called a block. One block may include one or more voxels. The block or voxel may correspond to a brick. Geometry is represented as a surface within each block. The surface according to embodiments may intersect with each edge of a block at most once.

One block has 12 edges, and accordingly there are at least 12 intersections in one block. Each intersection is called a vertex (or apex). A vertex present along an edge is detected when there is at least one occupied voxel adjacent to the edge among all blocks sharing the edge. The occupied voxel according to the embodiments refers to a voxel containing a point. The position of the vertex detected along the edge is the average position along the edge of all voxels adjacent to the edge among all blocks sharing the edge.

Once the vertex is detected, the point cloud video encoder according to the embodiments may perform entropy encoding on the starting point (x, y, z) of the edge, the direction vector (Δx, Δy, Δz) of the edge, and the vertex position value (relative position value within the edge). When the trisoup geometry encoding is applied, the point cloud video encoder according to the embodiments (for example, the geometry reconstruction unit 40005) may generate restored geometry (reconstructed geometry) by performing the triangle reconstruction, up-sampling, and voxelization processes.

The vertices positioned at the edge of the block determine a surface that passes through the block. The surface according to the embodiments is a non-planar polygon. In the triangle reconstruction process, a surface represented by a triangle is reconstructed based on the starting point of the edge, the direction vector of the edge, and the position values of the vertices. The triangle reconstruction process is performed according to Equation 2 by: i) calculating the centroid value of each vertex, ii) subtracting the center value from each vertex value, and iii) estimating the sum of the squares of the values obtained by the subtraction.

$$[ \begin{matrix}{μ}_{x} \\ {μ}_{y} \\ {μ}_{z}\end{matrix} ] = \frac{1}{n} {\sum }_{i = 1}^{n} [ \begin{matrix}{x}_{i} \\ {y}_{i} \\ {z}_{i}\end{matrix} ] [ \begin{matrix}{\overline{x}}_{i} \\ {\overline{y}}_{i} \\ {\overline{z}}_{i}\end{matrix} ] = [ \begin{matrix}{x}_{i} \\ {y}_{i} \\ {z}_{i}\end{matrix} ] - [ \begin{matrix}{μ}_{x} \\ {μ}_{y} \\ {μ}_{z}\end{matrix} ] [ \begin{matrix}{σ}_{x}^{2} \\ {σ}_{y}^{2} \\ {σ}_{z}^{2}\end{matrix} ] = {\sum }_{i = 1}^{n} [ \begin{matrix}{\overline{x}}_{i}^{2} \\ {\overline{y}}_{i}^{2} \\ {\overline{z}}_{i}^{2}\end{matrix} ] \qquad Equation 2$$

Then, the minimum value of the sum is estimated, and the projection process is performed according to the axis with the minimum value. For example, when the element x is the minimum, each vertex is projected on the x-axis with respect to the center of the block, and projected on the (y, z) plane. When the values obtained through projection on the (y, z) plane are (ai, bi), the value of θ is estimated through atan 2 (bi, ai), and the vertices are ordered based on the value of θ. The table 1 below shows a combination of vertices for creating a triangle according to the number of the vertices. The vertices are ordered from 1 to n. Table 1 below shows that for four vertices, two triangles may be constructed according to combinations of vertices. The first triangle may consist of vertices 1, 2, and 3 among the ordered vertices, and the second triangle may consist of vertices 3, 4, and 1 among the ordered vertices.

Table 1. Triangles formed from vertices ordered 1, . . . , n

TABLE 1

| n | Triangles |
|---|---|
| | (1,2,3) |
| | (1,2,3), (3,4,1) |
| | (1,2,3), (3,4,5), (5,1,3) |
| | (1,2,3), (3,4,5), (5,6,1), (1,3,5) |
| | (1,2,3), (3,4,5), (5,6,7), (7,1,3), (3,5,7) |
| | (1,2,3), (3,4,5), (5,6,7), (7,8,1), (1,3,5), (5,7,1) |
| | (1,2,3), (3,4,5), (5,6,7), (7,8,9), (9,1,3), (3,5,7), (7,9,3) |
| | (1,2,3), (3,4,5), (5,6,7), (7,8,9), (9,10,1), (1,3,5), (5,7,9), (9,1,5) |
| 1 | (1,2,3), (3,4,5), (5,6,7), (7,8,9), (9,10,11), (11,1,3), (3,5,7), (7,9,11), |
| | (11,3,7) |
| | (1,2,3), (3,4,5), (5,6,7), (7,8,9), (9,10,11), (11,12,1), (1,3,5), (5,7,9), |
| | (9,11,1), |
| 2 | (1,5,9) |

The upsampling process is performed to add points in the middle along the edge of the triangle and perform voxelization. The added points are generated based on the upsampling factor and the width of the block. The added points are called refined vertices. The point cloud video encoder according to the embodiments may voxelize the refined vertices. In addition, the point cloud video encoder may perform attribute encoding based on the voxelized positions (or position values).

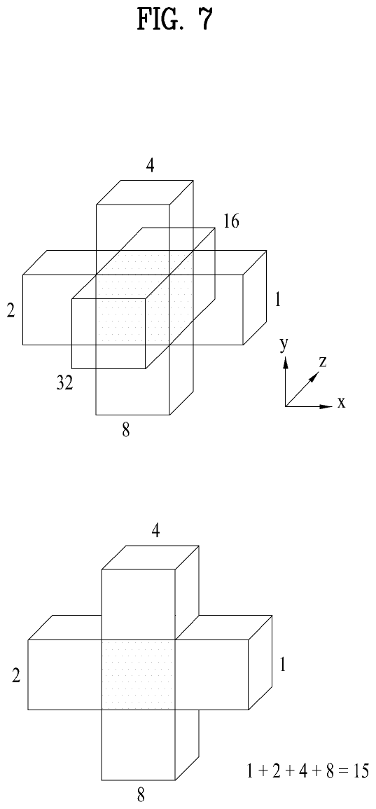

FIG. 7 shows an example of a neighbor node pattern according to embodiments.

In order to increase the compression efficiency of the point cloud video, the point cloud video encoder according to the embodiments may perform entropy coding based on context adaptive arithmetic coding.

As described with reference to FIGS. 1 to 6, the point cloud content providing system or the point cloud video encoder 10002 of FIG. 1, or the point cloud video encoder or arithmetic encoder 40004 of FIG. 4 may perform entropy coding on the occupancy code immediately. In addition, the point cloud content providing system or the point cloud video encoder may perform entropy encoding (intra encoding) based on the occupancy code of the current node and the occupancy of neighboring nodes, or perform entropy encoding (inter encoding) based on the occupancy code of the previous frame. A frame according to embodiments represents a set of point cloud videos generated at the same time. The compression efficiency of intra encoding/inter encoding according to the embodiments may depend on the number of neighboring nodes that are referenced. When the bits increase, the operation becomes complicated, but the encoding may be biased to one side, which may increase the compression efficiency. For example, when a 3-bit context is given, coding needs to be performed using 2³=8 methods. The part divided for coding affects the complexity of implementation. Accordingly, it is necessary to meet an appropriate level of compression efficiency and complexity.

FIG. 7 illustrates a process of obtaining an occupancy pattern based on the occupancy of neighbor nodes. The point cloud video encoder according to the embodiments determines occupancy of neighbor nodes of each node of the octree and obtains a value of a neighbor pattern. The neighbor node pattern is used to infer the occupancy pattern of the node. The up part of FIG. 7 shows a cube corresponding to a node (a cube positioned in the middle) and six cubes (neighbor nodes) sharing at least one face with the cube. The nodes shown in the figure are nodes of the same depth. The numbers shown in the figure represent weights (1, 2, 4, 8, 16, and 32) associated with the six nodes, respectively. The weights are assigned sequentially according to the positions of neighboring nodes.

The down part of FIG. 7 shows neighbor node pattern values. A neighbor node pattern value is the sum of values multiplied by the weight of an occupied neighbor node (a neighbor node having a point). Accordingly, the neighbor node pattern values are 0 to 63. When the neighbor node pattern value is 0, it indicates that there is no node having a point (no occupied node) among the neighbor nodes of the node. When the neighbor node pattern value is 63, it indicates that all neighbor nodes are occupied nodes. As shown in the figure, since neighbor nodes to which weights 1, 2, 4, and 8 are assigned are occupied nodes, the neighbor node pattern value is 15, the sum of 1, 2, 4, and 8. The point cloud video encoder may perform coding according to the neighbor node pattern value (for example, when the neighbor node pattern value is 63, 64 kinds of coding may be performed). According to embodiments, the point cloud video encoder may reduce coding complexity by changing a neighbor node pattern value (for example, based on a table by which 64 is changed to 10 or 6).

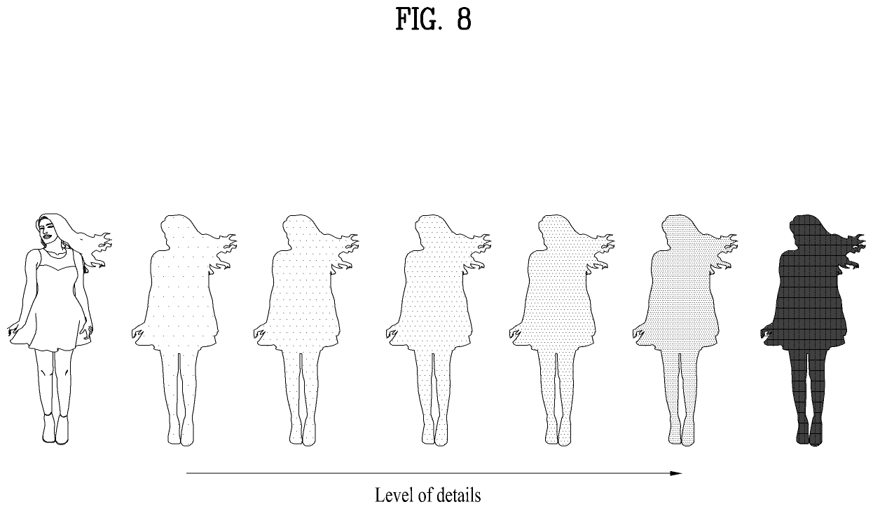

FIG. 8 illustrates an example of point configuration in each LOD according to embodiments.

As described with reference to FIGS. 1 to 7, encoded geometry is reconstructed (decompressed) before attribute encoding is performed. When direct coding is applied, the geometry reconstruction operation may include changing the placement of direct coded points (e.g., placing the direct coded points in front of the point cloud data). When trisoup geometry encoding is applied, the geometry reconstruction process is performed through triangle reconstruction, up-sampling, and voxelization. Since the attribute depends on the geometry, attribute encoding is performed based on the reconstructed geometry.

The point cloud video encoder (for example, the LOD generation unit 40009) may classify (reorganize or group) points by LOD. FIG. 8 shows the point cloud content corresponding to LODs. The leftmost picture in FIG. 8 represents original point cloud content. The second picture from the left of FIG. 8 represents distribution of the points in the lowest LOD, and the rightmost picture in FIG. 8 represents distribution of the points in the highest LOD. That is, the points in the lowest LOD are sparsely distributed, and the points in the highest LOD are densely distributed. That is, as the LOD rises in the direction pointed by the arrow indicated at the bottom of FIG. 8, the space (or distance) between points is narrowed.

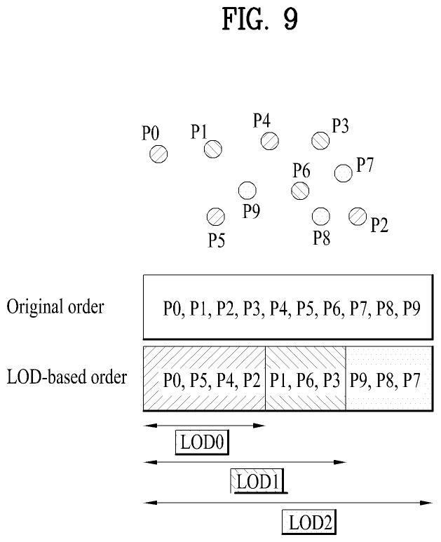

FIG. 9 illustrates an example of point configuration for each LOD according to embodiments.

As described with reference to FIGS. 1 to 8, the point cloud content providing system, or the point cloud video encoder (for example, the point cloud video encoder 10002 of FIG. 1, the point cloud video encoder of FIG. 4, or the LOD generation unit 40009) may generates an LOD. The LOD is generated by reorganizing the points into a set of refinement levels according to a set LOD distance value (or a set of Euclidean distances). The LOD generation process is performed not only by the point cloud video encoder, but also by the point cloud video decoder.

The upper part of FIG. 9 shows examples (P0 to P9) of points of the point cloud content distributed in a 3D space. In FIG. 9, the original order represents the order of points P0 to P9 before LOD generation. In FIG. 9, the LOD based order represents the order of points according to the LOD generation. Points are reorganized by LOD. Also, a high LOD contains the points belonging to lower LODs. As shown in FIG. 9, LOD0 contains P0, P5, P4 and P2. LOD1 contains the points of LOD0, P1, P6 and P3. LOD2 contains the points of LOD0, the points of LOD1, P9, P8 and P7.

As described with reference to FIG. 4, the point cloud video encoder according to the embodiments may perform prediction transform coding based on LOD, lifting transform coding based on LOD, and RAHT transform coding selectively or in combination.

The point cloud video encoder according to the embodiments may generate a predictor for points to perform prediction transform coding based on LOD for setting a predicted attribute (or predicted attribute value) of each point. That is, N predictors may be generated for N points. The predictor according to the embodiments may calculate a weight (=1/distance) based on the LOD value of each point, indexing information about neighboring points present within a set distance for each LOD, and a distance to the neighboring points.

The predicted attribute (or attribute value) according to the embodiments is set to the average of values obtained by multiplying the attributes (or attribute values) (e.g., color, reflectance, etc.) of neighbor points set in the predictor of each point by a weight (or weight value) calculated based on the distance to each neighbor point. The point cloud video encoder according to the embodiments (for example, the coefficient quantization unit 40011) may quantize and inversely quantize the residual of each point (which may be called residual attribute, residual attribute value, attribute prediction residual value or prediction error attribute value and so on) obtained by subtracting a predicted attribute (or attribute value) each point from the attribute (i.e., original attribute value) of each point. The quantization process performed for a residual attribute value in a transmission device is configured as shown in table 2. The inverse quantization process performed for a residual attribute value in a reception device is configured as shown in table 3.

TABLE 2

int PCCQuantization(int value, int quantStep) {
if( value >=0) {
return floor(value / quantStep + 1.0 / 3.0);
} else {
return -floor(-value / quantStep + 1.0 / 3.0);
}
}

TABLE 3

int PCCInverseQuantization(int value, int quantStep) {
if( quantStep ==0) {
return value;
} else {
return value * quantStep;
}
}

When the predictor of each point has neighbor points, the point cloud video encoder (e.g., the arithmetic encoder 40012) according to the embodiments may perform entropy coding on the quantized and inversely quantized residual attribute values as described above. When the predictor of each point has no neighbor point, the point cloud video encoder according to the embodiments (for example, the arithmetic encoder 40012) may perform entropy coding on the attributes of the corresponding point without performing the above-described operation.

1) The point cloud video encoder according to the embodiments (for example, the lifting transformation unit 40010) may generate a predictor of each point, set the calculated LOD and register neighbor points in the predictor, and set weights according to the distances to neighbor points to perform lifting transform coding. The lifting transform coding according to the embodiments is similar to the above-described prediction transform coding, but differs therefrom in that weights are cumulatively applied to attribute values. The process of cumulatively applying weights to the attribute values according to embodiments is configured as follows.

2) Create an array Quantization Weight (QW) for storing the weight value of each point. The initial value of all elements of QW is 1.0. Multiply the QW values of the predictor indexes of the neighbor nodes registered in the predictor by the weight of the predictor of the current point, and add the values obtained by the multiplication.

3) Lift prediction process: Subtract the value obtained by multiplying the attribute value of the point by the weight from the existing attribute value to calculate a predicted attribute value.

4) Create temporary arrays called updateweight and update and initialize the temporary arrays to zero.

5) Cumulatively add the weights calculated by multiplying the weights calculated for all predictors by a weight stored in the QW corresponding to a predictor index to the updateweight array as indexes of neighbor nodes. Cumulatively add, to the update array, a value obtained by multiplying the attribute value of the index of a neighbor node by the calculated weight.

6) Lift update process: Divide the attribute values of the update array for all predictors by the weight value of the updateweight array of the predictor index, and add the existing attribute value to the values obtained by the division. Calculate predicted attributes by multiplying the attribute values updated through the lift update process by the weight updated through the lift prediction process (stored in the QW) for all predictors. The point cloud video encoder (e.g., coefficient quantization unit 40011) according to the embodiments quantizes the predicted attribute values. In addition, the point cloud video encoder (e.g., the arithmetic encoder 40012) performs entropy coding on the quantized attribute values.

The point cloud video encoder (for example, the RAHT transformation unit 40008) according to the embodiments may perform RAHT transform coding in which attributes of nodes of a higher level are predicted using the attributes associated with nodes of a lower level in the octree. RAHT transform coding is an example of attribute intra coding through an octree backward scan. The point cloud video encoder according to the embodiments scans the entire region from the voxel and repeats the merging process of merging the voxels into a larger block at each step until the root node is reached. The merging process according to the embodiments is performed only on the occupied nodes. The merging process is not performed on the empty node. The merging process is performed on an upper node immediately above the empty node.

Equation 3 below represents a RAHT transformation matrix. In Equation 3, gₗ_{_{x,y,z}} denotes the average attribute value of voxels at level l. gₗ_{_{x,y,z}} may be calculated based on gₗ₊₁_{_{2x,y,z}} and gₗ₊₁_{_{2x+1,y,z}}. The weights for gₗ_{_{2x,y,z}} and gₗ_{_{2x+1,y,z}} are w1=wₗ_{_{2x,y,z}} and w2=wₗ_{_{2x+1,y,z}}.

$$⌈ \begin{matrix}{g}_{l - {1}_{x , y , z}} \\ {h}_{l - {1}_{x , y , z}}\end{matrix} ⌉ = {T}_{w 1 w 2} ⌈ \begin{matrix}{g}_{{l}_{2 x , y , z}} \\ {g}_{{l}_{2 x + 1 , y , z}}\end{matrix} ⌉ \qquad Equation 3$$

$${T}_{w 1 w 2} = \frac{1}{\sqrt{w 1 + w 2}} [ \begin{matrix}\sqrt{w 1} & \sqrt{w 2} \\ - \sqrt{w 2} & \sqrt{w 1}\end{matrix} ]$$

Here, gₗ₋₁ _{_{x,y,z}} is a low-pass value and is used in the merging process at the next higher level. hₗ₋₁ _{_{x,y,z}} denotes high-pass coefficients. The high-pass coefficients at each step are quantized and subjected to entropy coding (for example, encoding by the arithmetic encoder 40012). The weights are calculated as wₗ₋₁_{_{x,y,z}}=wₗ_{_{2x,y,z}}−wₗ_{_{2x+1,y,z}}. The root node is created through the g₁_{_{0,0,0}} and g₁_{_{0,0,1}} as Equation 4.

$$⌈ \begin{matrix}gDC \\ {h}_{{0}_{0 , 0 , 0}}\end{matrix} ⌉ = {T}_{w 1000 w 1001} ⌈ \begin{matrix}{g}_{{1}_{0 , 0 , 0 z}} \\ {g}_{{1}_{0 , 0 , 1}}\end{matrix} ⌉ \qquad Equation 4$$

The value of gDC is also quantized and subjected to entropy coding like the high-pass coefficients.

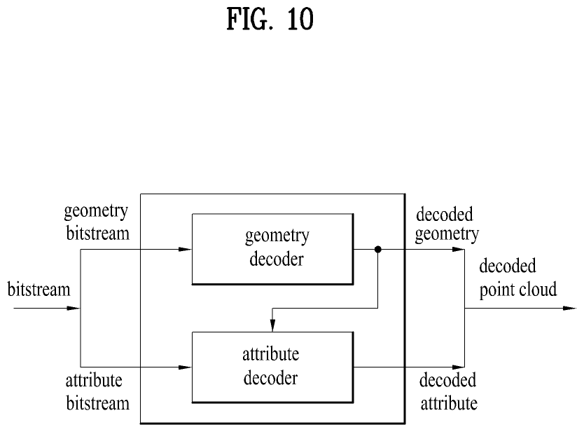

FIG. 10 illustrates a point cloud video decoder according to embodiments.

The point cloud video decoder illustrated in FIG. 10 is an example of the point cloud video decoder 10006 described in FIG. 1, and may perform the same or similar operations as the operations of the point cloud video decoder 10006 illustrated in FIG. 1. As shown in the figure, the point cloud video decoder may receive a geometry bitstream and an attribute bitstream contained in one or more bitstreams. The point cloud video decoder includes a geometry decoder and an attribute decoder. The geometry decoder performs geometry decoding on the geometry bitstream and outputs decoded geometry. The attribute decoder performs attribute decoding on the attribute bitstream based on the decoded geometry, and outputs decoded attributes. The decoded geometry and decoded attributes are used to reconstruct point cloud content (a decoded point cloud).

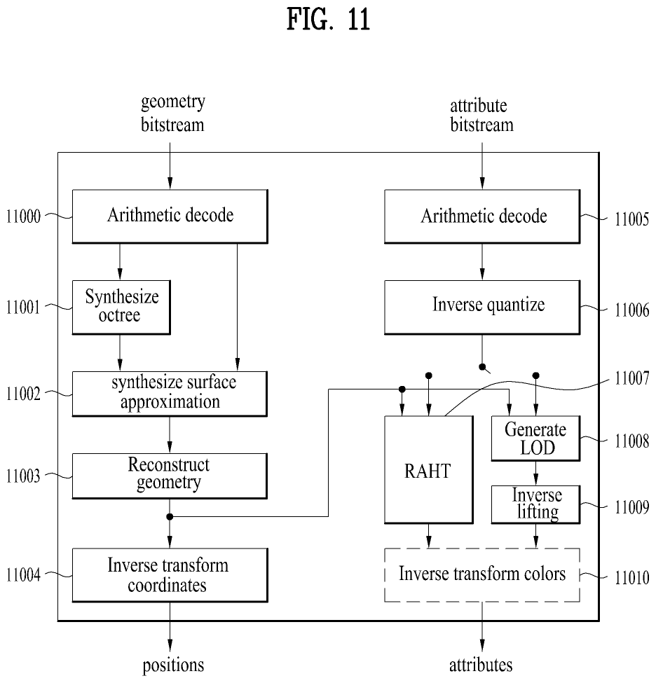

FIG. 11 illustrates a point cloud video decoder according to embodiments.

The point cloud video decoder illustrated in FIG. 11 is an example of the point cloud video decoder illustrated in FIG. 10, and may perform a decoding operation, which is an inverse process of the encoding operation of the point cloud video encoder illustrated in FIGS. 1 to 9.

As described with reference to FIGS. 1 and 10, the point cloud video decoder may perform geometry decoding and attribute decoding. The geometry decoding is performed before the attribute decoding.

The point cloud video decoder according to the embodiments includes an arithmetic decoder 11000, an octree synthesis unit 11001, a surface approximation synthesis unit 11002, and a geometry reconstruction unit 11003, a coordinates inverse transformation unit 11004, an arithmetic decoder 11005, an inverse quantization unit 11006, a RAHT transformation unit 11007, an LOD generation unit 11008, an inverse lifting unit 11009, and/or a color inverse transformation unit 11010.

The arithmetic decoder 11000, the octree synthesis unit 11001, the surface approximation synthesis unit 11002, and the geometry reconstruction unit 11003, and the coordinates inverse transformation unit 11004 may perform geometry decoding. The geometry decoding according to the embodiments may include direct decoding and trisoup geometry decoding. The direct decoding and trisoup geometry decoding are selectively applied. The geometry decoding is not limited to the above-described example, and is performed as an inverse process of the geometry encoding described with reference to FIGS. 1 to 9.

The arithmetic decoder 11000 according to the embodiments decodes the received geometry bitstream based on the arithmetic coding. The operation of the arithmetic decoder 11000 corresponds to the inverse process of the arithmetic encoder 40004.

The octree synthesis unit 11001 according to the embodiments may generate an octree by acquiring an occupancy code from the decoded geometry bitstream (or information on the geometry secured as a result of decoding). The occupancy code is configured as described in detail with reference to FIGS. 1 to 9.

When the trisoup geometry encoding is applied, the surface approximation synthesis unit 11002 according to the embodiments may synthesize a surface based on the decoded geometry and/or the generated octree.

The geometry reconstruction unit 11003 according to the embodiments may regenerate geometry based on the surface and/or the decoded geometry. As described with reference to FIGS. 1 to 9, direct coding and trisoup geometry encoding are selectively applied. Accordingly, the geometry reconstruction unit 11003 directly imports and adds position information about the points to which direct coding is applied. When the trisoup geometry encoding is applied, the geometry reconstruction unit 11003 may reconstruct the geometry by performing the reconstruction operations of the geometry reconstruction unit 40005, for example, triangle reconstruction, up-sampling, and voxelization. Details are the same as those described with reference to FIG. 6, and thus description thereof is omitted. The reconstructed geometry may include a point cloud picture or frame that does not contain attributes.

The coordinates inverse transformation unit 11004 according to the embodiments may acquire positions of the points by transforming the coordinates based on the reconstructed geometry.

The arithmetic decoder 11005, the inverse quantization unit 11006, the RAHT transformation unit 11007, the LOD generation unit 11008, the inverse lifting unit 11009, and/or the color inverse transformation unit 11010 may perform the attribute decoding described with reference to FIG. 10. The attribute decoding according to the embodiments includes region adaptive hierarchical transform (RAHT) decoding, interpolation-based hierarchical nearest-neighbor prediction (prediction transform) decoding, and interpolation-based hierarchical nearest-neighbor prediction with an update/lifting step (lifting transform) decoding. The three decoding schemes described above may be used selectively, or a combination of one or more decoding schemes may be used. The attribute decoding according to the embodiments is not limited to the above-described example.

The arithmetic decoder 11005 according to the embodiments decodes the attribute bitstream by arithmetic coding.

The inverse quantization unit 11006 according to the embodiments inversely quantizes the information about the decoded attribute bitstream or attributes secured as a result of the decoding, and outputs the inversely quantized attributes (or attribute values). The inverse quantization may be selectively applied based on the attribute encoding of the point cloud video encoder.

According to embodiments, the RAHT transformation unit 11007, the LOD generation unit 11008, and/or the inverse lifting unit 11009 may process the reconstructed geometry and the inversely quantized attributes. As described above, the RAHT transformation unit 11007, the LOD generation unit 11008, and/or the inverse lifting unit 11009 may selectively perform a decoding operation corresponding to the encoding of the point cloud video encoder.

The color inverse transformation unit 11010 according to the embodiments performs inverse transform coding to inversely transform a color value (or texture) included in the decoded attributes. The operation of the color inverse transformation unit 11010 may be selectively performed based on the operation of the color transformation unit 40006 of the point cloud video encoder.

Although not shown in the figure, the elements of the point cloud video decoder of FIG. 11 may be implemented by hardware including one or more processors or integrated circuits configured to communicate with one or more memories included in the point cloud content providing apparatus, software, firmware, or a combination thereof. The one or more processors may perform at least one or more of the operations and/or functions of the elements of the point cloud video decoder of FIG. 11 described above. Additionally, the one or more processors may operate or execute a set of software programs and/or instructions for performing the operations and/or functions of the elements of the point cloud video decoder of FIG. 11.

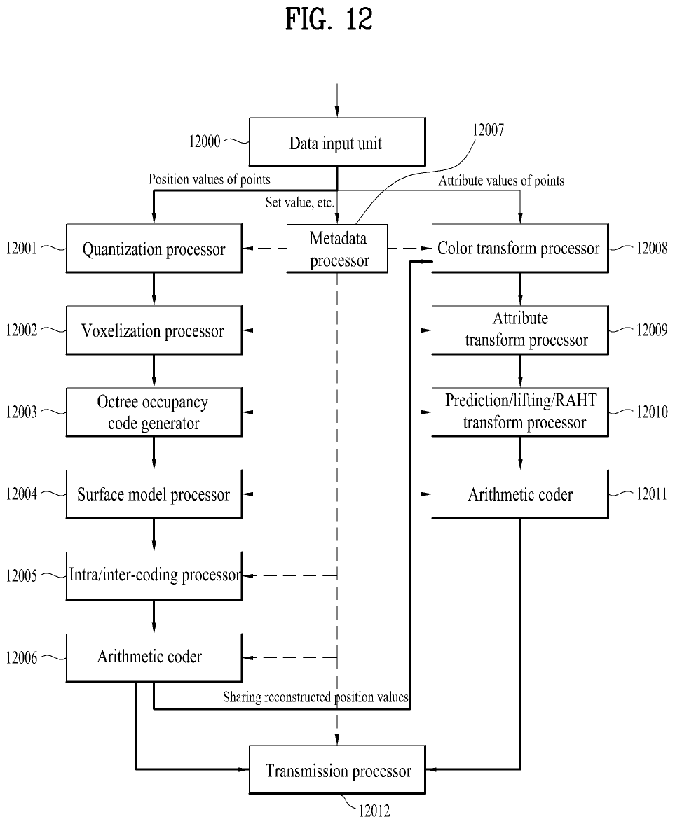

FIG. 12 illustrates a transmission device according to embodiments.

The transmission device shown in FIG. 12 is an example of the transmission device 10000 of FIG. 1 (or the point cloud video encoder of FIG. 4). The transmission device illustrated in FIG. 12 may perform one or more of the operations and methods the same as or similar to those of the point cloud video encoder described with reference to FIGS. 1 to 9. The transmission device according to the embodiments may include a data input unit 12000, a quantization processor 12001, a voxelization processor 12002, an octree occupancy code generator 12003, a surface model processor 12004, an intra/inter-coding processor 12005, an arithmetic coder 12006, a metadata processor 12007, a color transform processor 12008, an attribute transform processor 12009, a prediction/lifting/RAHT transform processor 12010, an arithmetic coder 12011 and/or a transmission processor 12012.

The data input unit 12000 according to the embodiments receives or acquires point cloud data. The data input unit 12000 may perform an operation and/or acquisition method the same as or similar to the operation and/or acquisition method of the point cloud video acquisition unit 10001 (or the acquisition process 20000 described with reference to FIG. 2).

The data input unit 12000, the quantization processor 12001, the voxelization processor 12002, the octree occupancy code generator 12003, the surface model processor 12004, the intra/inter-coding processor 12005, and the arithmetic coder 12006 perform geometry encoding. The geometry encoding according to the embodiments is the same as or similar to the geometry encoding described with reference to FIGS. 1 to 9, and thus a detailed description thereof is omitted.

The quantization processor 12001 according to the embodiments quantizes geometry (e.g., position values of points). The operation and/or quantization of the quantization processor 12001 is the same as or similar to the operation and/or quantization of the quantization unit 40001 described with reference to FIG. 4. Details are the same as those described with reference to FIGS. 1 to 9.

The voxelization processor 12002 according to the embodiments voxelizes the quantized position values of the points. The voxelization processor 12002 may perform an operation and/or process the same or similar to the operation and/or the voxelization process of the quantization unit 40001 described with reference to FIG. 4. Details are the same as those described with reference to FIGS. 1 to 9.

The octree occupancy code generator 12003 according to the embodiments performs octree coding on the voxelized positions of the points based on an octree structure. The octree occupancy code generator 12003 may generate an occupancy code. The octree occupancy code generator 12003 may perform an operation and/or method the same as or similar to the operation and/or method of the point cloud video encoder (or the octree analysis unit 40002) described with reference to FIGS. 4 and 6. Details are the same as those described with reference to FIGS. 1 to 9.

The surface model processor 12004 according to the embodiments may perform trisoup geometry encoding based on a surface model to reconstruct the positions of points in a specific region (or node) on a voxel basis. The surface model processor 12004 may perform an operation and/or method the same as or similar to the operation and/or method of the point cloud video encoder (for example, the surface approximation analysis unit 40003) described with reference to FIG. 4. Details are the same as those described with reference to FIGS. 1 to 9.

The intra/inter-coding processor 12005 according to the embodiments may perform intra/inter-coding on point cloud data. The intra/inter-coding processor 12005 may perform coding the same as or similar to the intra/inter-coding described with reference to FIG. 7. Details are the same as those described with reference to FIG. 7. According to embodiments, the intra/inter-coding processor 12005 may be included in the arithmetic coder 12006.

The arithmetic coder 12006 according to the embodiments performs entropy encoding on an octree of the point cloud data and/or an approximated octree. For example, the encoding scheme includes arithmetic encoding. The arithmetic coder 12006 performs an operation and/or method the same as or similar to the operation and/or method of the arithmetic encoder 40004.

The metadata processor 12007 according to the embodiments processes metadata about the point cloud data, for example, a set value, and provides the same to a necessary processing process such as geometry encoding and/or attribute encoding. Also, the metadata processor 12007 according to the embodiments may generate and/or process signaling information related to the geometry encoding and/or the attribute encoding. The signaling information according to the embodiments may be encoded separately from the geometry encoding and/or the attribute encoding. The signaling information according to the embodiments may be interleaved.

The color transform processor 12008, the attribute transform processor 12009, the prediction/lifting/RAHT transform processor 12010, and the arithmetic coder 12011 perform the attribute encoding. The attribute encoding according to the embodiments is the same as or similar to the attribute encoding described with reference to FIGS. 1 to 9, and thus a detailed description thereof is omitted.

The color transform processor 12008 according to the embodiments performs color transform coding to transform color values included in attributes. The color transform processor 12008 may perform color transform coding based on the reconstructed geometry. The reconstructed geometry is the same as described with reference to FIGS. 1 to 9. Also, it performs an operation and/or method the same as or similar to the operation and/or method of the color transformation unit 40006 described with reference to FIG. 4 is performed. The detailed description thereof is omitted.

The attribute transform processor 12009 according to the embodiments performs attribute transformation to transform the attributes based on the reconstructed geometry and/or the positions on which geometry encoding is not performed. The attribute transform processor 12009 performs an operation and/or method the same as or similar to the operation and/or method of the attribute transformation unit 40007 described with reference to FIG. 4. The detailed description thereof is omitted. The prediction/lifting/RAHT transform processor 12010 according to the embodiments may code the transformed attributes by any one or a combination of RAHT coding, prediction transform coding, and lifting transform coding. The prediction/lifting/RAHT transform processor 12010 performs at least one of the operations the same as or similar to the operations of the RAHT transformation unit 40008, the LOD generation unit 40009, and the lifting transformation unit 40010 described with reference to FIG. 4. In addition, the prediction transform coding, the lifting transform coding, and the RAHT transform coding are the same as those described with reference to FIGS. 1 to 9, and thus a detailed description thereof is omitted.

The arithmetic coder 12011 according to the embodiments may encode the coded attributes based on the arithmetic coding. The arithmetic coder 12011 performs an operation and/or method the same as or similar to the operation and/or method of the arithmetic encoder 40012.

The transmission processor 12012 according to the embodiments may transmit each bitstream containing encoded geometry and/or encoded attributes and metadata, or transmit one bitstream configured with the encoded geometry and/or the encoded attributes and the metadata. When the encoded geometry and/or the encoded attributes and the metadata according to the embodiments are configured into one bitstream, the bitstream may include one or more sub-bitstreams. The bitstream according to the embodiments may contain signaling information including a sequence parameter set (SPS) for signaling of a sequence level, a geometry parameter set (GPS) for signaling of geometry information coding, an attribute parameter set (APS) for signaling of attribute information coding, and a tile parameter set (TPS or tile inventory) for signaling of a tile level, and slice data. The slice data may include information about one or more slices. One slice according to embodiments may include one geometry bitstream Geom0⁰ and one or more attribute bitstreams Attr0⁰ and Attr1⁰.

A slice is a series of syntax elements representing the whole or part of the coded point cloud frame.

The TPS according to the embodiments may include information about each tile (for example, coordinate information and height/size information about a bounding box) for one or more tiles. The geometry bitstream may contain a header and a payload. The header of the geometry bitstream according to the embodiments may contain a parameter set identifier (geom_parameter_set_id), a tile identifier (geom_tile_id) and a slice identifier (geom_slice_id) included in the GPS, and information about the data contained in the payload. As described above, the metadata processor 12007 according to the embodiments may generate and/or process the signaling information and transmit the same to the transmission processor 12012. According to embodiments, the elements to perform geometry encoding and the elements to perform attribute encoding may share data/information with each other as indicated by dotted lines. The transmission processor 12012 according to the embodiments may perform an operation and/or transmission method the same as or similar to the operation and/or transmission method of the transmitter 10003. Details are the same as those described with reference to FIGS. 1 and 2, and thus a description thereof is omitted.

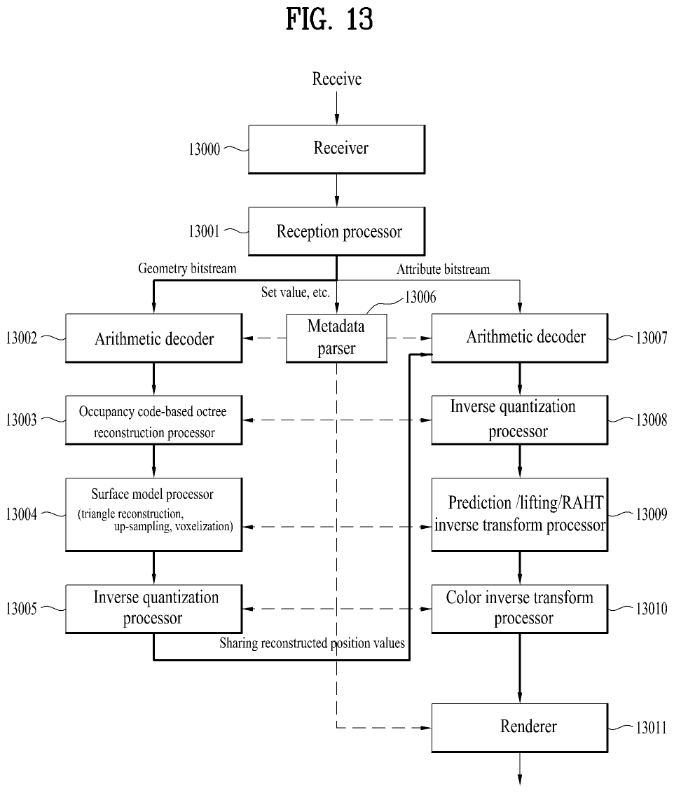

FIG. 13 illustrates a reception device according to embodiments.

The reception device illustrated in FIG. 13 is an example of the reception device 10004 of FIG. 1 (or the point cloud video decoder of FIGS. 10 and 11). The reception device illustrated in FIG. 13 may perform one or more of the operations and methods the same as or similar to those of the point cloud video decoder described with reference to FIGS. 1 to 11.

The reception device according to the embodiment includes a receiver 13000, a reception processor 13001, an arithmetic decoder 13002, an occupancy code-based octree reconstruction processor 13003, a surface model processor (triangle reconstruction, up-sampling, voxelization) 13004, an inverse quantization processor 13005, a metadata parser 13006, an arithmetic decoder 13007, an inverse quantization processor 13008, a prediction/lifting/RAHT inverse transform processor 13009, a color inverse transform processor 13010, and/or a renderer 13011. Each element for decoding according to the embodiments may perform an inverse process of the operation of a corresponding element for encoding according to the embodiments.

The receiver 13000 according to the embodiments receives point cloud data. The receiver 13000 may perform an operation and/or reception method the same as or similar to the operation and/or reception method of the receiver 10005 of FIG. 1. The detailed description thereof is omitted.

The reception processor 13001 according to the embodiments may acquire a geometry bitstream and/or an attribute bitstream from the received data. The reception processor 13001 may be included in the receiver 13000.

The arithmetic decoder 13002, the occupancy code-based octree reconstruction processor 13003, the surface model processor 13004, and the inverse quantization processor 1305 may perform geometry decoding. The geometry decoding according to embodiments is the same as or similar to the geometry decoding described with reference to FIGS. 1 to 10, and thus a detailed description thereof is omitted.

The arithmetic decoder 13002 according to the embodiments may decode the geometry bitstream based on arithmetic coding. The arithmetic decoder 13002 performs an operation and/or coding the same as or similar to the operation and/or coding of the arithmetic decoder 11000.

The occupancy code-based octree reconstruction processor 13003 according to the embodiments may reconstruct an octree by acquiring an occupancy code from the decoded geometry bitstream (or information about the geometry secured as a result of decoding). The occupancy code-based octree reconstruction processor 13003 performs an operation and/or method that is the same as or similar to the operation and/or octree generation method of the octree synthesis unit 11001. When the trisoup geometry encoding is applied, the surface model processor 13004 according to the embodiments may perform trisoup geometry decoding and related geometry reconstruction (for example, triangle reconstruction, up-sampling, voxelization) based on the surface model method. The surface model processor 13004 performs an operation that is the same as or similar to that of the surface approximation synthesis unit 11002 and/or the geometry reconstruction unit 11003.

The inverse quantization processor 13005 according to the embodiments may inversely quantize the decoded geometry.

The metadata parser 13006 according to the embodiments may parse metadata contained in the received point cloud data, for example, a set value. The metadata parser 13006 may pass the metadata to geometry decoding and/or attribute decoding. The metadata is the same as that described with reference to FIG. 12, and thus a detailed description thereof is omitted.

The arithmetic decoder 13007, the inverse quantization processor 13008, the prediction/lifting/RAHT inverse transform processor 13009 and the color inverse transform processor 13010 perform attribute decoding. The attribute decoding is the same as or similar to the attribute decoding described with reference to FIGS. 1 to 10, and thus a detailed description thereof is omitted.

The arithmetic decoder 13007 according to the embodiments may decode the attribute bitstream by arithmetic coding. The arithmetic decoder 13007 may decode the attribute bitstream based on the reconstructed geometry. The arithmetic decoder 13007 performs an operation and/or coding the same as or similar to the operation and/or coding of the arithmetic decoder 11005.

The inverse quantization processor 13008 according to the embodiments may inversely quantize the decoded attribute bitstream. The inverse quantization processor 13008 performs an operation and/or method the same as or similar to the operation and/or inverse quantization method of the inverse quantization unit 11006.

The prediction/lifting/RAHT inverse transform processor 13009 according to the embodiments may process the reconstructed geometry and the inversely quantized attributes. The prediction/lifting/RAHT inverse transform processor 13009 performs one or more of operations and/or decoding the same as or similar to the operations and/or decoding of the RAHT transformation unit 11007, the LOD generation unit 11008, and/or the inverse lifting unit 11009. The color inverse transform processor 13010 according to the embodiments performs inverse transform coding to inversely transform color values (or textures) included in the decoded attributes. The color inverse transform processor 13010 performs an operation and/or inverse transform coding the same as or similar to the operation and/or inverse transform coding of the color inverse transformation unit 11010. The renderer 13011 according to the embodiments may render the point cloud data.

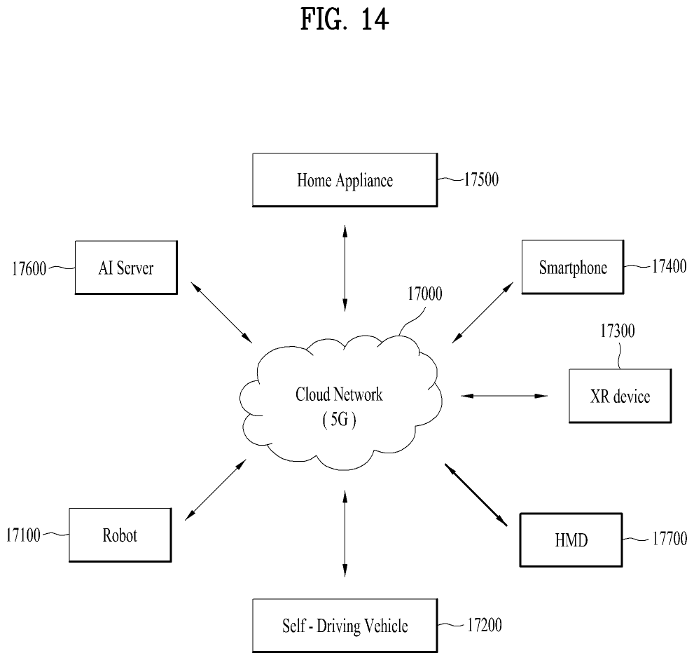

FIG. 14 shows an exemplary structure operatively connectable with a method/device for transmitting and receiving point cloud data according to embodiments.

The structure of FIG. 14 represents a configuration in which at least one of a server 17600, a robot 17100, a self-driving vehicle 17200, an XR device 17300, a smartphone 17400, a home appliance 17500, and/or a head-mount display (HMD) 17700 is connected to a cloud network 17100. The robot 17100, the self-driving vehicle 17200, the XR device 17300, the smartphone 17400, or the home appliance 17500 is referred to as a device. In addition, the XR device 17300 may correspond to a point cloud compressed data (PCC) device according to embodiments or may be operatively connected to the PCC device.

The cloud network 17000 may represent a network that constitutes part of the cloud computing infrastructure or is present in the cloud computing infrastructure. Here, the cloud network 17000 may be configured using a 3G network, 4G or Long Term Evolution (LTE) network, or a 5G network.

The server 17600 may be connected to at least one of the robot 17100, the self-driving vehicle 17200, the XR device 17300, the smartphone 17400, the home appliance 17500, and/or the HMD 17700 over the cloud network 17000 and may assist in at least a part of the processing of the connected devices 17100 to 17700.

The HMD 17700 represents one of the implementation types of the XR device and/or the PCC device according to the embodiments. The HMD type device according to the embodiments includes a communication unit, a control unit, a memory, an I/O unit, a sensor unit, and a power supply unit.

Hereinafter, various embodiments of the devices 17100 to 17500 to which the above-described technology is applied will be described. The devices 17100 to 17500 illustrated in FIG. 14 may be operatively connected/coupled to a point cloud data transmission device and reception according to the above-described embodiments.

<PCC+XR>

The XR/PCC device 17300 may employ PCC technology and/or XR (AR+VR) technology, and may be implemented as an HMD, a head-up display (HUD) provided in a vehicle, a television, a mobile phone, a smartphone, a computer, a wearable device, a home appliance, a digital signage, a vehicle, a stationary robot, or a mobile robot.

The XR/PCC device 17300 may analyze 3D point cloud data or image data acquired through various sensors or from an external device and generate position data and attribute data about 3D points. Thereby, the XR/PCC device 17300 may acquire information about the surrounding space or a real object, and render and output an XR object. For example, the XR/PCC device 17300 may match an XR object including auxiliary information about a recognized object with the recognized object and output the matched XR object.

<PCC+Self-Driving+XR>

The self-driving vehicle 17200 may be implemented as a mobile robot, a vehicle, an unmanned aerial vehicle, or the like by applying the PCC technology and the XR technology.

The self-driving vehicle 17200 to which the XR/PCC technology is applied may represent a self-driving vehicle provided with means for providing an XR image, or a self-driving vehicle that is a target of control/interaction in the XR image. In particular, the self-driving vehicle 17200 which is a target of control/interaction in the XR image may be distinguished from the XR device 17300 and may be operatively connected thereto.

The self-driving vehicle 17200 having means for providing an XR/PCC image may acquire sensor information from sensors including a camera, and output the generated XR/PCC image based on the acquired sensor information. For example, the self-driving vehicle 17200 may have an HUD and output an XR/PCC image thereto, thereby providing an occupant with an XR/PCC object corresponding to a real object or an object present on the screen.

When the XR/PCC object is output to the HUD, at least a part of the XR/PCC object may be output to overlap the real object to which the occupant's eyes are directed. On the other hand, when the XR/PCC object is output on a display provided inside the self-driving vehicle, at least a part of the XR/PCC object may be output to overlap an object on the screen. For example, the self-driving vehicle 17200 may output XR/PCC objects corresponding to objects such as a road, another vehicle, a traffic light, a traffic sign, a two-wheeled vehicle, a pedestrian, and a building.

The virtual reality (VR) technology, the augmented reality (AR) technology, the mixed reality (MR) technology and/or the point cloud compression (PCC) technology according to the embodiments are applicable to various devices.

In other words, the VR technology is a display technology that provides only CG images of real-world objects, backgrounds, and the like. On the other hand, the AR technology refers to a technology that shows a virtually created CG image on the image of a real object. The MR technology is similar to the AR technology described above in that virtual objects to be shown are mixed and combined with the real world. However, the MR technology differs from the AR technology in that the AR technology makes a clear distinction between a real object and a virtual object created as a CG image and uses virtual objects as complementary objects for real objects, whereas the MR technology treats virtual objects as objects having equivalent characteristics as real objects. More specifically, an example of MR technology applications is a hologram service.

Recently, the VR, AR, and MR technologies are sometimes referred to as extended reality (XR) technology rather than being clearly distinguished from each other. Accordingly, embodiments of the present disclosure are applicable to any of the VR, AR, MR, and XR technologies. The encoding/decoding based on PCC, V-PCC, and G-PCC techniques is applicable to such technologies.

The PCC method/device according to the embodiments may be applied to a vehicle that provides a self-driving service.

A vehicle that provides the self-driving service is connected to a PCC device for wired/wireless communication.

When the point cloud compression data (PCC) transmission/reception device according to the embodiments is connected to a vehicle for wired/wireless communication, the device may receive/process content data related to an AR/VR/PCC service, which may be provided together with the self-driving service, and transmit the same to the vehicle. In the case where the PCC transmission/reception device is mounted on a vehicle, the PCC transmission/reception device may receive/process content data related to the AR/VR/PCC service according to a user input signal input through a user interface device and provide the same to the user. The vehicle or the user interface device according to the embodiments may receive a user input signal. The user input signal according to the embodiments may include a signal indicating the self-driving service.

Meanwhile, the point cloud video encoder on the transmitting side may further perform a spatial partitioning process of spatially partitioning (or dividing) the point cloud data into one or more 3D blocks before encoding the point cloud data. That is, in order for the encoding and transmission operations of the transmission device and the decoding and rendering operations of the reception device to be performed in real time and processed with low latency, the transmission device may spatially partition the point cloud data into a plurality of regions. In addition, the transmission device may independently or non-independently encode the spatially partitioned regions (or blocks), thereby enabling random access and parallel encoding in the three-dimensional space occupied by the point cloud data. In addition, the transmission device and the reception device may perform encoding and decoding independently or non-independently for each spatially partitioned region (or block), thereby preventing errors from being accumulated in the encoding and decoding process.

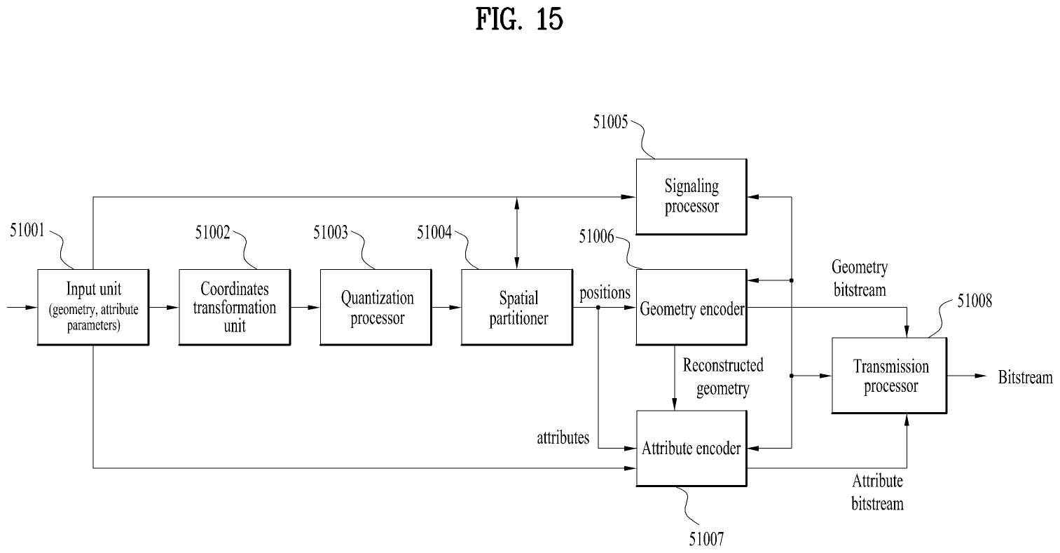

FIG. 15 is a diagram illustrating another example of a point cloud transmission device according to embodiments, including a spatial partitioner.

The point cloud transmission device according to the embodiments may include a data input unit 51001, a coordinates transformation unit 51002, a quantization processor 51003, a spatial partitioner 51004, a signaling processor 51005, a geometry encoder 51006, an attribute encoder 51007, and a transmission processor 51008. According to embodiments, the coordinates transformation unit 51002, the quantization processor 51003, the spatial partitioner 51004, the geometry encoder 51006, and the attribute encoder 51007 may be referred to as point cloud video encoders.

The data input unit 51001 may perform some or all of the operations of the point cloud video acquisition unit 10001 of FIG. 1, or may perform some or all of the operations of the data input unit 12000 of FIG. 12. The coordinates transformation unit 51002 may perform some or all of the operations of the coordinates transformation unit 40000 of FIG. 4. Further, the quantization processor 51003 may perform some or all of the operations of the quantization unit 40001 of FIG. 4, or may perform some or all of the operations of the quantization processor 12001 of FIG. 12.

The spatial partitioner 51004 may spatially partition the point cloud data quantized and output from the quantization processor 51003 into one or more 3D blocks based on a bounding box and/or a sub-bounding box. Here, the 3D block may refer to a tile group, a tile, a slice, a coding unit (CU), a prediction unit (PU), or a transform unit (TU). In one embodiment, the signaling information for spatial partition is entropy-encoded by the signaling processor 51005 and then transmitted through the transmission processor 51008 in the form of a bitstream.

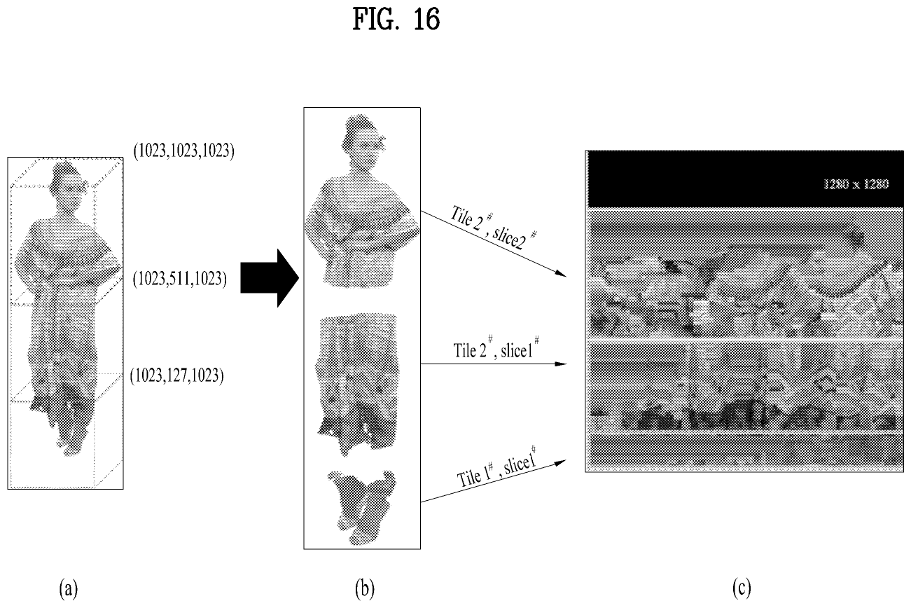

FIGS. 16a to 16c illustrate an embodiment of partitioning a bounding box into one or more tiles. As shown in FIG. 16a, a point cloud object, which corresponds to point cloud data, may be expressed in the form of a box based on a coordinate system, which is referred to as a bounding box. In other words, the bounding box represents a cube capable of containing all points of the point cloud.

FIGS. 16b and 16c illustrate an example in which the bounding box of FIG. 16a is partitioned into tile 1 # and tile 2 #, and tile 2 # is partitioned again into slice 1 # and slice 2 #.

In one embodiment, the point cloud content may be one person such as an actor, multiple people, one object, or multiple objects. In a larger range, it may be a map for autonomous driving or a map for indoor navigation of a robot. In this case, the point cloud content may be a vast amount of locally connected data. In this case, the point cloud content cannot be encoded/decoded at once, and accordingly tile partitioning may be performed before the point cloud content is compressed. For example, room #101 in a building may be partitioned into one tile and room #102 in the building may be partitioned into another tile. In order to support fast encoding/decoding by applying parallelization to the partitioned tiles, the tiles may be partitioned (or split) into slices again. This operation may be referred to as slice partitioning (or splitting).

That is, a tile may represent a partial region (e.g., a rectangular cube) of a 3D space occupied by point cloud data according to embodiments. According to embodiments, a tile may include one or more slices. The tile according to the embodiments may be partitioned into one or more slices, and thus the point cloud video encoder may encode point cloud data in parallel.

A slice may represent a unit of data (or bitstream) that may be independently encoded by the point cloud video encoder according to the embodiments and/or a unit of data (or bitstream) that may be independently decoded by the point cloud video decoder. A slice may be a set of data in a 3D space occupied by point cloud data, or a set of some data among the point cloud data. A slice according to the embodiments may represent a region or set of points included in a tile according to embodiments. According to embodiments, a tile may be partitioned into one or more slices based on the number of points included in one tile. For example, one tile may be a set of points partitioned by the number of points. According to embodiments, a tile may be partitioned into one or more slices based on the number of points, and some data may be split or merged in the partitioning process. That is, a slice may be a unit that may be independently coded within a corresponding tile. In this way, a tile obtained by spatially partitioning may be partitioned into one or more slices for fast and efficient processing.

The point cloud video encoder according to the embodiments may encode point cloud data on a slice-by-slice basis or a tile-by-tile basis, wherein a tile includes one or more slices. In addition, the point cloud video encoder according to the embodiments may perform different quantization and/or transformation for each tile or each slice.

Positions of one or more 3D blocks (e.g., tiles or slices) spatially partitioned by the spatial partitioner 51004 are output to the geometry encoder 51006, and the attribute information (or attributes) is output to the attribute encoder 51007. The positions may be position information about the points included in a partitioned unit (box, block, tile, tile group, or slice), and are referred to as geometry information.

The geometry encoder 51006 constructs and encodes (i.e., compresses) an octree based on the positions output from the spatial partitioner 51004 to output a geometry bitstream. The geometry encoder 51006 may reconstruct an octree and/or an approximated octree and output the same to the attribute encoder 51007. The reconstructed octree may be referred to as reconstructed geometry (or restored geometry) using posion information changed through compression.

The attribute encoder 51007 encodes (i.e., compresses) the attributes output from the spatial partitioner 51004 based on the reconstructed geometry output from the geometry encoder 51006, and outputs an attribute bitstream.

In the geometry information compression process, an octree technique or a trisoup technique may be used. The geometry information compression process according to the embodiments may include quantization of geometry information, voxelization, generation of an octree for managing an occupied voxel, and encoding occupancy bits (or occupied bits) in each node of the octree. When the trisoup is used, an operation of transforming the geometry information into information of vertex segments for forming a triangle may be additionally included in addition to the operation of generating the octree.

The reception device receives the geometry bitstream and an attribute bitstream, decodes the geometry information, and decodes the attribute information based on the geometry reconstructed through the decoding.

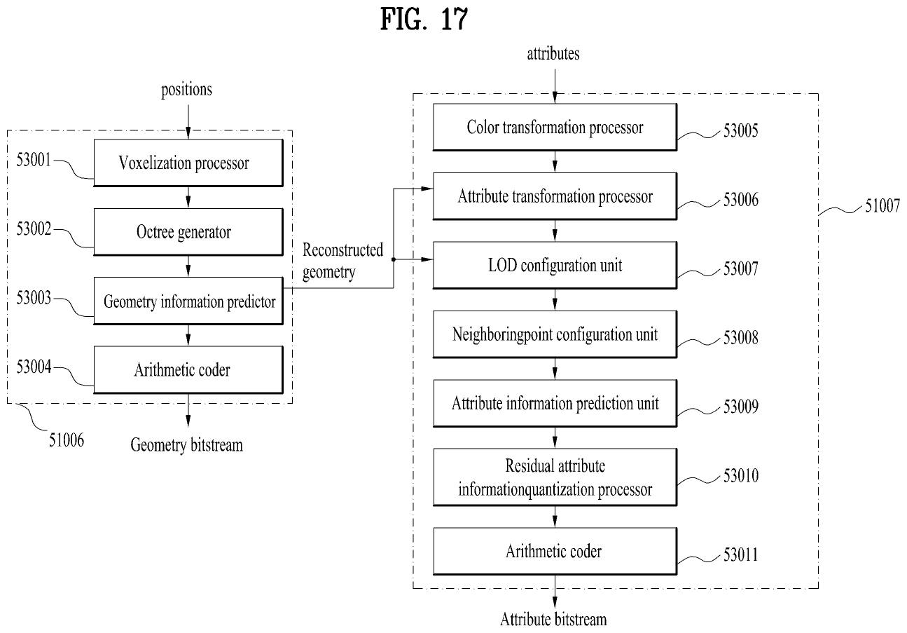

FIG. 17 is a detailed block diagram illustrating another example of the geometry encoder 51006 and the attribute encoder 51007 according to embodiments.

The geometry encoder 51006 of FIG. 17 may include a voxelization processor 53001, an octree generator 53002, a geometry information predictor 53003, and an arithmetic coder 53004. This is merely an embodiment. Some blocks may not be included in the geometry encoder 51006, or other blocks may be further included in the geometry encoder 51006.

The voxelization processor 53001, the octree generator 53002, the geometry information predictor 53003, and the arithmetic coder 53004 of the geometry encoder 51006 of FIG. 17 may perform some or all of the operations of the octree analysis unit 40002, the surface approximation analysis unit 40003, the arithmetic encoder 40004, and the geometry reconstruction unit 40005 of FIG. 4, or may perform some or all of the operations of the voxelization processor 12002, the octree occupancy code generator 12003, and the surface model processor 12004, the intra/inter-coding processor 12005, and the arithmetic coder 12006 of FIG. 12.

The attribute encoder 51007 of FIG. 17 may include a color transformation processor 53005, an attribute transformation processor 53006, an LOD configurator 53007, a neighbor set configurator 53008, an attribute information predictor 53009, a residual attribute information quantization processor 53010, and an arithmetic coder 53011. This is merely an embodiment. Some blocks may not be included in the attribute encoder 51007, and other blocks may be further included in the attribute encoder 51007.

In an embodiment, a quantization processor may be further provided between the spatial partitioner 51004 and the voxelization processor 53001. The quantization processor quantizes positions of one or more 3D blocks (e.g., tiles or slices) spatially partitioned by the spatial partitioner 51004. In this case, the quantization processor may perform some or all of the operations of the quantization unit 40001 of FIG. 4, or perform some or all of the operations of the quantization processor 12001 of FIG. 12. When the quantization processor is further provided between the spatial partitioner 51004 and the voxelization processor 53001, the quantization processor 51003 of FIG. 15 may or may not be omitted.

The voxelization processor 53001 according to the embodiments performs voxelization based on the positions of the one or more spatially partitioned 3D blocks (e.g., tiles or slices) or the quantized positions thereof. Voxelization refers to the minimum unit expressing position information in a 3D space. Points of point cloud content (or 3D point cloud video) according to embodiments may be included in one or more voxels. According to embodiments, one voxel may include one or more points. In an embodiment, in the case where quantization is performed before voxelization is performed, a plurality of points may belong to one voxel.

In the present specification, when two or more points are included in one voxel, the two or more points are referred to as duplicated points or multiple points. That is, in the geometry encoding/decoding processes, duplicated points may be generated through geometry quantization and voxelization.

According to embodiments, the voxelization processor 53001 or the octree generator 53002 may or may not merge duplicated points belonging to one voxel into one point.

The process of processing duplicated points belonging to one voxel by the voxelization processor 53001 or the octree generator 53002 will be described in detail later.

The octree generator 53002 according to the embodiments generates an octree based on a voxel output from the voxelization processor 53001.

The geometry information predictor 53003 according to the embodiments predicts and compresses geometry information based on the octree generated by the octree generator 53002, and outputs the predicted and compressed information to the arithmetic coder 53004. In addition, the geometry information predictor 53003 reconstructs the geometry based on the positions changed through compression, and outputs the reconstructed (or decoded) geometry to the LOD configurator 53007 of the attribute encoder 51007. The reconstruction of the geometry information may be performed in a device or component separate from the geometry information predictor 53003. In another embodiment, the reconstructed geometry may also be provided to the attribute transformation processor 53006 of the attribute encoder 51007.

The color transformation processor 53005 of the attribute encoder 51007 corresponds to the color transformation unit 40006 of FIG. 4 or the color transformation processor 12008 of FIG. 12. The color transformation processor 53005 according to the embodiments performs color transformation coding of transforming color values (or textures) included in the attributes provided from the data input unit 51001 and/or the spatial partitioner 51004. For example, the color transformation processor 53005 may transform the format of color information (e.g., from RGB to YCbCr). The operation of the color transformation processor 53005 according to the embodiments may be optionally applied according to color values included in the attributes. In another embodiment, the color transformation processor 53005 may perform color transformation coding based on the reconstructed geometry. For this, the reconstructed geometry may be provided to the color transformation processor 53005. For details of the geometry reconstruction, refer to the description of FIGS. 1 to 9.

The attribute transformation processor 53006 according to the embodiments may perform attribute transformation of transforming attributes based on positions on which geometry encoding has not been performed and/or the reconstructed geometry.

The attribute transformation processor 53006 may be referred to as a recoloring unit.

The operation of the attribute transformation processor 53006 according to the embodiments may be optionally applied according to whether duplicated points are merged. According to an embodiment, merging of the duplicated points may be performed by the voxelization processor 53001 or the octree generator 53002 of the geometry encoder 51006.

In the present specification, when points belonging to one voxel are merged into one point in the voxelization processor 53001 or the octree generator 53002, the attribute transformation processor 53006 performs an attribute transformation. Take an example.

The attribute transformation processor 53006 performs an operation and/or method identical or similar to the operation and/or method of the attribute transformation unit 40007 of FIG. 4 or the attribute transformation processor 12009 of FIG. 12.

According to embodiments, the geometry information reconstructed by the geometry information predictor 53003 and the attribute information output from the attribute transformation processor 53006 are provided to the LOD configurator 53007 for attribute compression.

According to embodiments, the attribute information output from the attribute transformation processor 53006 may be compressed by one or a combination of two or more of RAHT coding, LOD-based predictive transform coding, and lifting transform coding based on the reconstructed geometry information.

Hereinafter, it is assumed that attribute compression is performed by one or a combination of the LOD-based predictive transform coding and the lifting transform coding as an embodiment. Thus, a description of the RAHT coding will be omitted. For details of the RAHT transform coding, refer to the descriptions of FIGS. 1 to 9.

The LOD configurator 53007 according to the embodiments generates a Level of Detail (LOD).

The LOD is a degree representing the detail of the point cloud content. As the LOD value decreases, it indicates that the detail of the point cloud content is degraded. As the LOD value increases, it indicates that the detail of the point cloud content is enhanced. Points may be classified according to the LOD.

In an embodiment, in the predictive transform coding and the lifting transform coding, points may be divided into LODs and grouped.

This operation may be referred to as an LOD generation process, and a group having different LODs may be referred to as a set LOD₁. Here, 1 denotes the LOD and is an integer starting from 0. LOD₀ is a set consisting of points with the largest distance therebetween. As 1 increases, the distance between points belonging to LOD₁ decreases. When the set LOD₁ is generated by the LOD configurator 53007, the neighbor set configurator 53008 may search for points X (>0) nearest neighbors in a group having the same or lower LODs (that is, large distances between nodes) based on the set LOD₁ and register the points as a set neighbor in a predictor. X is the maximum number of points that may be configured as neighbor points, and may have a fixed value or be input as a user parameter.

In an embodiment, the LOD configurator 53007 may sort all points of the reconstructed geometry based on the Morton code, and generate LODs in the sorted state. In this case, the generated LODs may all be sorted based on the Morton code. In an embodiment, the neighbor set configurator 53008 may search for neighbor points in a range before/after the current point based on points close to the current point in terms of Morton code based on the order of sorting.

Referring to FIG. 9 as an example, neighbors of P3 belonging to LOD₁ may be searched for in LOD₀ and LOD₁. For example, when the maximum number (X) of points that may be set as neighbors is 3, three nearest neighbor nodes of P3 may be P2, P4 and P6. Here, X=3 is merely an embodiment configured to provide understanding of the present disclosure. The value of X may vary.

As described above, all points of the point cloud data may each have a predictor.

The attribute information predictor 53009 predicts an attribute based on neighbor points registered in the predictor of a corresponding point based on the prediction mode.

According to embodiments, any one of prediction mode 0 to prediction mode 3 may be selected as the prediction mode of the point.

According to embodiments, in prediction mode 0, the average (i.e., the average of values obtained by multiplying the attributes (e.g., color, reflectance, etc.) of the neighbor points registered in the predictor of the corresponding point by a weight (or normalized weight) may be configured as a predicted attribute value. In prediction mode 1, the attribute of the first neighbor point may be configured as a predicted attribute value. In prediction mode 2, the attribute of the second neighbor point may be configured as a predicted attribute value. In prediction mode 3, the attribute of the third neighbor point may be configured as a predicted attribute value.

According to embodiments, the predicted attribute value may be referred to as predicted attribute information.

A residual attribute value (or residual attribute information or residual) of the point may be obtained by subtracting the predicted attribute value (referred to as predicted attribute information) estimated based on the prediction mode of the point from the attribute value (i.e., the original attribute value) of the point.

In an embodiment, for a specific point, the prediction mode may be fixed to one (e.g., prediction mode 0) of prediction mode 0 to prediction mode 3, or a prediction mode having the smallest residual attribute among the residual attribute values for the respective prediction modes may be selected as the prediction mode of the point.

In addition, the prediction mode used to obtain the predicted attribute value of each point and the corresponding residual attribute value are output to the residual attribute information quantization processor 53010.

According to embodiments, the residual attribute information quantization processor 53010 may apply zero run-length coding to the input residual attribute values.

The arithmetic coder 53011 outputs an attribute bitstream by applying arithmetic coding to the prediction modes and residual attribute values output from the residual attribute information quantization processor 53010.

The geometry bitstream compressed and output by the geometry encoder 51006 and the attribute bitstream compressed and output by the attribute encoder 51007 are output to the transmission processor 51008.

The transmission processor 51008 according to the embodiments may perform an operation and/or transmission method identical or similar to the operation and/or transmission method of the transmission processor 12012 of FIG. 12, and perform an operation and/or transmission method identical or similar to the operation and/or transmission method of the transmitter 10003 of FIG. 1. For details, reference will be made to the description of FIG. 1 or 12.

The transmission processor 51008 according to the embodiments may transmit the geometry bitstream output from the geometry encoder 51006, the attribute bitstream output from the attribute encoder 51007, and the signaling bitstream output from the signaling processor 51005, respectively, or may multiplex the bitstreams into one bitstream to be transmitted.

The transmission processor 51008 according to the embodiments may encapsulate the bitstream into a file or segment (e.g., a streaming segment) and then transmit the encapsulated bitstream over various networks such as a broadcasting network and/or a broadband network.

The signaling processor 51005 according to the embodiments may generate and/or process signaling information and output the same to the transmission processor 51008 in the form of a bitstream. The signaling information generated and/or processed by the signaling processor 51005 will be provided to the geometry encoder 51006, the attribute encoder 51007, and/or the transmission processor 51008 for geometry encoding, attribute encoding, and transmission processing. Alternatively, the signaling processor 51005 may receive signaling information generated by the geometry encoder 51006, the attribute encoder 51007, and/or the transmission processor 51008.

In the present disclosure, the signaling information may be signaled and transmitted on a per parameter set (sequence parameter set (SPS), geometry parameter set (GPS), attribute parameter set (APS), tile parameter set (TPS), or the like) basis. Also, it may be signaled and transmitted on the basis of a coding unit of each image, such as slice or tile. In the present disclosure, signaling information may include metadata (e.g., set values) related to point cloud data, and may be provided to the geometry encoder 51006, the attribute encoder 51007, and/or the transmission processor 51008 for geometry encoding, attribute encoding, and transmission processing. Depending on the application, the signaling information may also be defined at the system side, such as a file format, dynamic adaptive streaming over HTTP (DASH), or MPEG media transport (MMT), or at the wired interface side, such as high definition multimedia interface (HDMI), Display Port, Video Electronics Standards Association (VESA), or CTA.

A method/device according to the embodiments may signal related information to add/perform an operation of the embodiments. The signaling information according to the embodiments may be used in a transmission device and/or a reception device.

Hereinafter, a process of processing duplicated points belonging to one voxel by the voxelization processor 53001 or the octree generator 53002 will be described in detail.

The quantizer 51003 according to the embodiments quantizes geometry information (e.g., position values of points). For example, the quantizer 51003 may quantize the points based on the minimum position value (e.g., the minimum value on each of the X, Y, and Z axes) of all points. The quantizer 51003 performs a quantization operation of multiplying the difference between the minimum position value and the position value of each point by a preset quantization scale (or quantization coefficient value) and then finding the nearest integer by rounding the value obtained through the multiplication. Thus, one or more points may have the same quantized position (or position value).

The geometry encoder 51006 according to the embodiments performs voxelization based on the quantized positions of the points to reconstruct quantized points.

The duplicated point processing of the present disclosure may be processed while the voxelization is performed by the geometry encoder 51006. That is, in lossy compression, the quantized position value is matched with a specific voxel. In this case, several points may belong to a voxel.

In the present disclosure, multiple points belonging to one voxel are referred to as duplicated points. Duplicated points may be produced in voxelizing the quantized positions, and may also be produced in the voxelizing positions which are not quantized. Also, there may be content having many duplicated points in a voxel, which may depend on the characteristics of the content.

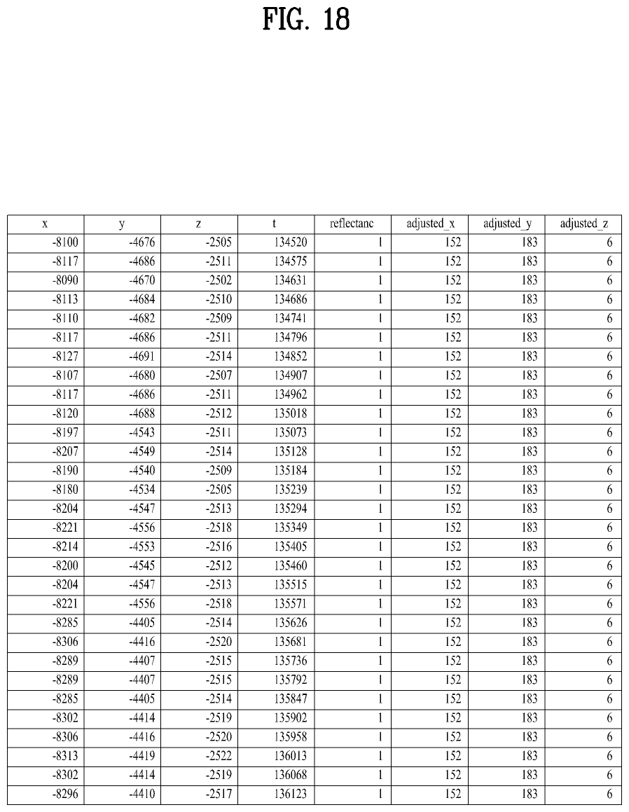

FIG. 18 is a table showing an example of presence of a plurality of points (e.g., 30 points) in a voxel (152, 183, 6) of specific content according to embodiments. The in-voxel positions of the duplicated points included in the voxel may all be different from each other, or the positions of only some of the points may be different from each other. In the example of FIG. 18, the positions of some of the 30 duplicated points are different from each other in the voxel (152, 183, 6).

According to embodiments, one or more voxels in the same content may each include a plurality of duplicated points.

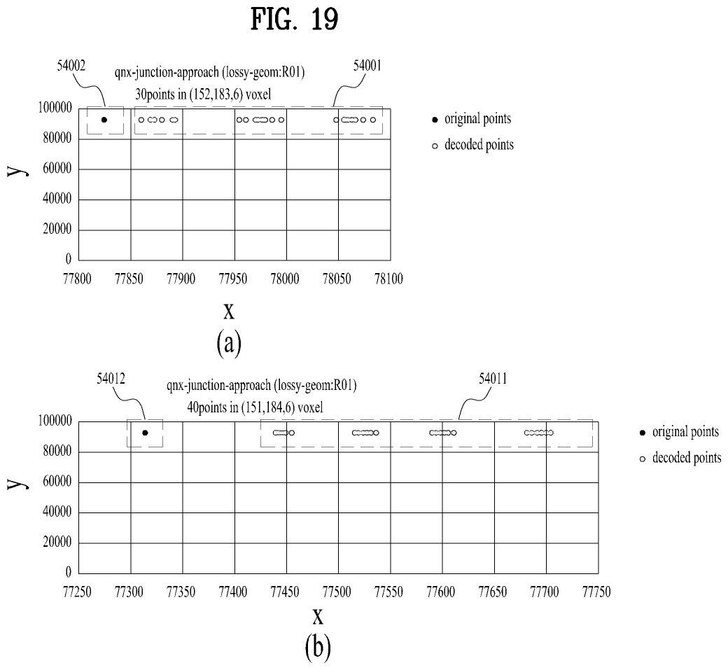

FIG. 19a is a graph depicting an example in which 30 points are included in a voxel (152, 183, 6) of content.

FIG. 19b is a graph depicting an example in which 40 points are included in another voxel (151, 184, 6) of the same content as that of FIG. 19a.

As shown in FIG. 19a, original duplicated points 54001 may be integrated into a specific voxel position (i.e., a decoded point) 54002, and geometry information thereon may be lossy compressed. As shown in FIG. 19b, original duplicated points 54011 may be integrated into a specific voxel position (i.e., a decoded point) 54012, and geometry information thereon may be lossy compressed

As an example, in FIG. 19a, the difference in position value between the voxel (152, 183, 6) and the farthest point is 262 on the x-axis, 311 on the y-axis, and 435 on the z-axis. That is, when lossy compression is performed on the geometry information, all values in between may be ignored.

However, there may be cases where one voxel does not include many points depending on the characteristics of content even though lossy compression is performed. Accordingly, characteristics related to merging duplicated points included in one voxel may vary according to the characteristics of the content.

Therefore, the loss of the geometry value may be predicted from the geometry quantization value (i.e., quantization coefficient). However, when merging of duplicated points is performed together, the image quality may depend on the characteristics of the content, which makes it difficult to control the degree of loss. That is, when duplicated point merging is performed on content including many points in a voxel, more loss may be caused due to merging of duplicated points in addition to quantization, depending on content. In other words, even when the geometry information is quantized using the same quantization coefficient, the size of the bitstream and the PNRN value may be significantly varied depending on whether the duplicated points are merged into one point to be transmitted or are transmitted without being merged.

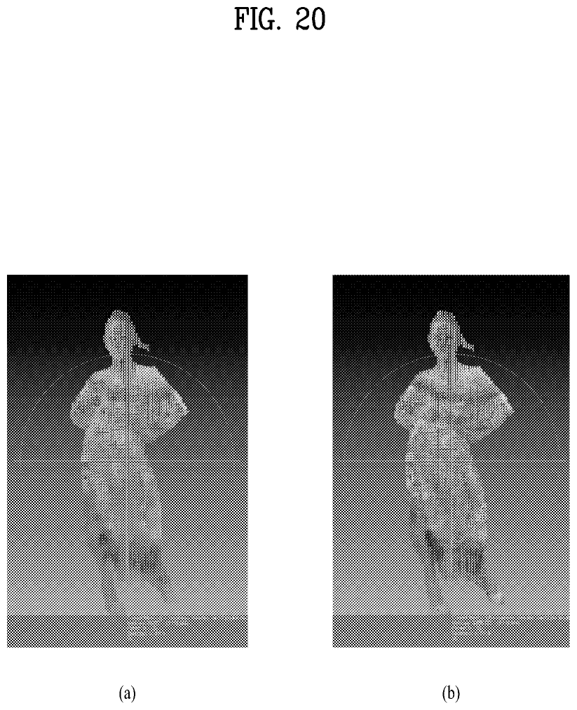

FIGS. 20a and 20b illustrate a case where duplicated points are merged after quantization by applying the same quantization parameter to the same image and a case where the duplicated points are not merged after the quantization according to embodiments. That is, the figures show that the quality of an image obtained without merging duplicated points after quantization as in FIG. 20b is better than that of the image obtained by merging the duplicated points after the quantization as in FIG. 20a.

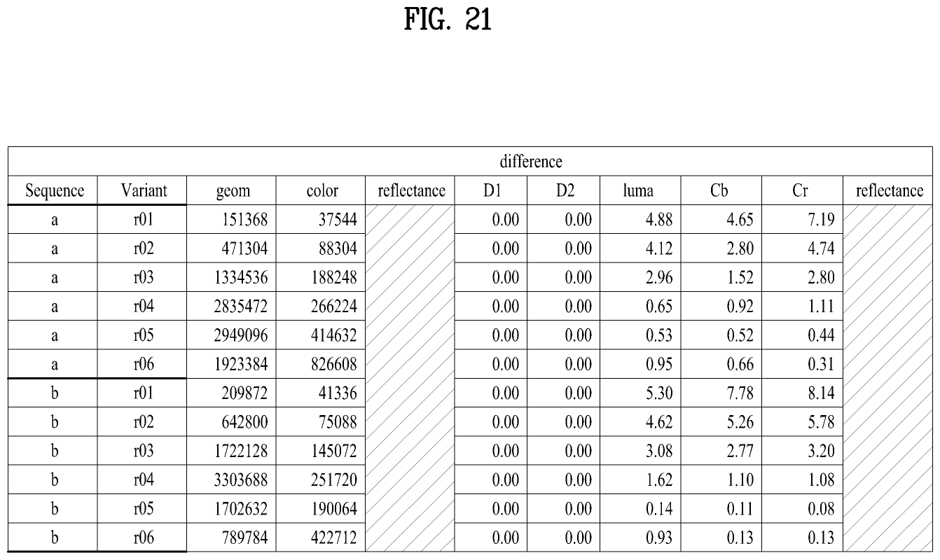

FIG. 21 is a table showing examples of a difference in image quality according to whether duplicated points are merged according to embodiments. That is, the figure shows examples of a difference in bit size between the geometry and the attribute, a difference in peak noise-to-signal ratio (PNSR) (D1, D2), and a difference in peak signal-to-noise ratio (PSNR) (luma, Cb, Cr) of the geometry and attribute given when the same geometry quantization value (i.e., quantization parameter) is applied.

Referring to FIG. 21, since merging duplicated points does not consistently yield a loss of a certain ratio according to the characteristics of the content, predictability of the degree of geometry loss may be lowered in configuring a quantization parameter (QP) (or quantization index).

Therefore, in the present disclosure, duplicated point processing capable of compensating for ambiguity of visual quality control and increasing the PSNR and visual quality is proposed.

In particular, the present disclosure proposes a method and apparatus for reducing the degree of unpredictable change in the degree of loss caused by duplicated point processing and quantization depending on the characteristics of content and the geometry quantization value.

For example, in merging duplicated points into one point, a representative color is designated. When the attributes of the duplicated points are different from each other, the PSNR may be reduced because the colors of excessively many points may be ignored. Accordingly, the present disclosure proposes an apparatus and method for increasing the PSNR by improving a duplicated point processing method.

As another example, even when all duplicated points belonging to one voxel have the same attribute, the details of the shape of the geometry may vary because geometry information about all duplicated points belonging to one voxel is integrated. Accordingly, the present disclosure proposes an apparatus and method for improving a visual quality by improving the duplicated point processing method.

As another example, when duplicated points belonging to one voxel are transmitted without being merged, the size of the transmitted bitstream may increase. Accordingly, the present disclosure proposes an apparatus and method for providing better visual quality while reducing the size of a bitstream even when duplicated points are transmitted without being merged.

According to embodiments, in the present disclosure, lossy compression is performed on geometry information according to a quantization value for predicting a loss of geometry regardless of the density of content or a region of the content. When a plurality of points is included in a voxel due to high density, and the number of the points is greater than a preset threshold (e.g., the maximum number of points that may be included in one voxel (max_duplicated_point)), the length of the tree may be virtually extended to make the geometry loss predictable.

According to embodiments, max_duplicated_point, the maximum number of points that may be included in a voxel, max_duplicated_point, may be signaled in signaling information. According to embodiments, the maximum number of points that may be included in the voxel, max_duplicated_point, may be signaled in at least one of a geometry parameter set (GPS), a tile parameter set (TPS), or a geometry slice header (GSH). According to embodiments, the maximum number of points that may be included in a sub-voxel may also be signaled in at least one of the GPS, the TPS, or the GSH. The maximum number of points that may be included in a voxel may or may not be equal to the maximum number of points that may be included in a sub-voxel. According to embodiments, the maximum number of points that may be included in a voxel and the maximum number of points that may be included in a sub-voxel may be fixed values known to the transmitting side/receiving side. In this case, separate signaling may not be required.

By controlling the degree of geometry loss, the degree of damage and increase in size of the bitstream through the geometry duplicated point processing according to the embodiments, the compression efficiency of the geometry and/or the attribute may be increased.

The geometry duplicated point processing according to the embodiments may be performed by the geometry encoder 51006 of the point cloud video encoder. The geometry duplicated point processing may be performed by the voxelization processor 53001 or the octree generator 53002 of the geometry encoder 51006. The result of the duplicated point processing performed by the geometry encoder 51006 may also affect the attribute encoder.

According to an embodiment of the present disclosure, when a plurality of points is present in a voxel, duplicated point processing may be differently performed according to the number of points included in the voxel. In other words, according to an embodiment of the present disclosure, adaptive duplicated point merging may be performed.

According to embodiments, when the number of the plurality of points present in a voxel is greater than a preset threshold (e.g., the maximum number of points that may be present in a voxel), the length of the tree may be virtually extended and the voxel may be divided or partitioned into one or more sub-voxels, enabling prediction of the geometry loss.

According to embodiments, the attribute information may be encoded (on the transmitting side) and decoded (on the receiving side) based on the reconstructed geometry information including sub-voxels.

According to embodiments, signaling related to whether to partition a voxel into sub-voxels, a method of partitioning the voxel into sub-voxels, and a method of generating a sub-voxel occupancy bit is supported.

That is, on the receiving side, the geometry information and the attribute information may be decoded based on information related to whether to partition a voxel into sub-voxels, information related to the sub-voxel partitioning method, information related to the sub-voxel occupancy bit generation method, and the like included in the signaling information.

According to embodiments, a cube having a width, depth, and height equal to 1 may be determined as one voxel. In addition, it may be determined which voxel the point belongs to according to the integerized point position value. Accordingly, no point may belong to a voxel, or one point or several points may belong to the voxel. In general, when lossy geometry compression is performed through geometry quantization, multiple points may be present in a voxel. Alternatively, multiple points may present in a voxel although the original point cloud content has not undergone the geometry quantization. When multiple points are present in a voxel, the points belonging to the voxel may be integrated into one point, or point position information may be directly coded for an additional point, depending on whether duplication is allowed. In the case where a plurality of points is integrated into one point, an operation of configuring a representative color for the point in a subsequent step may be included, resulting in a loss related to geometry and attributes.

In the present disclosure, when two or more points are included in a voxel, an optimized bitstream size is provided, a different duplicated point processing method may be used according to the number of points included in the voxel, such that the PSNR and visual quality may be enhanced.

Hereinafter, a description will be given of information related to whether to partition a voxel, a sub-voxel partitioning method, a sub-voxel occupancy bit generation method, and information related to whether to apply attribute encoding, which are needed to perform region-wise adaptive merging of duplicated points according to embodiments.

In the present disclosure, the information related to whether to partition a voxel will be referred to as voxel partitioning information or a sub voxel partition flag field (or information).

That is, when the number of points belonging to a voxel exceeds a threshold (i.e., the maximum number of points that may be included in one voxel (max_duplicated_point)), the voxel may be divided into one or more sub-voxels by virtually extending the tree. According to embodiments, the threshold, which corresponds to the maximum number of points that may be included in a voxel, may be received as input through signaling information. According to an embodiment, whether a voxel is to be partitioned or has been partitioned into one or more sub-voxels may be signaled in signaling information, using sub voxel partition flag information. According to embodiments, the sub voxel partition flag information and the maximum number of points that may be included in a voxel (max_duplicated_point) may be signaled in at least one of a geometry parameter set (GPS), a tile parameter set (TPS), a geometry slice header (GSH), or geometry slice data (GSD).

According to embodiments, the information on the maximum number of points that may be included in a voxel and/or the information on whether to partition the voxel may be assigned fixed values known to the transmitting side/receiving side. In this case, separate signaling may not be required.

According to embodiments, when the number of points belonging to a partitioned sub-voxel exceeds a threshold (i.e., the maximum number of points that may be included in the sub-voxel), the sub-voxel may be partitioned again into one or more sub-voxels. According to embodiments, the maximum number of points that may be included in a voxel may or may not be equal to the maximum number of points that may be included in a sub-voxel.

According to embodiments, when a voxel is partitioned into one or more sub-voxels by virtually extending the tree, the virtual tree may be a binary tree, a quad tree, an octree, or the like. An occupancy bit may be generated by partitioning the voxel into one or more sub-voxels based on the virtually extended tree. According to embodiments, a tree to be used for voxel partitioning may be received as input by signaling information or may be automatically configured according to a classification state of points. According to embodiments, a sub-voxel partitioning method (sub voxel partition method) may be signaled in the signaling information. That is, the sub-voxel partitioning method (sub-voxel partition method) may indicate whether binary tree partitioning, quadtree partitioning, or octree partitioning is used to partition a voxel into one or more sub-voxels. The sub-voxel partitioning method (sub voxel partition method) may be signaled in at least one of the GPS, the TPS, the GSH, or the GSD. According to embodiments, the sub-voxel partitioning method may be assigned a fixed value known to the transmitting side/receiving side. In this case, separate signaling may not be required.

According to embodiments, information about whether a point is present in a partitioned sub-voxel may be provided according to the sub-voxel partitioning method. That is, a voxel may be partitioned by applying one of a binary tree, a quadtree, and an octree, and it is checked whether there is a point present in the partitioned region. When there is at least one point present, a sub-voxel occupancy bit may be generated as 1. Where there is no point present, a sub-voxel occupancy bit may be generated as 0. According to embodiments, a bitstream according to the presence or absence of a point may be presented from left to right, from top to bottom, or from front to back, and any presentation order may be determined. In another embodiment, the bitstream according to the presence or absence of a point may be determined according to the order of generation of Morton codes, or the order of generation of octree occupancy bits.

According to embodiments, an occupancy bit generated for a sub-voxel partitioned based on one of the binary tree, the quadtree, and the octree may be signaled in the GSD.

According to embodiments, only the geometry may be encoded in more detail (on the transmitting side) and decoded (on the receiving side). Alternatively, the attribute including the sub-voxel may be encoded in attribute encoding (on the transmitted side) and decoded (on the receiving side). According to embodiments, whether to use the geometry reconstructed based on the points in the sub-voxel in attribute encoding may be received as input by signaling information and applied, or may be preset to a fixed value known to the transmitting side/receiving side.

In the present disclosure, information related to whether points in a sub-voxel are to be applied to attribute encoding will be referred to as attribute coding application information or an include sub voxel for attribute coding flag field (or information). According to embodiments, the include sub voxel for attribute coding flag information may be signaled in at least one of the GPS, the TPS, the GSH, or the GSD.

A method of setting a geometry value, a recoloring method, and a Morton code sorting method using in applying points of a sub-voxel to attribute encoding according to embodiments will be described.

According to embodiments, based on a point geometry being reconstructed for attribute encoding, when a voxel is divided into one or more sub-voxels, a center position of each sub-voxel may be set as a geometry value of the sub-voxel. This operation may be referred to as a point geometry reconstruction step for attribute encoding.

According to embodiments, neighbor points may be searched for based on the reconstructed position value of a point and the original position value of the point, and the average of the color values of the neighbor points may be assigned as the color of the reconstructed point position. This operation may be referred to as a recoloring step.

According to embodiments, the Morton code may play an important role in the attribute encoding.

In an embodiment, the LOD configurator 53007 may generate LODs after sorting all points of the reconstructed geometry based on the Morton code. In this case, the generated LODs are configured as sorted based on the Morton code. In this case, the neighbor set configurator 53008 may search for neighbor points in the ranges before and after the current point and a point that is near the current point in terms of Morton code based on the sorting order.

According to embodiments, when a voxel is divided into one or more sub-voxels (or referred to as first sub-voxels), the Morton code of each of the sub-voxels (i.e., the first sub-voxels) may be the same as the Morton code of the voxel. Also, even when one sub-voxel (i.e., the first sub-voxel) is again partitioned into one or more sub-voxels (or referred to as second sub-voxels), the Morton code of each of the sub-voxels (i.e., the second sub-voxels) may be the same as the Morton code of the first sub-voxel.

Accordingly, when sub-voxels are present, there are points having the same Morton code value in attribute encoding.

In this case, the Morton code sorting order of the points may affect attribute compression. This is because when positions sorted in Morton code order may affect LOD configuration and generation of a neighbor set.

According to embodiments, when a voxel is partitioned into one or more sub-voxels, sorting according to the Morton code generation scheme, sorting according to the octree occupancy bit generation order, or an arbitrary sorting method (e.g., top-to-bottom, left-to-right, or front-to-back order) may be selectively applied to the order of the sub-voxels. The sorting method according to the embodiments may also be applied when a sub-voxel is partitioned into one or more sub-voxels. In addition, a bitstream having information related to whether points are present in the sub-voxel in order of sorting according to the selected sorting method is transmitted.

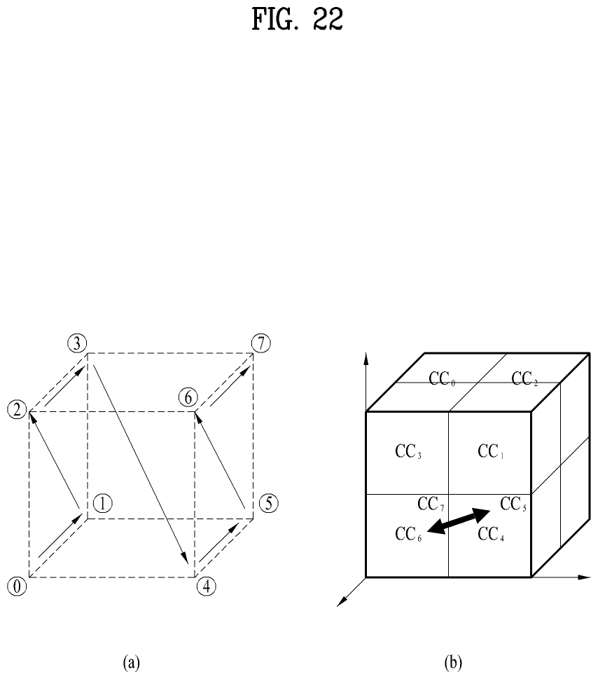

FIG. 22a shows an example of sorting sub-voxels according to a scheme of Morton code generation according to embodiments. As shown in FIG. 22a, the sub-voxels may be sorted in order of zyx, or ascending order of values according to a scheme such as Morton code generation.

FIG. 22b shows an example of sorting sub-voxels according to a scheme such as the octree occupancy bit generation according to embodiments. According to embodiments, when a voxel is partitioned into one or more sub-voxels based on an octree, the sub-voxels may be sorted in order according to a scheme such as the octree occupancy bit generation.

FIGS. 22a and 22b are merely exemplary embodiments provided for understanding of the present disclosure. The sub-voxels may be sorted in top-to-bottom, left-to-right, or front-to-back order. According to embodiments, unless the voxel is partitioned into one or more sub-voxels based on the octree, the partitioned sub-voxels may be sorted from top to bottom, from left to right, from front to back.

Other sorting methods may also be applied.

According to embodiments, a sub-voxel ordering method (sub_voxel_order_method) may be signaled in signaling information. That is, the sub-voxel ordering method (sub_voxel_order_method) is related to a method of determining an order in which sub-voxels are added to a point list when a voxel is partitioned into one or more sub-voxels, and may indicate sorting according to the Morton code generation scheme, sorting according to an order of octree occupancy bit generation, or top-to-bottom, left-to-right or front-to-back sorting. The sub-voxel ordering method (sub_voxel_order_method) may be signaled in at least one of the GPS, the TPS, or the GSH. According to embodiments, the sub-voxel ordering method (sub_voxel_order_method) may be assigned a fixed value known to the transmitting side/receiving side. In this case, separate signaling may not be required.

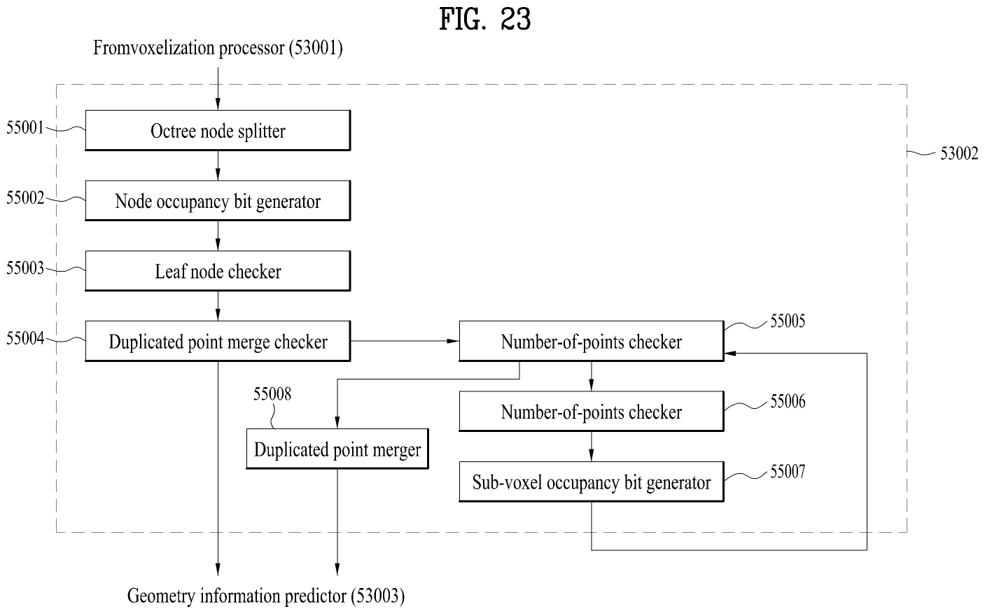

FIG. 23 is a block diagram illustrating an exemplary device for adaptive duplicated point processing described above. In an embodiment of the present disclosure, the adaptive duplicated point processing may be performed by the octree generator 53002.

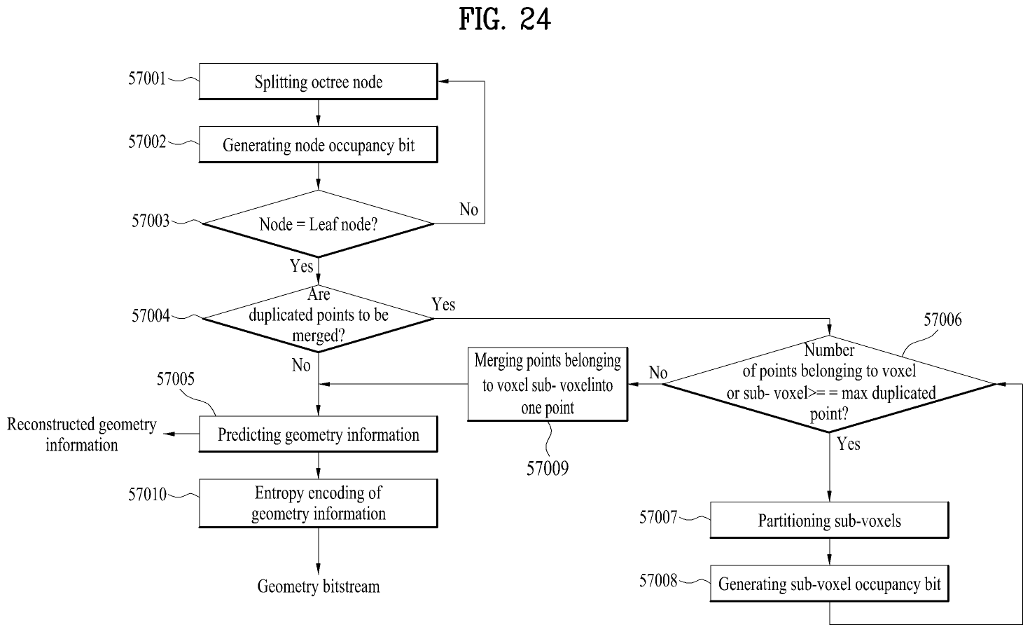

FIG. 24 is a flowchart illustrating an example of a method for adaptive duplicated point processing according to embodiments.

Changes and combinations of the embodiments are possible in the present disclosure. Terms used in the present disclosure may be understood based on the intended meaning of the terms within the scope of common uses thereof in the relevant field.

While it is illustrated in an embodiment of the present disclosure that adaptive duplicated point processing is performed by the octree generator 53002 included in the geometry encoder 51006 of FIG. 15, the adaptive duplicated point processing may be performed by the point cloud video encoder 10002 of FIG. 1, the encoding 20001, the quantization unit 40001 of FIG. 4, the voxelization processor 12002 of FIG. 12, or the octree occupancy code generator 12003.

The octree generator 53002 of FIG. 23 may include an octree node splitter 55001, a node occupancy bit generator 55002, a leaf node checker 55003, a duplicated point merge checker 55004, a number-of-points checker 55005, a sub-voxel partitioner 55006, a sub-voxel occupancy bit generator 55007, and a duplicated point merger 55508.

The adaptive duplicated point processing will be described in more detail with reference to the device of FIG. 23 and the flowchart of FIG. 24.

According to embodiments, the octree generator 53002 may be provided with sub_voxel_partition_flag information, sub_voxel_partition_method, max_duplicated_point information, include sub_voxel_for_attribute_coding_flag information, sub_voxel_order_method, and the like. According to an embodiment, such information may be provided by the signaling processor 51005. According to an embodiment, such information may be carried in the signaling information and transmitted to the receiving side. The signaling information may be at least one of a sequence parameter set, a geometry parameter set, an attribute parameter set, a tile parameter set, or a geometry slice header. In another embodiment, the sub_voxel_partition_flag information, the sub_voxel_partition_method, the max_duplicated_point information, the include sub_voxel_for_attribute_coding_flag information, and the sub_voxel_order_method may be automatically configured in the octree generator 53002 according to the characteristics of the content, the classification state of the points, and the like, or may be set to fixed values.

For simplicity, in the present disclosure, the sub_voxel_partition_flag information, the sub-voxel_partition_method, the max_duplicated_point information, the include sub_voxel_for_attribute_coding_flag information, and the sub_voxel_order_method will be referred to as duplicated point processing related option information.

The voxelization processor 53001 of FIG. 17 performs voxelization based on the position values of the quantized points and outputs a result to the octree node splitter 55001 of the octree generator 53002. That is, the voxelization processor 53001 may generate integers by rounding the position values of the points. Also, it may calculate the cubic bounding box of the entire point cloud. The bounding box may be the smallest cube enclosing the entire point cloud.

The octree node splitter 55001 may divide the cubic bounding box of the entire point cloud into eight equal parts by recursively subdividing the cubic bounding box (step 57001). That is, when the bounding box may be halved on the x-axis, on the y-axis, and on the z-axis, it may be divided into eight cubic regions of the same size, each of which may be a region of a node of one octree. In this case, the whole bounding box may be a root node of the octree, and each region obtained by dividing the whole bounding box into 8 equal parts may be 8 child nodes of the root node. This division may be repeated until a voxel becomes a node (leaf node).

In this case, the octree node splitter 55001 may classify the points into nodes based on the generated nodes. In addition, it may analyze the number of points included in the region of a node.

The node occupancy bit generator 55002 may generate an occupancy bit based on the eight divided child nodes of each node and the number of points belonging to each child node (step 57002). In an embodiment, when a node has a point, the occupancy bit value of the node may be 1. When there is no point belonging to the node, the occupancy bit value of the node may be 0. An 8-bit occupancy code may be generated by collecting bit information about the presence or absence of a point in the 8 child nodes, and may be set as the occupancy code of the parent node. The 8-bit occupancy code may be generated in order of the x, y, and z axes, ascending order of values, or specific order.

That is, the occupancy code of the octree is generated to indicate whether each of the eight divided spaces generated by dividing one space includes at least one point. Accordingly, an occupancy code is represented by occupancy bits of eight child nodes. Each child node represents occupancy of the divided space and has a value of 1 bit. Therefore, the occupancy code is represented in 8 bits. That is, when at least one point is included in a space corresponding to a specific child node, the occupancy bit of the child node has a value of 1. When the space corresponding to the specific child node does not include a point (or is empty), the occupancy bit of the child node has a value of 0. Since the occupancy code of the root node shown in FIG. 6 is 00100001, it indicates that spaces corresponding to the third child node and the eighth child node among the eight child nodes of the root node each include at least one point.

According to embodiments, the octree node splitter 55001 and the node occupancy bit generator 55002 may be repeatedly executed until one voxel becomes one node (leaf node).

To this end, the leaf node checker 55003 checks whether a node divided by the octree node splitter 55001 is a leaf node (step 57003). According to embodiments, when one voxel becomes one node, the node divided by the octree node splitter 55001 may be determined to be a leaf node.

In an embodiment, when it is determined by the leaf node checker 55003 that the current node is not a leaf node, the octree node division by the octree node splitter 55001 and the occupancy bit generation by the node occupancy bit generator 55002 are performed again.

As shown in FIG. 6, when it is determined that the 8 child nodes split from the root node are not leaf nodes, the octree node splitter 55001 splits each of the third child node and the eighth child node of the root node into 8 child nodes. In addition, the node occupancy bit generator 55002 generates occupancy bits of the 8 child nodes split from the third child node of the root node and occupancy bits of the 8 child nodes split from the eighth child node. An occupancy code is represented by the occupancy bits of 8 child nodes. Accordingly, the occupancy code of the third child node of the root node of FIG. 6 may be 10000111, and the occupancy code of the eighth child node may be 01001111.

According to embodiments, when the current node is determined as a leaf node by the leaf node checker 55003, the duplicated point merge checker 55004 determines whether a plurality of points is included in a voxel and a plurality of points in one voxel and whether to merge duplicated (overlapping) points when a plurality of points is included in the voxel (step 57004).

According to embodiments, whether to merge duplicated points may be automatically or manually configured according to a user, a system or a content characteristic.

In the present disclosure, code point position information for one or more additional points may be directly coded with or without merging the duplicated points.

In an embodiment, when duplicated points are not merged, the occupancy bits generated in the leaf node may be output to the geometry information predictor 53003. In another embodiment, even when only one point is present in a voxel or no point is present in the voxel, the occupancy bits generated in the leaf node may be output to the geometry information predictor 53003.

In the present disclosure, merging of duplicated points belonging to one voxel will be described as an embodiment.

Therefore, when the duplicated point merge checker 55004 determines that a plurality of points (referred to as duplicated or overlapping points) is included in a voxel and that the plurality of points is merged, the number-of-points checker 55005 may determine whether to divide the voxel into one or more sub-voxels. According to the result of the determination, the plurality of points included in the voxel may be merged into one point or the voxel may be partitioned into one or more sub-voxels through the sub-voxel partitioner 55006.

According to embodiments, the duplicated point merge checker 55004 or the number-of-points checker 55005 may determine whether to partition one voxel into one or more sub-voxels based on signaling information or pre-configured information. To this end, at least one of the duplicated point merge checker 55004, the number-of-points checker 55005, the sub-voxel partitioner 55006, or the sub-voxel occupancy bit generator 55007 may receive, from the signaling processor 51005, sub_voxel_partition_flag information, sub_voxel_partition_method, max_duplicated_point information, include_sub_voxel_for_attribute_coding_method information, sub_voxel_order_method, and the like.

According to embodiments, when it is determined by the number-of-points checker 55005 that one voxel is not partitioned into one or more sub-voxels based on the signaling information, the duplicated point merger 55008 may merge the plurality of voxels included in the voxel and outputs the merged point to the geometry information predictor 53003 (step 57009).

According to embodiments, when it is determined that one voxel is partitioned into one or more sub-voxels based on the signaling information, the number-of-points checker 55005 checks whether the number of points included in the voxel is greater than or equal to max_duplicated_point (step 57006). The max_duplicated_point may be referred to as the maximum number of duplicated points that may be merged in one voxel or a threshold of the maximum duplicated points.

When the number-of-points checker 55005 determines that the number of points included in the voxel is greater than or equal to max_duplicated_point, the sub-voxel partitioner 55006 may partition the voxel into one or more sub-voxels based on the sub-voxel partitioning method (sub_voxel_partition_method), and check the number of points belonging to each of the partitioned sub-voxels (step 57007). The sub-voxel portioning method (sub_voxel_partition_method) may be signaled in at least one of the GPS, the TPS, or the GSH and transmitted to the receiving side.

Then, the sub-voxel occupancy bit generator 55007 sorts the partitioned sub-voxels based on the sub-voxel ordering method (sub-voxel_order_method), and generates an occupancy bit for each of the sub-voxels (step 57008). That is, when one or more points are included in a sub-voxel, the occupancy bit for the sub-voxel may be set to 1. When no point is included, the occupancy bit for the sub-voxel may be set to 0. The sub-voxel ordering method (sub_voxel_order_method) may be signaled in at least one of the GPS, the TPS, or the GSH and transmitted to the receiving side.

The method by which the sub-voxel occupancy bit generator 55007 configures an occupancy code by generating occupancy bits may be the same as the method by which the node occupancy bit generator 55002 configures an occupancy code by generating occupancy bits. That is, when one or more points are present in a voxel or sub-voxel, the value of the occupancy bit may be 1. When no point is present, the value of the occupancy bit may be 0. The bits may be sorted in order of the x, y, and z axes, ascending order of values, or specific order. The sub-voxel occupancy bits (i.e., the sub-voxel occupancy code) generated by the sub-voxel occupancy bit generator 55007 may be carried in the geometry slice data and transmitted to the receiving side.

According to embodiments, the number-of-points checker 55005, the sub-voxel partitioner 55006, and the sub-voxel occupancy bit generator 55007 may be repeatedly executed until the number of points included in a sub-voxel decreases below a threshold (i.e., the maximum number of points that may be included in a sub-voxel). That is, sub-voxel partitioning and sub-voxel occupancy bit generation may be repeatedly performed until the number of points included in the sub-voxel is less than the maximum duplicated point threshold. For example, when the number of points included in at least one sub-voxel among the sub-voxels partitioned from one voxel is greater than the maximum number of points that may be included in the sub-voxel, the sub-voxel may be partitioned into one or more sub-voxels, and the operation of occupancy bit generation for the partitioned sub-voxels may be performed. The maximum number of points that may be included in a voxel may or may not be equal to the maximum number of points that may be included in a sub-voxel.

According to embodiments, the number-of-points checker 55005 determines that the number of points included in the voxel is less than the maximum number of points that may be included in one voxel or the number of points included in the sub-voxel is less than the maximum number of points that may be included in one voxel, the duplicated point merger 55008 merges the points included in the voxel or the sub-voxel into one point and outputs the merged point to the geometry information predictor 53003. Such a sub-voxel partitioning method may be repeated until the number of points included in a sub-voxel is less than the maximum number of points that may be included in one sub-voxel.

As described above, when the node partitioned by the octree generator 53002 is a leaf node, duplicated point merging is performed, and voxel partitioning is not performed, the geometry encoder 51006 may set the value (e.g., the node center position value) of one of the points included in a voxel as a point value of the voxel (or node) and ignore the other point values. Thereafter, the attribute transformation processor (or referred to as a recoloring unit) 53006 of the attribute encoder 51007 may calculate a color based on the node center position value and set the same as a representative color value of the point.

According to embodiments, in the case where the node partitioned by the octree generator 53002 is a leaf node, duplicated point merging is performed, and voxel partitioning is performed, when the number of points belonging to the voxel is greater than or equal to the maximum duplicated point threshold, the sub-voxel partitioner 55006 may partition the voxel into one or more sub-voxels based on a sub-voxel partitioning method. The sub-voxel partitioning method specifies a virtual tree that is extended when one voxel is partitioned into one or more sub-voxels. The virtual tree may be one of a binary tree, a quadtree, or an octree.

Further, sub-voxel partition flag information indicating whether the voxel is partitioned into sub-voxels and the sub-voxel partitioning method may be signaled in at least one of the GPS, the TPS, or the GSH and transmitted to the receiving side. In addition, the sub-voxel occupancy bit generator 55007 sorts the partitioned sub-voxels based on the sub-voxel ordering method and generates occupancy bits of the sorted sub-voxels to configure an occupancy code.

Here, the sub-voxel ordering method may specify sorting according to the Morton code generation scheme, sorting according to an order of octree occupancy bit generation, top-to-bottom, left-to-right or front-to-back sorting, or the like. The sub-voxel ordering method may be signaled in at least one of the GPS, the TPS, or the GSH and transmitted to the receiving side.

According to embodiments, when the node partitioned by the octree generator 53002 is a leaf node, and duplicated point merging and voxel partitioning are performed, additional geometry information may be generated and provided to the attribute encoder 51007 according to whether to use sub-voxel information for encoding attribute information (i.e., include_sub_voxel_for_attribute_coding_flag information). The include_sub_voxel_for_attribute_coding_flag information may be signaled in at least one of the GPS, the TPS, or the GSH and transmitted to the receiving side.

In generating the additional geometry information according to the embodiments, a position to which the additional geometry information is to be added may be determined according to a sub-voxel sorting method that is predefined (or included in the signaling information). Since the sorting is performed by the attribute encoder 51007 based on the Morton code, not all sub-voxels included in one voxel need to be present at a specific position. However, only the relative positions may need to be adjusted according to the sub-voxel sorting method defined in the order. The sub-voxel sorting method may include sorting according to the Morton code generation scheme, sorting according to an order of octree occupancy bit generation, or top-to-bottom, left-to-right or front-to-back sorting. This sub-voxel sorting method may be signaled in at least one of the GPS, the TPS, or the GSH and transmitted to the receiving side. Accordingly, the geometry decoder on the receiving side may reconstruct an additional point and then apply the same to a sorted position.

For the operation of the geometry information predictor 53003 according to the output of the duplicated point merger 55004 or the output of the duplicated point merger 55008, reference will be made to the description of FIG. 17 and a description of the operation will be omitted. Also, for the geometry information prediction 57005 and the geometry information entropy encoding 57010 of FIG. 24, reference will be made to the description of the operations of the geometry information predictor 53003 and the arithmetic coder 53004 of FIG. 17, and a description of the steps will be omitted.

Next, a description will be given of the attribute encoding performed by the attribute encoder 51007 when duplicated points are processed by the geometry encoder 51006 as described above. An operation of the attribute encoder 51007 that is not described below may be the same as or similar to that of FIG. 4, 12, or 17.

According to embodiments, the attribute encoder 51007 is not directly changed, except that the Morton code value of a specific voxel is equal to the Morton code value of sub-voxels partitioned from the voxel. However, changes in the geometry encoder 51006 may affect the attribute encoder 51007. Next, blocks (or modules) of the attribute encoder 51007 affected by the changes will be described.

Specifically, the attribute transformation processor (or referred to as a recoloring unit) 53006 of the attribute encoder 51007 may search for points at positions near the center position of a sub-voxel and allocate a color thereto, considering information related to the sub-voxel as well.

In addition, the LOD configurator 53007 of the attribute encoder 51007 may sort the points based on the Morton code and configure LODs based on the sorted points. In this case, the Morton code may be obtained based on an integer value obtained by rounding the position information about the sub-voxel. That is, sub-voxels partitioned from one voxel may have the same Morton code value as the voxel.

Also, Morton code-based sorting may affect the search for neighbor points by the neighbor set configurator 53008 of the attribute encoder 51007. That is, a specific voxel and a sub-voxel partitioned from the voxel may have the same Morton code value, as in the case of the LOD configurator 53007. Therefore, in calculating the distance between points, the distance value may be calculated based on the non-rounded position value of the sub-voxel.

The point cloud video decoder of the reception device may decode geometry information and attribute information by performing point reconstruction according to the sub-voxel occupancy bits based on sub_voxel_partition_flag information, sub_voxel_partition_method, max_duplicated_point information, include sub_voxel_for_attribute_coding_flag information, sub_voxel_order_method, and the like as used by the above-described point cloud video encoder of the transmission device.

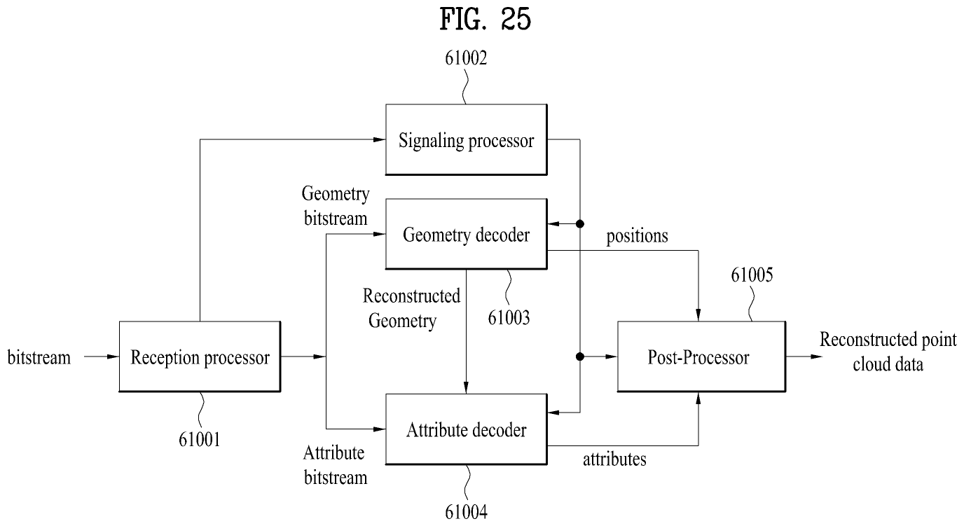

FIG. 25 is a diagram showing another exemplary point cloud reception device according to embodiments.

The point cloud reception device according to the embodiments may include a reception processor 61001, a signaling processor 61002, a geometry decoder 61003, an attribute decoder 61004, and a post-processor 61005. According to embodiments, the geometry decoder 61003 and the attribute decoder 61004 may be referred to as a point cloud video decoder. According to embodiments, the point cloud video decoder may be referred to as a PCC decoder, a PCC decoding unit, a point cloud decoder, a point cloud decoding unit, or the like.

The reception processor 61001 according to the embodiments may receive a single bitstream, or may receive a geometry bitstream, an attribute bitstream, and a signaling bitstream, respectively. When a file and/or segment is received, the reception processor 61001 according to the embodiments may decapsulate the received file and/or segment and output the decapsulated file and/or segment as a bitstream.

When the single bitstream is received (or decapsulated), the reception processor 61001 according to the embodiments may demultiplex the geometry bitstream, the attribute bitstream, and/or the signaling bitstream from the single bitstream. The reception processor 61001 may output the demultiplexed signaling bitstream to the signaling processor 61002, the geometry bitstream to the geometry decoder 61003, and the attribute bitstream to the attribute decoder 61004.

When the geometry bitstream, the attribute bitstream, and/or the signaling bitstream are received (or decapsulated), respectively, the reception processor 61001 according to the embodiments may deliver the signaling bitstream to the signaling processor 61002, the geometry bitstream to the geometry decoder 61003, and the attribute bitstream to the attribute decoder 61004.

The signaling processor 61002 may parse signaling information, for example, information contained in the SPS, GPS, APS, TPS, metadata, or the like from the input signaling bitstream, process the parsed information, and provide the processed information to the geometry decoder 61003, the attribute decoder 61004, and the post-processor 61005. In another embodiment, signaling information contained in the geometry slice header and/or the attribute slice header may also be parsed by the signaling processor 61002 before decoding of the corresponding slice data. That is, when the point cloud data is partitioned into tiles and/or slices at the transmitting side as shown in FIG. 16, the TPS includes the number of slices included in each tile, and accordingly the point cloud video decoder according to the embodiments may check the number of slices and quickly parse the information for parallel decoding.

Accordingly, the point cloud video decoder according to the present disclosure may quickly parse a bitstream containing point cloud data as it receives an SPS having a reduced amount of data. The reception device may decode tiles upon receiving the tiles, and may decode each slice based on the GPS and APS included in each tile. Thereby, decoding efficiency may be maximized.

That is, the geometry decoder 61003 may reconstruct the geometry by performing the reverse process of the operation of the geometry encoder 51006 of FIG. 15 on the compressed geometry bitstream based on signaling information (e.g., geometry related parameters). The geometry restored (or reconstructed) by the geometry decoder 61003 is provided to the attribute decoder 61004. The attribute decoder 61004 may restore the attribute by performing the reverse process of the operation of the attribute encoder 51007 of FIG. 15 on the compressed attribute bitstream based on signaling information (e.g., attribute related parameters) and the reconstructed geometry. According to embodiments, when the point cloud data is partitioned into tiles and/or slices at the transmitting side as shown in FIG. 16, the geometry decoder 61003 and the attribute decoder 61004 perform geometry decoding and attribute decoding on a tile-by-tile basis and/or slice-by-slice basis.

According to embodiments, when sub_voxel_partition_flag information, sub_voxel_partition_method, max_duplicated_point information, include sub_voxel_for_attribute_coding_flag information, sub_voxel_order_method, and the like are signaled in at least one of the SPS, the GPS, the TPS, or the GSH, the signaling processor 61002 may acquire the same and provide the same to the geometry decoder 61003, or the geometry decoder 61003 may directly acquire the same.

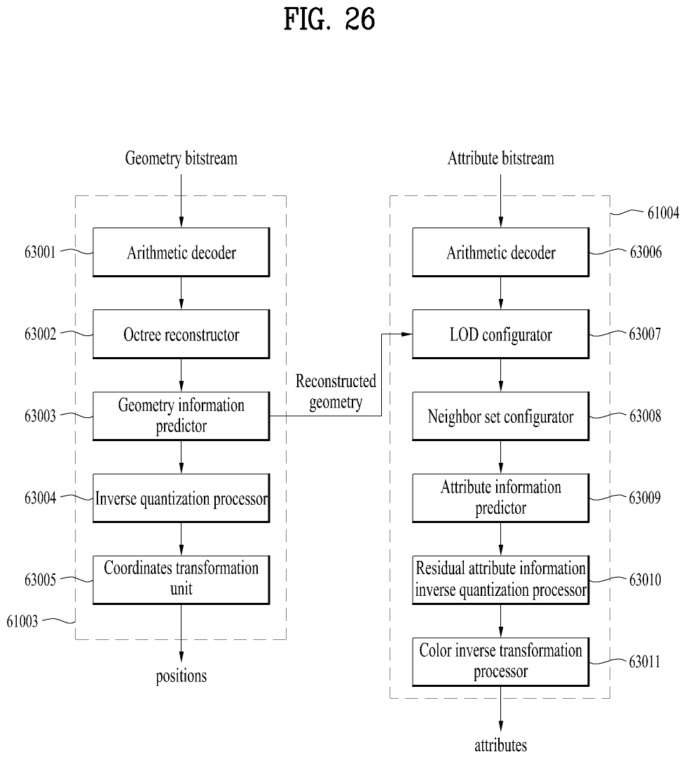

FIG. 26 is a detailed block diagram illustrating an example of the geometry decoder 61003 and the attribute decoder 61004 for adaptive duplicated point processing according to embodiments.

In an embodiment of the present disclosure, adaptive duplicated point processing may be performed by an octree reconstructor 63002.

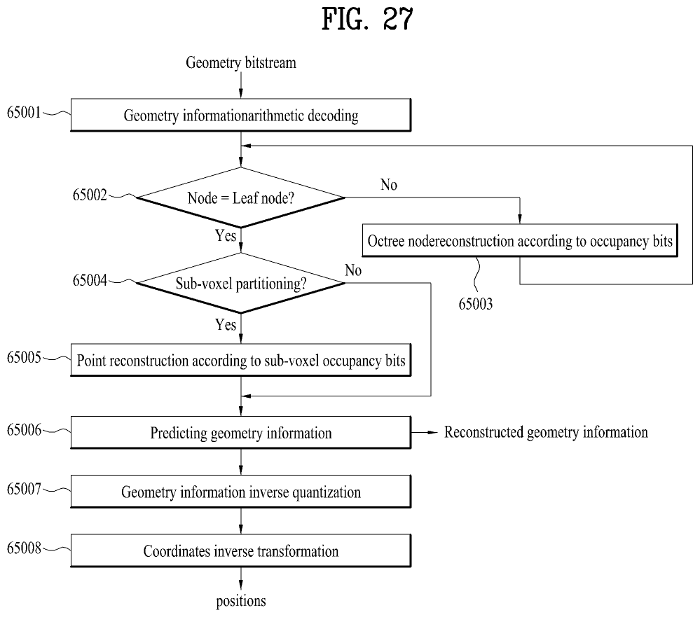

FIG. 27 is a flowchart illustrating an example of a method for adaptive duplicated point processing by the geometry decoder 61003 according to embodiments.

Changes and combinations of the embodiments are possible in the present disclosure. Terms used in the present disclosure may be understood based on the intended meaning of the terms within the scope of common uses thereof in the relevant field.

While it is illustrated in an embodiment of the present disclosure that adaptive duplicated point processing is performed by the octree reconstructor 63002 included in the geometry decoder 61003 of FIG. 26, the adaptive duplicated point processing may be performed by the point cloud video decoder 10006 of FIG. 1, the decoding 20003 of FIG. 2, the octree synthesis unit 11001 of FIG. 11, and the occupancy code-based octree reconstruction processor 13003 of FIG. 13.

The geometry decoder 61003 of FIG. 26 may include an arithmetic decoder 63001, an octree reconstructor 63002, a geometry information predictor 63003, an inverse quantization processor 63004, and a coordinates inverse transformation unit 63005. This is merely embodiment. Some blocks may not be included in the geometry decoder 61003, or other blocks may be further included in the geometry decoder 61003.

The arithmetic decoder 63001 decodes a received geometry bitstream based on arithmetic coding and outputs the decoded bitstream to the octree reconstructor 63002. The operation of the arithmetic decoder 63001 corresponds to the reverse of the operation of the arithmetic coder 53004.

The octree reconstructor 63002 may process adaptive duplicated points by acquiring a voxel occupancy code or a sub-voxel occupancy code from the arithmetic decoded geometry bitstream (or signaling information about a geometry secured as a result of the decoding) and reconstruct octree nodes. The octree reconstructor 63002 may generate points (or leaf nodes, which may be specified as voxels) based on the reconstructed octree nodes. Details of the occupancy code of a voxel or sub-voxel is the same as those described with reference to FIGS. 15 to 24.

Hereinafter, the adaptive duplicated point processing performed by the receiver will be described in more detail with reference to the devices of FIG. 26 and the flowchart of FIG. 27.

According to embodiments, the octree reconstructor 63002 may be provided with sub_voxel_partition_flag information, sub_voxel_partition_method, max_duplicated_point information, include_sub_voxel_for_attribute_coding_flag information, sub_voxel_order_method, and the like for duplicated point processing. According to an embodiment, such information may be provided by the signaling processor 61002. According to an embodiment, such information may be carried in the signaling information and transmitted from the transmitting side to the receiving side, on which the information may be restored. The signaling information may be at least one of a sequence parameter set, a geometry parameter set, a tile parameter set, or a geometry slice header. In another embodiment, the sub_voxel_partition_flag information, the sub_voxel_partition_method, the max_duplicated_point information, the include_sub_voxel_for_attribute_coding_flag information, and the sub_voxel_order_method may be automatically configured in the octree reconstructor 63002 according to the characteristics of the content, the classification state of the points, and the like, or may be set to fixed values.

For simplicity, in the present disclosure, the sub_voxel_partition_flag information, the sub-voxel_partition_method, the max_duplicated_point information, the include_sub_voxel_for_attribute_coding_flag information, and the sub_voxel_order_method will be referred to as duplicated point processing related option information.

According to embodiments, after the arithmetic coded geometry bitstream is processed through arithmetic decoding in step 65001, it is checked whether the current node is a leaf node (step 65002).

When it is determined in step 65002 that the node is not a leaf node, the occupancy bits are restored to reconstruct the octree nodes according to the occupancy bits, and points are generated based on the reconstructed octree nodes. Then, the process returns to step 65002 to check whether the reconstructed octree node is a leaf node (step 65003).

When it is determined in step 65002 that the node is a leaf node, it is checked whether sub-voxel partitioning has been performed in the leaf node based on the sub_voxel_partition_flag information (step 65004).

For example, when the value of the sub_voxel_partition_flag information is 1, the transmitting side may determine that the voxel has been partitioned into one or more sub-voxels. When the value is 0, the transmitting side may determine that the voxel has not been partitioned into sub-voxels.

Therefore, when it is determined in step 65004 that sub-voxel partitioning has been performed, the process proceeds to step 65005 for point reconstruction according to the sub-voxel occupancy bits. When it is determined that sub-voxel partitioning has not been performed, the process proceeds to step 65006 for geometry information prediction.

In step 65005 according to the embodiments, the sub-voxel occupancy bits may be interpreted based on the sub-voxel partitioning method (sub_voxel_partition_method) information for sub-voxel reconstruction. In step 65005, the sub-voxel occupancy bits may be restored, and sub-voxels may be reconstructed based on the restored sub-voxel occupancy bits. Then, points may be generated based on the reconstructed sub-voxels.

According to embodiments, in reconstructing the sub-voxels in step 65005, a position to which additional geometry information is to be added may be determined according to the sub-voxel ordering method (sub-voxel_order_method). That is, since the points are sorted by the attribute encoder on the transmitting side based on the Morton code, not all sub-voxels included in one voxel need to be present at a specific position. Accordingly, according to an embodiment, only the relative position may be adjusted according to the sub-voxel ordering method (sub-voxel_order_method) defined in order. The sub-voxel sorting method may include sorting according to the Morton code generation scheme, sorting according to an order of octree occupancy bit generation, or top-to-bottom, left-to-right or front-to-back sorting.

The geometry information predictor 63003 reconstructs the geometry information by performing geometry information prediction based on the points reconstructed in step 65005 or the points generated in step 65003 (step 65006). The reconstructed geometry information is output to the inverse quantizer 63004 and the attribute decoder 61004.

According to embodiments, the points generated in step 65005 are points included in sub-voxels reconstructed based on the occupancy bits of the sub-voxels.

Therefore, when sub-voxel partitioning is performed at the transmitting side, the geometry information reconstructed by the geometry information predictor 63003 includes voxel geometry information reconstructed based on the voxel occupancy bits and sub-voxel geometry information reconstructed based on the sub-voxel occupancy bits.

According to embodiments, the reconstructed geometry information provided to the attribute decoder 61004 may or may not include the reconstructed sub-voxel geometry information depending on the include_sub_voxel_for_attribute_coding_flag information.

According to embodiments, the reconstructed geometry information provided to the attribute decoder 61004 includes the reconstructed sub-voxel geometry information when the value of the include_sub_voxel_for_attribute_coding_flag information is 1, and does not include the reconstructed sub-voxel geometry information when the value is 0.

The inverse quantization unit 63004 according to the embodiments inversely quantizes the reconstructed geometry information output from the geometry information predictor 63003 in the reverse of the quantization process at the transmitting side, and outputs the inversely quantized information to the coordinates inverse transformation unit 63005 (step 65007).

The coordinates inverse transformation unit 63005 may acquire positions of points by transforming the coordinates based on the inversely quantized geometry information (step 65008). The positions reconstructed by the coordinates inverse transformation unit 63005, that is, the reconstructed geometry information, are output to the post-processor 61005.

The reconstructed geometry information output from the coordinates inverse transformation unit 63005 may include positions of points reconstructed based on the sub-voxel occupancy bits regardless of the value of the include_sub_voxel_for_attribute_coding_flag information.

As described above, the geometry information reconstructed by the geometry information predictor 63003 is used as information for the attribute decoder 61004 to reconstruct the attribute information.

The attribute decoder 61004 according to the embodiments may include an arithmetic decoder 63006, an LOD configurator 63007, a neighbor set configurator 63008, an attribute information predictor 63009, and a residual attribute information inverse quantization processor 63010, and a color inverse transformation processor 63011.

The arithmetic decoder 63006 may perform arithmetic decoding (e.g., entropy decoding) on an input attribute bitstream. The arithmetic decoder 63006 may decode the attribute bitstream based on the geometry information reconstructed by the geometry decoder 61003. The arithmetic decoder 63006 performs the same or similar operation and/or decoding to the operation and/or decoding of the arithmetic decoder 11005 of FIG. 11 or the arithmetic decoder 13007 of FIG. 13.

According to embodiments, the attribute bitstream that is to be entropy-decoded and output by the arithmetic decoder 63006 may be decoded by any one or a combination of two or more of RAHT decoding, LOD-based prediction transform decoding, and lifting transform decoding, based on the reconstructed geometry information.

It has been described as an embodiment of the present disclosure that the transmission device performs attribute compression by combining any one or two of the LOD-based prediction transform coding and the lifting transform coding. Thus, an embodiment in which the reception device performs attribute decoding by combining any one or two of LOD-based prediction transform decoding and lifting transform decoding will be described. The description of RAHT decoding by the reception device will be omitted.

According to an embodiment, the attribute bitstream processed through arithmetic decoding by the arithmetic decoder 63006 is provided to the LOD configurator 63007. According to embodiments, the attribute bitstream provided from the arithmetic decoder 63006 to the LOD configurator 63007 may include prediction modes and residual attribute values.

According to embodiments, the geometry information reconstructed by the geometry information predictor 63003 of the geometry decoder 61003 is provided to the LOD configurator 63007 of the attribute decoder 61004.

The LOD configurator 63007 according to the embodiments generates LODs using the same or similar method to that for the LOD configurator 53007 of the transmission device and outputs the generated LODs to the neighbor set configurator 63008. That is, all points of voxels or sub-voxels included in the reconstructed geometry information may be sorted based on the Morton code, and LODs may be configured based on the sorted points. According to embodiments, the LOD configurator 63007 divides the sorted points into LODs based on the Morton code and groups the same. In this case, a group having different LODs is referred to as a set LOD₁. Here, 1 is an integer representing LOD and starts from 0. LOD₀ is a set composed of points having the largest distance therebetween. As 1 increases, the distance between points in LOD1 decreases.

In this case, according to an embodiment, when the value of the include_sub_voxel_for_attribute_coding_flag information is 1, the reconstructed geometry information provided to the LOD constructor 63007 includes sub-voxel geometry information reconstructed based on sub-voxel occupancy bits. When the value is 0, the reconstructed sub-voxel geometry information is not included. In an embodiment, when the value of the include_sub_voxel_for_attribute_coding_flag information is 1, the reconstructed geometry information provided to the attribute decoder 61004 may include reconstructed voxel geometry information. When the value is 0, the reconstructed geometry information may include reconstructed voxel geometry information and reconstructed sub-voxel geometry information. In another embodiment, when the value of the include_sub_voxel_for_attribute_coding_flag information is 1, the reconstructed geometry information provided to the attribute decoder 61004 may include voxel geometry information reconstructed based on the voxel occupancy bits. When the value is 0, the reconstructed geometry information may include sub-voxel geometry information reconstructed based on the sub-voxel occupancy bits.

According to embodiments, decoding of the attribute information may be affected by the information about whether the reconstructed geometry information provided to the LOD constructor 63007 includes the reconstructed sub-voxel geometry information.

According to embodiments, when the LOD configurator 63007 sorts the points based on the Morton code and configures the LODs based on the sorted points, the Morton code may be obtained based on an integer value obtained by rounding sub-voxel position information. That is, sub-voxels partitioned from one voxel may have the same Morton code value as the voxel.

According to embodiments, the neighbor set configurator 63008 may search for neighbor points near the current point in terms of Morton code in a range configured before and after the current point based on the sorting order.

According to embodiments, the Morton code-based sorting may also have an effect on the search for neighbor points performed by the neighbor set configurator 63008. That is, since a specific voxel and sub-voxels partitioned from the voxel may have the same Morton code value as in the case of the LOD configurator 63007, the neighbor set configurator 63008 may calculate the values of distance between points based on the non-rounded position values of the sub-voxels.

In an embodiment, when the LOD configurator 63007 generates a set LOD₁ using the voxel geometry information reconstructed based on the voxel occupancy bits or the sub-voxel geometry information reconstructed based on the sub-voxel occupancy bits, the LOD1 set is generated. The neighbor set configurator 63008 may search for X (>0) nearest neighbors in a group having the same or lower LOD (i.e., a group in which the distance between nodes is large) based on the set LOD₁ and register the same in the predictor as a neighbor point set. Here, X is the maximum number of points that may be configured as neighbors. X may be input as a user parameter, or may be received through signaling information such as the SPS, APS, GPS, TPS, geometry slice header, or attribute slice header.

In some embodiments, when the LOD configurator 63007 generates LODs based on the sub-voxel geometry information, the neighbor set configurator 63008 may calculate the values of distance between the points based on the non-rounded position values of sub-voxels.

In another embodiment, the neighbor set configurator 63008 may select neighbor points for each point based on the signaling information such as the SPS, APS, GPS, TPS, geometry slice header, or attribute slice header. To this end, the neighbor set configurator 63008 may receive the information from the signaling processor 61002.

According to embodiments, the attribute information predictor 63009 predicts an attribute from neighbor points registered in the predictor of each point based on the prediction mode of each point, and provides the predicted attributes to the residual attribute information inverse quantization processor 63010. The prediction mode may be a value predetermined by an agreement between the transmitting side/receiving side, or may be signaled and received in signaling information such as the SPS, APS, TPS, or attribute slice header. According to an embodiment, the prediction mode predetermined by the agreement between the transmitting side/receiving side is 0. According to embodiments, the prediction mode of the point may be any one of prediction mode 0 to prediction mode 3.

According to embodiments, in prediction mode 0, the average (i.e., the average of values obtained by multiplying the attributes (e.g., color, reflectance, etc.) of the neighbor points registered in the predictor of the corresponding point by a weight (or normalized weight) may be configured as a predicted attribute value. In prediction mode 1, the attribute of the first neighbor point may be configured as a predicted attribute value. In prediction mode 2, the attribute of the second neighbor point may be configured as a predicted attribute value. In prediction mode 3, the attribute of the third neighbor point may be configured as a predicted attribute value.

Once the attribute information prediction unit 63009 obtains the predicted attribute value of each point based on the prediction mode of each point, the residual attribute information inverse quantization processor 63012 restores the attribute value of each point by adding the predicted attribute value of the point predicted by the attribute information prediction unit 63009 to the received residual attribute value of the point, and then performs inverse quantization as a reverse process to the quantization process of the transmission device.

In an embodiment, in the case where the transmitting side applies zero run-length coding to the residual attribute values of points, the residual attribute information inverse quantization processor 63012 performs zero run-length decoding on the residual attribute values of the points, and then performs inverse quantization.

The attribute values restored by the residual attribute information inverse quantization processor 63012 through processes described above are output to the inverse color transformation processor 63013.

The inverse color transformation processor 63013 performs inverse transform coding for inverse transformation of the color values (or textures) included in the restored attribute values, and then outputs the attributes to the post-processor 61005. The inverse color transformation processor 63013 performs an operation and/or inverse transform coding identical or similar to the operation and/or inverse transform coding of the inverse color transformation unit 11010 of FIG. 11 or the inverse color transformation processor 13010 of FIG. 13.

The post-processor 61005 may reconstruct point cloud data by matching the positions restored and output by the geometry decoder 61003 with the attributes restored and output by the attribute decoder 61004. In addition, when the reconstructed point cloud data is in a tile and/or slice unit, the post-processor 61005 may perform a reverse process to the spatial partitioning of the transmitting side based on the signaling information. For example, when the bounding box shown in FIG. 16a is partitioned into tiles and slices as shown in of FIGS. 16(b) and 16c, the tiles and/or slices may be combined based on the signaling information to restore the bounding box as shown in FIG. 16a.

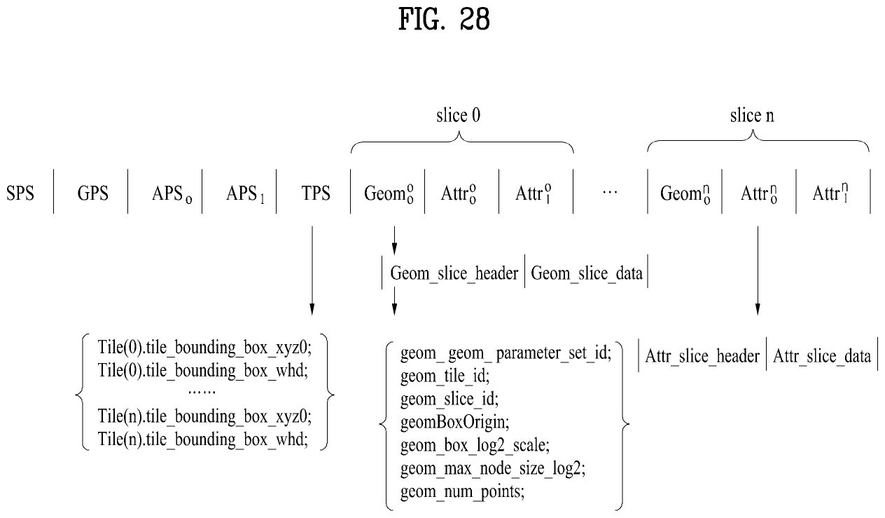

FIG. 28 shows an exemplary bitstream structure of point cloud data for transmission/reception according to embodiments.

When a geometry bitstream, an attribute bitstream, and a signaling bitstream according to embodiments are configured as one bitstream, the bitstream may include one or more sub-bitstreams. The bitstream according to the embodiments may include a sequence parameter set (SPS) for sequence level signaling, a geometry parameter set (GPS) for signaling of geometry information coding, one or more attribute parameter sets (APSs) (APS₀, APS₁) for signaling of attribute information coding, a tile parameter set (TPS) for tile level signaling, and one or more slices (slice 0 to slice n). That is, a bitstream of point cloud data according to embodiments may include one or more tiles, and each of the tiles may be a group of slices including one or more slices (slice 0 to slice n). The TPS according to the embodiments may contain information about each of the one or more tiles (e.g., coordinate value information and height/size information about the bounding box). Each slice may include one geometry bitstream (Geom0) and one or more attribute bitstreams (Attr0 and Attr1). For example, a first slice (slice 0) may include one geometry bitstream)(Geom0⁰ and one or more attribute bitstreams (Attr0⁰, Attr1⁰).

The geometry bitstream (or geometry slice) in each slice may be composed of a geometry slice header (geom_slice_header) and geometry slice data (geom_slice_data). According to embodiments, geom_slice_header may include identification information (geom_parameter_set_id), a tile identifier (geom_tile_id), and a slice identifier (geom_slice_id) for a parameter set included in the GPS, and information (geomBoxOrigin, geom_box_log 2_scale, geom_max_node_size_log 2, geom numpoints) about data contained in the geometry slice data (geom_slice_data). geomBoxOrigin is geometry box origin information indicating the origin of the box of the geometry slice data, geom_box_log 2_scale is information indicating the log scale of the geometry slice data, geom_max_node_size_log 2 is information indicating the size of the root geometry octree node, and geom_num_points is information related to the number of points of the geometry slice data. According to embodiments, the geom_slice_data may include geometry information (or geometry data) about the point cloud data in a corresponding slice.

Each attribute bitstream (or attribute slice) in each slice may be composed of an attribute slice header (attr_slice_header) and attribute slice data (attr_slice_data). According to embodiments, the attr_slice_header may include information about the corresponding attribute slice data. The attribute slice data may contain attribute information (or attribute data or attribute value) about the point cloud data in the corresponding slice. When there is a plurality of attribute bitstreams in one slice, each of the bitstreams may contain different attribute information. For example, one attribute bitstream may contain attribute information corresponding to color, and another attribute stream may contain attribute information corresponding to reflectance.

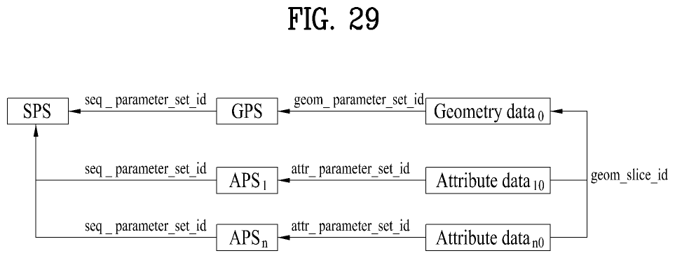

FIG. 29 shows an exemplary bitstream structure for point cloud data according to embodiments.

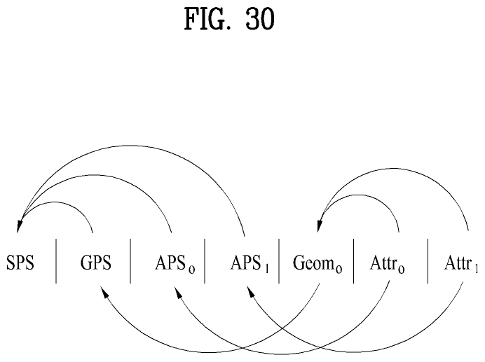

FIG. 30 illustrates a connection relationship between components in a bitstream of point cloud data according to embodiments.

The bitstream structure for the point cloud data illustrated in FIGS. 29 and 30 may represent the bitstream structure for point cloud data shown in FIG. 28.

According to the embodiments, the SPS may include an identifier (seq_parameter_set_id) for identifying the SPS, and the GPS may include an identifier (geom_parameter_set_id) for identifying the GPS and an identifier (seq_parameter_set_id) indicating an active SPS to which the GPS belongs. The APS may include an identifier (attr_parameter_set_id) for identifying the APS and an identifier (seq_parameter_set_id) indicating an active SPS to which the APS belongs.

According to embodiments, a geometry bitstream (or geometry slice) may include a geometry slice header and geometry slice data. The geometry slice header may include an identifier (geom_parameter_set_id) of an active GPS to be referred to by a corresponding geometry slice. Moreover, the geometry slice header may further include an identifier (geom_slice_id) for identifying a corresponding geometry slice and/or an identifier (geom_tile_id) for identifying a corresponding tile. The geometry slice data may include geometry information belonging to a corresponding slice.

According to embodiments, an attribute bitstream (or attribute slice) may include an attribute slice header and attribute slice data. The attribute slice header may include an identifier (attr_parameter_set_id) of an active APS to be referred to by a corresponding attribute slice and an identifier (geom_slice_id) for identifying a geometry slice related to the attribute slice. The attribute slice data may include attribute information belonging to a corresponding slice.

That is, the geometry slice refers to the GPS, and the GPS refers the SPS. In addition, the SPS lists available attributes, assigns an identifier to each of the attributes, and identifies a decoding method. The attribute slice is mapped to output attributes according to the identifier. The attribute slice has a dependency on the preceding (decoded) geometry slice and the APS. The APS refers to the SPS.

According to embodiments, parameters necessary for encoding of the point cloud data may be newly defined in a parameter set of the point cloud data and/or a corresponding slice header. For example, when encoding of the attribute information is performed, the parameters may be added to the APS. When tile-based encoding is performed, the parameters may be added to the tile and/or slice header.

As shown in FIGS. 28, 29, and 30, the bitstream of the point cloud data provides tiles or slices such that the point cloud data may be partitioned and processed by regions. According to embodiments, the respective regions of the bitstream may have different importances. Accordingly, when the point cloud data is partitioned into tiles, a different filter (encoding method) and a different filter unit may be applied to each tile. When the point cloud data is partitioned into slices, a different filter and a different filter unit may be applied to each slice.

When the point cloud data is partitioned and compressed, the transmission device and the reception device according to the embodiments may transmit and receive a bitstream in a high-level syntax structure for selective transmission of attribute information in the partitioned regions.

The transmission device according to the embodiments may transmit point cloud data according to the bitstream structure as shown in FIGS. 28, 29, and 30. Accordingly, a method to apply different encoding operations and use a good-quality encoding method for an important region may be provided. In addition, efficient encoding and transmission may be supported according to the characteristics of point cloud data, and attribute values may be provided according to user requirements.

The reception device according to the embodiments may receive the point cloud data according to the bitstream structure as shown in FIGS. 28, 29, and 30. Accordingly, different filtering (decoding) methods may be applied to the respective regions (regions partitioned into tiles or into slices), rather than a complexly decoding (filtering) method being applied to the entire point cloud data. Therefore, better image quality in a region important is provided to the user and an appropriate latency to the system may be ensured.

As described above, a tile or a slice is provided to process the point cloud data by partitioning the point cloud data by region. In partitioning the point cloud data by region, an option to generate a different set of neighbor points for each region may be set. Thereby, a selection method having low complexity and slightly lower reliability, or a selection method having high complexity and high reliability I may be provided.

According to embodiments, duplicated point processing related option information may be included in a geometry parameter set. The duplicated point processing related option information may include sub_voxel_partition_flag information, sub_voxel_partition_method, max_duplicated_point information, include_sub_voxel_for_attribute_coding_flag information, and sub_voxel_order_method.

The duplicated point processing related option information may be added to and signaled in the TPS or a geometry slice header for each slice.

According to embodiments, the present disclosure provides tiles or slices such that a point cloud may be divided into regions and processed. In addition, in dividing the point cloud into regions, an option of generating a different neighbor point set for each region may be configured, such that low complexity is obtained although the reliability of the result is somewhat low, or that high reliability is obtained although the complexity is high. In other words, a different configuration may be established according to the processing capacity of the reception device.

Therefore, in an embodiment, when the point cloud is divided into tiles, a different duplicated point processing option may be applied to each tile.

In another embodiment, when the point cloud is divided into slices, a different duplicated point processing option may be applied to each slice.

In another embodiment, the sub_voxel_partition_flag information and the sub-voxel occupancy bits may be added to and signaled in geometry node of the geometry slice data.

A field, which is a term used in syntaxes of the present disclosure described below, may have the same meaning as a parameter or element.

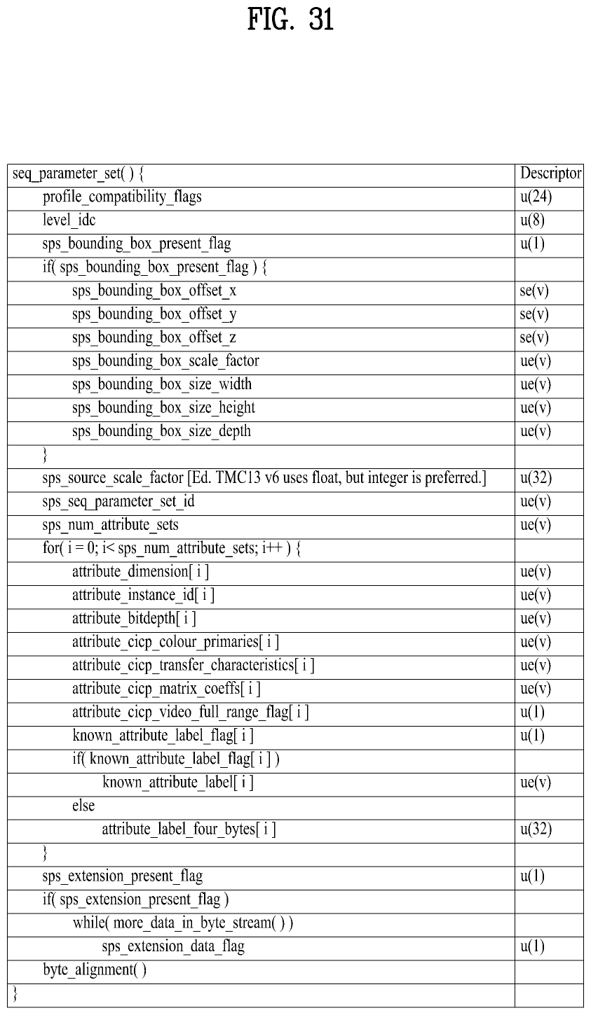

FIG. 31 shows an embodiment of a syntax structure of a sequence parameter set (SPS) (seq_parameter_set_rbsp( )) according to the present disclosure. The SPS according to embodiments may include sequence information about a point cloud data bitstream.

The SPS according to the embodiments may include a profile_idc field, a profile_compatibility_flags field, a level_idc field, an sps_bounding_box_present_flag field, an sps_source_scale_factor field, an sps_seq_parameter_set_id field, an sps_num_attribute_sets field, and an sps_extension_present_flag field.

The profile_idc field indicates a profile to which the bitstream conforms.

The profile_compatibility_flags field equal to 1 may indicate that the bitstream conforms to the profile indicated by profile_idc.

The level_idc field indicates a level to which the bitstream conforms.

The sps_bounding_box_present_flag field indicates whether source bounding box information is signaled in the SPS. The source bounding box information may include offset and size information about the source bounding box. For example, the sps_bounding_box_present_flag field equal to 1 indicates that the source bounding box information is signaled in the SPS. The sps_bounding_box_present_flag field equal to 0 indicates the source bounding box information is not signaled. The sps_source_scale_factor field indicates the scale factor of the source point cloud.

The sps_seq_parameter_set_id field provides an identifier for the SPS for reference by other syntax elements.

The sps_num_attribute_sets field indicates the number of coded attributes in the bitstream.

The sps_extension_present_flag field specifies whether the sps_extension_data syntax structure is present in the SPS syntax structure. For example, the sps_extension_present_flag field equal to 1 specifies that the sps_extension_data syntax structure is present in the SPS syntax structure. The sps_extension_present_flag field equal to 0 specifies that this syntax structure is not present. When not present, the value of the sps_extension_present_flag field is inferred to be equal to 0.

When the sps_bounding_box_present_flag field is equal to 1, the SPS according to embodiments may further include an sps_bounding_box_offset_x field, an sps_bounding_box_offset_y field, an sps_bounding_box_offset_z field, an sps_bounding_box_scale_factor field, an sps_bounding_box_size_width field, an sps_bounding_box_size_height field, and an sps_bounding_box_size_depth field.

The sps_bounding_box_offset_x field indicates the x offset of the source bounding box in the Cartesian coordinates. When the x offset of the source bounding box is not present, the value of sps_bounding_box_offset_x is 0.

The sps_bounding_box_offset_y field indicates the y offset of the source bounding box in the Cartesian coordinates. When the y offset of the source bounding box is not present, the value of sps_bounding_box_offset_y is 0.

The sps_bounding_box_offset_z field indicates the z offset of the source bounding box in the Cartesian coordinates. When the z offset of the source bounding box is not present, the value of sps_bounding_box_offset_z is 0.

The sps_bounding_box_scale_factor field indicates the scale factor of the source bounding box in the Cartesian coordinates. When the scale factor of the source bounding box is not present, the value of sps_bounding_box_scale_factor may be 1.

The sps_bounding_box_size_width field indicates the width of the source bounding box in the Cartesian coordinates. When the width of the source bounding box is not present, the value of the sps_bounding_box_size_width field may be 1.

The sps_bounding_box_size_height field indicates the height of the source bounding box in the Cartesian coordinates. When the height of the source bounding box is not present, the value of the sps_bounding_box_size_height field may be 1.

The sps_bounding_box_size_depth field indicates the depth of the source bounding box in the Cartesian coordinates. When the depth of the source bounding box is not present, the value of the sps_bounding_box_size_depth field may be 1.

The SPS according to embodiments includes an iteration statement repeated as many times as the value of the sps_num_attribute_sets field. In an embodiment, i is initialized to 0, and is incremented by 1 each time the iteration statement is executed. The iteration statement is repeated until the value of i becomes equal to the value of the sps_num_attribute_sets field. The iteration statement may include an attribute dimension[i] field, an attribute_instance_id[i] field, an attribute_bitdepth[i] field, an attribute_cicp_colour_primaries[i] field, an attribute_cicp_transfer_characteristics[i] field, an attribute_cicp_matrix_coeffs[i] field, an attribute_cicp_video_full_range_flag[i] field, and a known_attribute_label_flag[i] field.

The attribute_dimension[i] field specifies the number of components of the i-th attribute.

The attribute_instance_id[i] field specifies the instance ID of the i-th attribute.

The attribute_bitdepth[i] field specifies the bitdepth of the i-th attribute signal(s).

The attribute_cicp_colour_primaries[i] field indicates chromaticity coordinates of the color attribute source primaries of the i-th attribute.

The attribute_cicp_transfer_characteristics[i] field either indicates the reference opto-electronic transfer characteristic function of the colour attribute as a function of a source input linear optical intensity with a nominal real-valued range of 0 to 1 or indicates the inverse of the reference electro-optical transfer characteristic function as a function of an output linear optical intensity.

The attribute_cicp_matrix_coeffs[i] field describes the matrix coefficients used in deriving luma and chroma signals from the green, blue, and red, or Y, Z, and X primaries.

The attribute_cicp_video_full_range_flag[i] field indicates the black level and range of the luma and chroma signals as derived from ET, E′PB, and E′PR or E′R, E′G, and E′B real-valued component signals.

The known_attribute_label_flag[i] field specifies whether a known attribute label field or an attribute label four bytes field is signaled for the i-th attribute. For example, the value of the known_attribute_label_flag[i] field equal to 0 specifies that the known attribute label field is signaled for the ith attribute. The known_attribute_label_flag[i] field equal to 1 specifies that the attribute_label_four_bytes field is signaled for the ith attribute.

The known_attribute_label[i] field may specify an attribute type. For example, the known_attribute_label[i] field equal to 0 may specify that the i-th attribute is color. The known_attribute_label[i] field equal to 1 specifies that the i-th attribute is reflectance. The known_attribute_label[i] field equal to 2 may specify that the i-th attribute is frame index.

The attribute_label_four_bytes field indicates the known attribute type with a 4-byte code.

In this example, the attribute_label_four_bytes field indicates color when equal to 0 and indicates reflectance when is equal to 1.

According to embodiments, when the sps_extension_present_flag field is equal to 1, the SPS may further include a sps_extension_data_flag field.

The sps_extension_data_flag field may have any value.

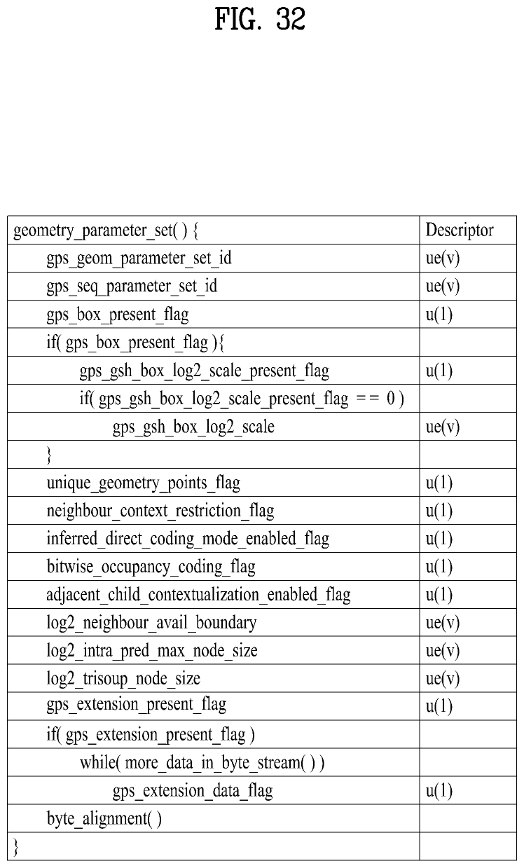

FIG. 32 shows an embodiment of a syntax structure of the geometry parameter set (GPS) (geometry_parameter_set( )) according to the present disclosure. The GPS according to the embodiments may contain information on a method of encoding geometry information about point cloud data contained in one or more slices.

According to embodiments, the GPS may include a gps_geom_parameter_set_id field, a gps_seq_parameter_set_id field, a gps_box_present_flag field, a unique_geometry_points_flag field, a neighbour_context_restriction_flag field, an inferred_direct_coding_mode_enabled_flag field, a bitwise_occupancy_coding_flag field, an adjacent_child_contextualization_enabled_flag field, a log 2_neighbour_avail_boundary field, a log 2_intra_pred_max_node_size field, a log 2_trisoup_node_size field, and a gps_extension_present_flag field.

The gps_geom_parameter_set_id field provides an identifier for the GPS for reference by other syntax elements.

The gps_seq_parameter_set_id field specifies the value of sps_seq_parameter_set_id for the active SPS.

The gps_box_present_flag field specifies whether additional bounding box information is provided in a geometry slice header that references the current GPS. For example, the gps_box_present_flag field equal to 1 may specify that additional bounding box information is provided in a geometry header that references the current GPS. Accordingly, when the gps_box_present_flag field is equal to 1, the GPS may further include a gps_gsh_box_log 2_scale_present_flag field.

The gps_gsh_box_log 2_scale_present_flag field specifies whether the gps_gsh_box_log 2_scale field is signaled in each geometry slice header that references the current GPS. For example, the gps_gsh_box_log 2_scale_present_flag field equal to 1 may specify that the gps_gsh_box_log 2_scale field is signaled in each geometry slice header that references the current GPS. As another example, the gps_gsh_box_log 2_scale_present_flag field equal to 0 may specify that the gps_gsh_box_log 2_scale field is not signaled in each geometry slice header and a common scale for all slices is signaled in the gps_gsh_box_log 2_scale field of the current GPS.

When the gps_gsh_box_log 2_scale_present_flag field is equal to 0, the GPS may further include a gps_gsh_box_log 2_scale field.

The gps_gsh_box_log 2_scale field indicates the common scale factor of the bounding box origin for all slices that refer to the current GPS.

The unique_geometry_points_flag field indicates whether all output points have unique positions. For example, the unique_geometry_points_flag field equal to 1 indicates that all output points have unique positions. The unique_geometry_points_flag field equal to 0 indicates that in all slices that refer to the current GPS, the two or more of the output points may have the same position.

The neighbor context restriction flag field indicates contexts used for octree occupancy coding. For example, the neighbour_context_restriction_flag field equal to 0 indicates that octree occupancy coding uses contexts determined from six neighboring parent nodes. The neighbour_context_restriction_flag field equal to 1 indicates that octree occupancy coding uses contexts determined from sibling nodes only.

The inferred_direct_coding_mode_enabled_flag field indicates whether the direct_mode_flag field is present in the geometry node syntax. For example, the inferred_direct_coding_mode_enabled_flag field equal to 1 indicates that the direct_mode_flag field may be present in the geometry node syntax. For example, the inferred_direct_coding_mode_enabled_flag field equal to 0 indicates that the direct_mode_flag field is not present in the geometry node syntax.

The bitwise_occupancy_coding_flag field indicates whether geometry node occupancy is encoded using bitwise contextualization of the syntax element occupancy map. For example, the bitwise_occupancy_coding_flag field equal to 1 indicates that geometry node occupancy is encoded using bitwise contextualisation of the syntax element occupancy_map. For example, the bitwise_occupancy_coding_flag field equal to 0 indicates that geometry node occupancy is encoded using the dictionary encoded syntax element occupancy_byte.

The adjacent_child_contextualization_enabled_flag field indicates whether the adjacent children of neighboring octree nodes are used for bitwise occupancy contextualization. For example, the adjacent_child_contextualization_enabled_flag field equal to 1 indicates that the adjacent children of neighboring octree nodes are used for bitwise occupancy contextualization. For example, adjacent_child_contextualization_enabled_flag equal to 0 indicates that the children of neighbouring octree nodes are not used for the occupancy contextualization.

The log 2_neighbour_avail_boundary field specifies the value of the variable NeighbAvailBoundary that is used in the decoding process as follows:

NeighbAvailBoundary=2^{log2_neighbour_avail_boundary}

For example, when the neighbour_context_restriction_flag field is equal to 1, NeighbAvailabilityMask may be set equal to 1. For example, when the neighbour_context_restriction_flag field is equal to 0, NeighbAvailabilityMask may be set equal to 1<<log 2_neighbour_avail_boundary.

The log 2_intra_pred_max_node_size field specifies the octree node size eligible for occupancy intra prediction.

The log 2_trisoup_node_size field specifies the variable TrisoupNodeSize as the size of the triangle nodes as follows.

TrisoupNodeSize=1<<log 2_trisoup_node_size

The gps_extension_present_flag field specifies whether the gps_extension_data syntax structure is present in the GPS syntax structure. For example, gps_extension_present_flag equal to 1 specifies that the gps_extension_data syntax structure is present in the GPS syntax. For example, gps_extension_present_flag equal to 0 specifies that this syntax structure is not present in the GPS syntax.

When the value of the gps_extension_present_flag field is equal to 1, the GPS according to the embodiments may further include a gps_extension_data_flag field.

The gps_extension_data_flag field may have any value. Its presence and value do not affect the decoder conformance to profiles.

The GPS according to the embodiments may further include duplicated point processing related option information. According to embodiments, the duplicated point processing related option information may include sub_voxel_partition_flag information, sub_voxel_partition_method, max_duplicated_point information, include_sub_voxel_for_attribute_coding_flag information, and sub_voxel_order_method.

According to embodiments, when the unique_geometry_points_flag is equal to 1, that is, all output points have unique positions, the GPS may further include sub_voxel_partition_flag information, sub_voxel_partition_method information, include_sub_voxel_for_attribute_coding_flag information, and sub_voxel_order_method information.

The sub_voxel_partition_flag information is related to whether to divide a voxel into one or more sub-voxels. According to embodiments, when the value of the sub_voxel_partition_flag information is 1, a voxel is divided into one or more sub-voxels. When the value is 0, it may specify that a voxel is not divided into one or more sub-voxels. In another embodiment, the sub_voxel_partition_flag information may specify whether a voxel has been divided into one or more sub-voxels.

The sub_voxel_partition_method information specifies a partitioning method used to partition a voxel into one or more sub-voxels. According to embodiments, when the value of the sub_voxel_partition_method information is 1, it may specify that binary tree partitioning is used. When value is 2, it may specify that quadtree partitioning is used. When the value is 3, it may specify that octree partitioning is used.

The include_sub_voxel_for_attribute_coding_flag information specifies whether to apply the points of a sub-voxel to attribute encoding. According to embodiments, when the value of the include_sub_voxel_for_attribute_coding_flag information is 1, it may specify that the points of the sub-voxel are applied to the attribute encoding. When the value is 0, it may specify that the points of the sub-voxel are not applied to the attribute encoding.

The sub_voxel_order_method information may specify a sorting method for sub-voxels. According to embodiments, when the value of the sub_voxel_order_method information is 1, it may specify that sorting according to the Morton code generation scheme is used. When the value is 2, it may specify that sorting according to the octree occupancy bit generation order is used. When the value is 3, it may specify that sorting according to top-to-bottom, left-to-right, or front-to-back order is used. In an embodiment, the sub_voxel_order_method information may specify a method related to an order in which the sub-voxels are added to a point list. Thus, it may affect sorting in Morton code order in the attribute encoding.

As such, the sub_voxel_partition_flag information, the sub_voxel_partition_method information, the include_sub_voxel_for_attribute_coding_flag information, and the sub_voxel_order_method information may be signaled in the GPS.

The GPS according to embodiments may further include at least one of the maximum number of points that may be included in a voxel and the maximum number of points that may be included in a sub-voxel.

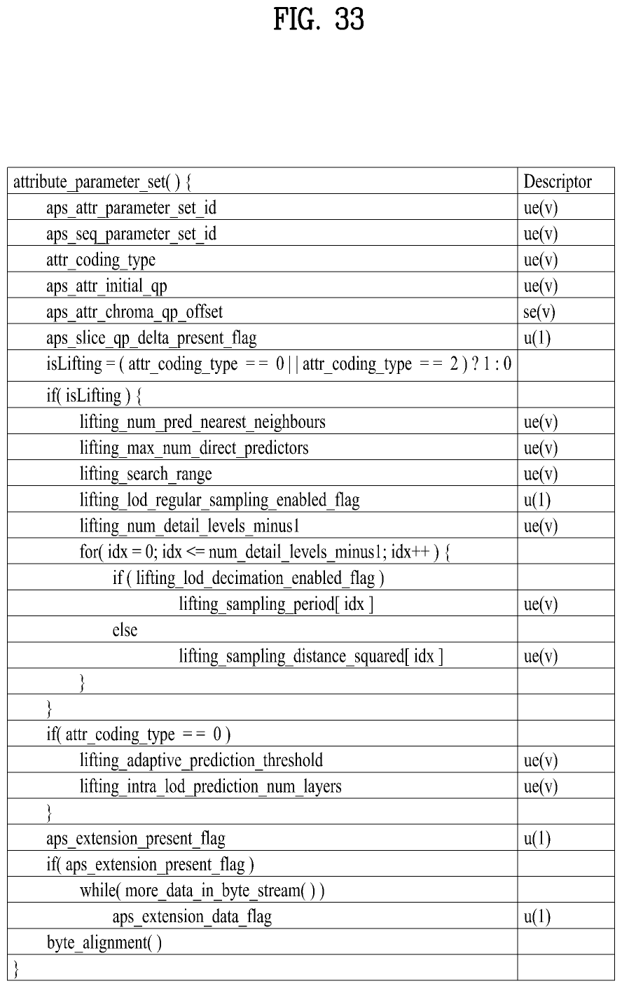

FIG. 33 shows an embodiment of a syntax structure of the attribute parameter set (APS) (attribute parameter set( )) according to the present disclosure. The APS according to the embodiments may contain information on a method of encoding attribute information in point cloud data contained in one or more slices.

The APS according to the embodiments may include an aps_attr_parameter_set_id field, an aps_seq_parameter_set_id field, an attr_coding_type field, an aps_attr_initial_qp field, an aps_attr_chroma_qp_offset field, an aps_slice_qp_delta_present_flag field, and an aps_flag field.

The aps_attr_parameter_set_id field provides an identifier for the APS for reference by other syntax elements.

The aps seq_parameter_set_id field specifies the value of sps_seq_parameter_set_id for the active SPS.

The attr_coding_type field indicates the coding type for the attribute.

In this example, the attr_coding_type field equal to 0 indicates predicting weight lifting as the coding type. The attr_coding_type field equal to 1 indicates RAHT as the coding type. The attr_coding_type field equal to 2 indicates fix weight lifting.

The aps_attr_initial_qp field specifies the initial value of the variable SliceQp for each slice referring to the APS. The initial value of SliceQp is modified at the attribute slice segment layer when a non-zero value of slice_qp_delta_luma or slice_qp_delta_luma are decoded

The aps_attr_chroma_qp_offset field specifies the offsets to the initial quantization parameter signaled by the syntax aps_attr_initial_qp.

The aps slice_qp_delta_present_flag field specifies whether the ash_attr_qp_delta_luma and ash_attr_qp_delta_chroma syntax elements are present in the attribute slice header (ASH). For example, the aps slice_qp_delta_present_flag field equal to 1 specifies that the ash_attr_qp_delta_luma and ash_attr_qp_delta_chroma syntax elements are present in the ASH. For example, the aps slice_qp_delta_present_flag field equal to 0 specifies that the ash_attr_qp_delta_luma and ash_attr_qp_delta_chroma syntax elements are not present in the ASH.

When the value of the attr_coding_type field is 0 or 2, that is, the coding type is predicting weight lifting or fix weight lifting, the APS according to the embodiments may further include a lifting_num_pred_nearest_neighbours field, a lifting_max_num_direct_predictors [symbol] , a lifting_search_range field, a lifting_lod_regular_sampling_enabled_flag field, a lifting_num_detail_levels_minus1 field, and attribute_pred_residual_separate_encoding_flag field.

The lifting_num_pred_nearest_neighbours field specifies the maximum number of nearest neighbors to be used for prediction.

The lifting_max_num_direct_predictors field specifies the maximum number of predictors to be used for direct prediction. The value of the variable MaxNumPredictors that is used in the decoding process as follows:

MaxNumPredictors=lifting_max_num_direct_predictors field+1

The lifting_lifting_search_range field specifies the search range used to determine nearest neighbors to be used for prediction and to build distance-based levels of detail.

The lifting_num_detail_levels_minus1 field specifies the number of levels of detail for the attribute coding.

The lifting_lod_regular_sampling_enabled_flag field specifies whether levels of detail (LOD) are built by a regular sampling strategy. For example, the lifting_lod_regular_sampling_enabled_flag equal to 1 specifies that levels of detail (LOD) are built by using a regular sampling strategy. The lifting_lod_regular_sampling_enabled_flag equal to 0 specifies that a distance-based sampling strategy is used instead.

The APS according to embodiments includes an iteration statement repeated as many times as the value of the lifting_num_detail_levels_minus1 field. In an embodiment, the index (idx) is initialized to 0 and incremented by 1 every time the iteration statement is executed, and the iteration statement is repeated until the index (idx) is greater than the value of the lifting_num_detail_levels_minus1 field. This iteration statement may include a lifting_sampling_period[idx] field when the value of the lifting_lod_decimation_enabled flag field is true (e.g., 1), and may include a lifting sampling distance squared[idx] field when the value of the lifting_lod_decimation_enabled flag field is false (e.g., 0).

The lifting_sampling_period[idx] field specifies the sampling period for the level of detail idx.

The lifting_sampling_distance_squared[idx] field specifies the square of the sampling distance for the level of detail idx.

When the value of the attr_coding_type field is 0, that is, when the coding type is predicting weight lifting, the APS according to the embodiments may further include a lifting_adaptive_prediction_threshold field, and a lifting_intra_lod_prediction_num_layers field.

The lifting_adaptive_prediction_threshold field specifies the threshold to enable adaptive prediction.

The lifting_intra_lod_prediction_num_layers field specifies the number of LOD layers where decoded points in the same LOD layer could be referred to generate a prediction value of a target point. For example, the lifting_intra_lod_prediction_num_layers field equal to num_detail_levels_minus1 plus 1 indicates that target point could refer to decoded points in the same LOD layer for all LOD layers. For example, the lifting_intra_lod_prediction_num_layers field equal to 0 indicates that target point could not refer to decoded points in the same LoD layer for any LoD layers.

The aps_extension_present_flag field specifies whether the aps_extension_data syntax structure is present in the APS syntax structure. For example, the aps_extension_present_flag field equal to 1 specifies that the aps_extension_data syntax structure is present in the APS syntax structure. For example, the aps_extension_present_flag field equal to 0 specifies that this syntax structure is not present in the APS syntax structure.

When the value of the aps_extension_present_flag field is 1, the APS according to the embodiments may further include an aps_extension_data flag field.

The aps_extension_data flag field may have any value. Its presence and value do not affect decoder conformance to profiles.

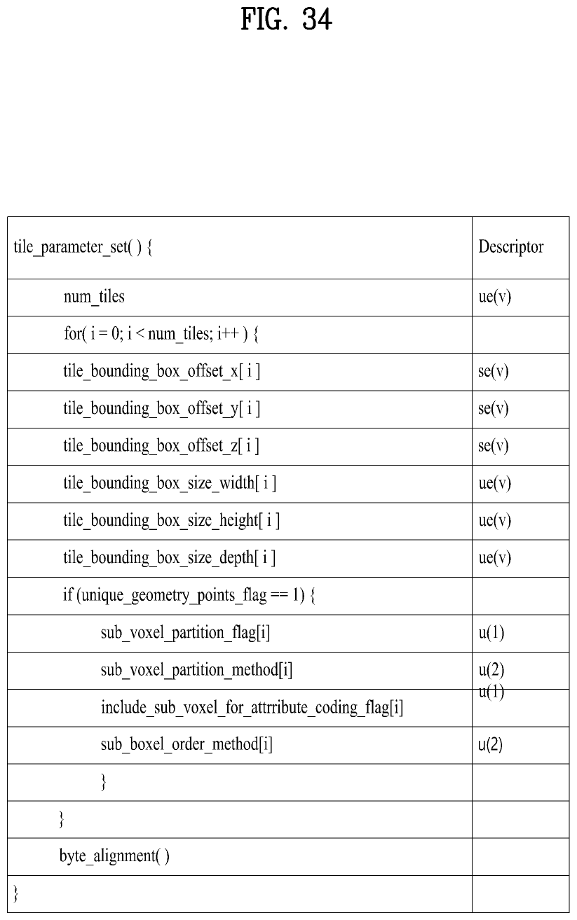

FIG. 34 shows an embodiment of a syntax structure of a tile parameter set (TPS) (tile_parameter_set( )) according to the present disclosure. According to embodiments, a TPS may be referred to as a tile inventory. The TPS according to the embodiments includes information related to each tile. In particular, in this example, the TPS includes duplicated point process related option information.

The TPS according to the embodiments includes a num_tiles field.

The num_tiles field indicates the number of tiles signaled for the bitstream. When not present, num_tiles is inferred to be 0.

The TPS according to the embodiments includes an iteration statement repeated as many times as the value of the num_tiles field. In an embodiment, i is initialized to 0, and is incremented by 1 each time the iteration statement is executed. The iteration statement is repeated until the value of i becomes equal to the value of the num_tiles field. The iteration statement may include a tile_bounding_box_offset_x[i] field, a tile_bounding_box_offset_y[i] field, a tile_bounding_box_offset_z[i] field, a tile_bounding_box_size_width[i] field, a tile_bounding_box_size_height[i] field, a tile_bounding_box_size_depth[i] field, and attribute_pred_residual_separate_encoding_flag[i] field.

The tile_bounding_box_offset_x[i] field indicates the x offset of the i-th tile in the Cartesian coordinates.

The tile_bounding_box_offset_y[i] field indicates the y offset of the i-th tile in the Cartesian coordinates.

The tile_bounding_box_offset_z[i] field indicates the z offset of the i-th tile in the Cartesian coordinates.

The tile_bounding_box_size_width[i] field indicates the width of the i-th tile in the Cartesian coordinates.

The tile_bounding_box_size_height[i] field indicates the height of the i-th tile in the Cartesian coordinates.

The tile_bounding_box_size_depth[i] field indicates the depth of the i-th tile in the Cartesian coordinates.

The iteration statement of the TPS according to the embodiments may further include duplicated point processing related option information. According to embodiments, the duplicated point processing related option information may include sub_voxel_partition_flag information, sub_voxel_partition_method, max_duplicated_point information, include_sub_voxel_for_attribute_coding_flag information, and sub_voxel_order_method.

According to embodiments, when unique_geometry_points_flag is equal to 1, that is, all output points have unique positions, the i-th tile of the TPS may further include includes sub_voxel_partition_flag[i], a sub_voxel_partition_method[i], an include_sub_voxel_for_attribute_coding_flag[i], and a sub_voxel_order_method[i].

According to embodiments, the unique_geometry_points_flag may be signaled in the GPS and/or the TPS.

sub_voxel_partition_flag[i] specifies whether to divide a voxel in the i-th tile into one or more sub-voxels. According to embodiments, when the value of the sub_voxel_partition_flag[i] is 1, it may specify that the voxel is divided into one or more sub-voxels. When the value is 0, it may specify that the voxel is not divided into one or more sub-voxels. In another embodiment, sub_voxel_partition_flag[i] may specify whether a voxel in the i-th tile is divided into one or more sub-voxels.

sub_voxel_partition_method[i] specifies a partitioning method used to partition a voxel in the i-th tile into one or more sub-voxels. According to embodiments, when the value of sub_voxel_partition_method[i] is 1, it may specify that binary tree partitioning is used. When the value is 2, it may specify that quadtree partitioning is used. When the value is 3, it may specify that octree partitioning is used.

include_sub_voxel_for_attribute_coding_flag[i] specifies whether to apply the points of a sub-voxel in the i-th tile to attribute encoding. According to embodiments, when the value of include_sub_voxel_for_attribute_coding_flag[i] is 1, it may specify that the points of the sub-voxel are applied to the attribute encoding. When the value is 0, it may specify that the points of the sub-voxel are not applied to the attribute encoding.

sub_voxel_order_method[i] may specify a sorting method of sub-voxels in the i-th tile. According to embodiments, when the value of sub_voxel_order_method[i] is 1, it may specify that sorting according to the Morton code generation scheme is used. When the value is 2, it may specify that sorting according to the octree occupancy bit generation order is used. When the value is 3, it may specify that sorting according to top-to-bottom, left-to-right, or front-to-back order is used. In an embodiment, sub_voxel_order_method field specify a method related to an order in which the sub-voxels are added to a point list. Thus, it may affect sorting in Morton code order in attribute encoding of the i-th tile.

As such, the sub_voxel_partition_flag[i], the sub_voxel_partition_method[i], the include_sub_voxel_for_attribute_coding_flag[i], and the sub_voxel_order_method[i] may be signaled in the TPS.

The TPS according to embodiments may further include at least one of the maximum number of points that may be included in a voxel and the maximum number of points that may be included in a sub-voxel.

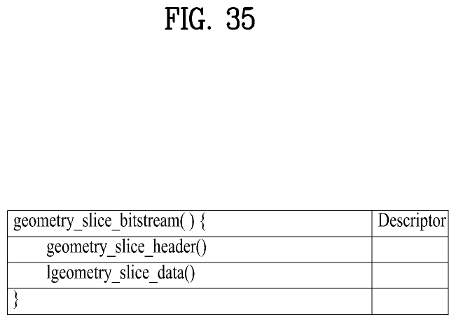

FIG. 35 shows an embodiment of a syntax structure of a geometry slice bitstream( ) according to the present disclosure.

The geometry slice bitstream (geometry_slice_bitstream( )) according to the embodiments may include a geometry slice header (geometry_slice_header( )) and geometry slice data (geometry_slice_data( )).

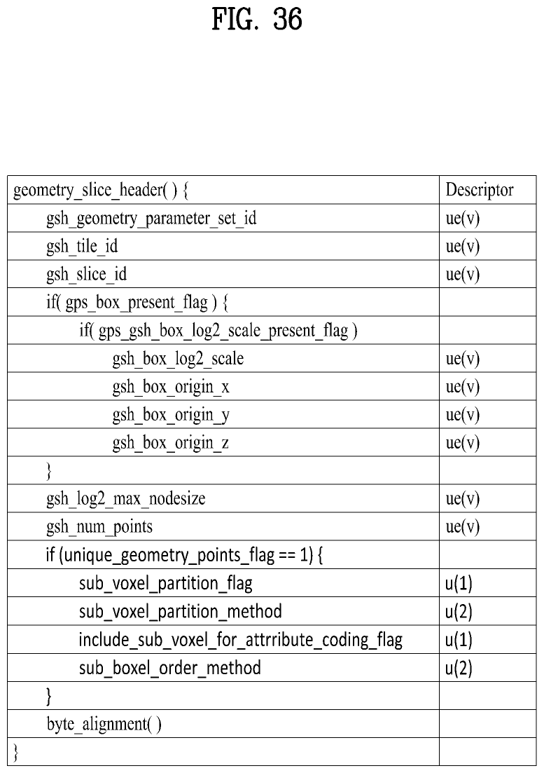

FIG. 36 shows an embodiment of a syntax structure of the geometry slice header (geometry_slice_header( )) according to the present disclosure.

A bitstream transmitted by the transmission device (or a bitstream received by the reception device) according to the embodiments may contain one or more slices. Each slice may include a geometry slice and an attribute slice. The geometry slice includes a geometry slice header (GSH). The attribute slice includes an attribute slice header (ASH).

The geometry slice header (geometry_slice_header( )) according to embodiments may include a gsh_geom_parameter_set_id field, a gsh_tile_id field, a gsh_slice_id field, a gsh_max_node_size_log 2 field, a gsh_num_points field, and a byte_alignment( )) field.

When the value of the gps_box_present_flag field included in the GPS is ‘true’ (e.g., 1), and the value of the gps_gsh_box_log 2 scale_present_flag field is ‘true’ (e.g., 1), the geometry slice header (geometry_slice_header( )) according to the embodiments may further include a gsh_box_log 2 scale field, a gsh_box_origin_x field, a gsh_box_origin_y field, and a gsh_box_origin_z field.

The gsh_geom_parameter_set_id field specifies the value of the gps_geom_parameter_set_id of the active GPS.

The gsh_tile_id field specifies the value of the tile id that is referred to by the GSH.

The gsh_slice_id specifies id of the slice for reference by other syntax elements.

The gsh_box_log 2_scale field specifies the scaling factor of the bounding box origin for the slice.

The gsh_box_origin_x field specifies the x value of the bounding box origin scaled by the value of the gsh_box_log 2_scale field.

The gsh_box_origin_y field specifies the y value of the bounding box origin scaled by the value of the gsh_box_log 2_scale field.

The gsh_box_origin_z field specifies the z value of the bounding box origin scaled by the value of the gsh_box_log 2_scale field.

The gsh_max_node_size_log 2 field specifies a size of a root geometry octree node.

The gsh_points_number field specifies the number of coded points in the slice.

The GSH according to the embodiments may further include duplicated point processing related option information. According to embodiments, the duplicated point processing related option information may include sub_voxel_partition_flag information, sub_voxel_partition_method, max_duplicated_point information, include_sub_voxel_for_attribute_coding_flag information, and sub_voxel_order_method.

According to embodiments, when the unique_geometry_points_flag is equal to 1, that is, all output points have unique positions, the GSH may further include sub_voxel_partition_flag information, sub_voxel_partition_method information, include_sub_voxel_for_attribute_coding_flag information, and sub_voxel_order_method information.

According to embodiments, unique_geometry_points_flag may be signaled in the GPS and/or the GSH.

The sub_voxel_partition_flag information is related to whether to divide a voxel into one or more sub-voxels in the slice. According to embodiments, when the value of the sub_voxel_partition_flag information is 1, a voxel is divided into one or more sub-voxels. When the value is 0, it may specify that a voxel is not divided into one or more sub-voxels. In another embodiment, the sub_voxel_partition_flag information may specify whether a voxel has been divided into one or more sub-voxels in the slice.

The sub_voxel_partition_method information specifies a partitioning method used to partition a voxel into one or more sub-voxels in the slice. According to embodiments, when the value of the sub_voxel_partition_method information is 1, it may specify that binary tree partitioning is used. When value is 2, it may specify that quadtree partitioning is used. When the value is 3, it may specify that octree partitioning is used.

The include_sub_voxel_for_attribute_coding_flag information specifies whether to apply the points of a sub-voxel in the slice to attribute encoding. According to embodiments, when the value of the include_sub_voxel_for_attribute_coding_flag information is 1, it may specify that the points of the sub-voxel are applied to the attribute encoding. When the value is 0, it may specify that the points of the sub-voxel are not applied to the attribute encoding.

The sub_voxel_order_method information may specify a sorting method for sub-voxels in the slice. According to embodiments, when the value of the sub_voxel_order_method information is 1, it may specify that sorting according to the Morton code generation scheme is used. When the value is 2, it may specify that sorting according to the octree occupancy bit generation order is used. When the value is 3, it may specify that sorting according to top-to-bottom, left-to-right, or front-to-back order is used. In an embodiment, the sub_voxel_order_method information may specify a method related to an order in which the sub-voxels are added to a point list. Thus, it may affect sorting in Morton code order in attribute encoding of the slice.

As such, the sub_voxel_partition_flag information, the sub_voxel_partition_method information, the include_sub_voxel_for_attribute_coding_flag information, and the sub_voxel_order_method information may be signaled in the GSH.

The GSH according to embodiments may further include at least one of the maximum number of points that may be included in a voxel and the maximum number of points that may be included in a sub-voxel.

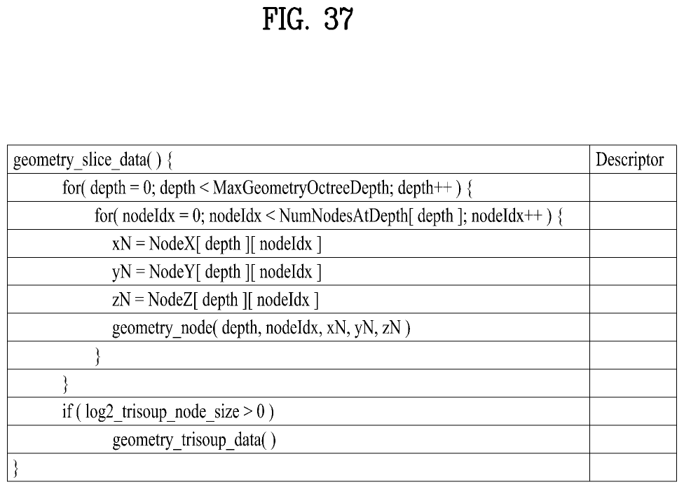

FIG. 37 shows an embodiment of a syntax structure of geometry slice data (geometry_slice_data( )) according to the present disclosure. The geometry slice data (geometry_slice_data( )) according to the embodiments may carry a geometry bitstream belonging to a corresponding slice.

The geometry_slice_data( ) according to the embodiments may include a first iteration statement repeated as many times as by the value of MaxGeometryOctreeDepth. In an embodiment, the depth is initialized to 0 and is incremented by 1 each time the iteration statement is executed, and the first iteration statement is repeated until the depth becomes equal to MaxGeometryOctreeDepth. The first iteration statement may include a second loop statement repeated as many times as the value of NumNodesAtDepth. In an embodiment, nodeidx is initialized to 0 and is incremented by 1 each time the iteration statement is executed. The second iteration statement is repeated until nodeidx becomes equal to NumNodesAtDepth. The second iteration statement may include xN=NodeX[depth][nodeIdx], yN=NodeY[depth][nodeIdx], zN=NodeZ[depth][nodeIdx], and geometry_node (depth, nodeIdx, xN, yN, zN). MaxGeometryOctreeDepth indicates the maximum value of the geometry octree depth, and NumNodesAtDepth[depth] indicates the number of nodes to be decoded at the corresponding depth. The variables NodeX[depth][nodeIdx], NodeY[depth][nodeIdx], and NodeZ[depth][nodeIdx] indicate the x, y, z coordinates of the nodeIdx-th node in decoding order at a given depth.

The geometry bitstream of the node of the depth is transmitted through geometry_node (depth, nodeIdx, xN, yN, zN).

The geometry_slice_data (geometry_slice_data( )) according to the embodiments may further include geometry_trisoup_data( ) when the value of the log 2_trisoup_node_size field is greater than 0. That is, when the size of the triangle nodes is greater than 0, a geometry bitstream subjected to trisoup geometry encoding is transmitted through geometry_trisoup_data( ).

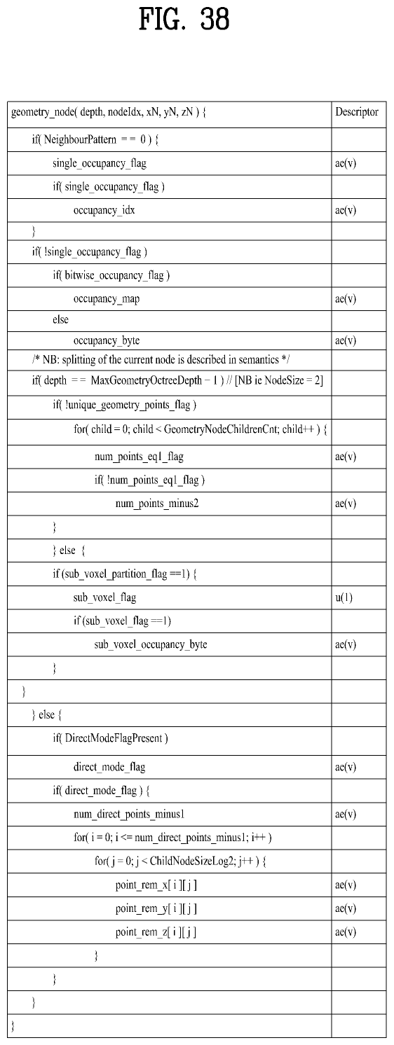

FIG. 38 illustrates an embodiment of a syntax structure of a bitstream of geometry_node (depth, nodeIdx, xN, yN, zN) of FIG. 37.

The geometry_node (depth, nodeIdx, xN, yN, zN) of FIG. 38 may include sub voxel flag information indicating whether sub-voxels are divided and sub-voxel occupancy bits.

The geometry_node (depth, nodeIdx, xN, yN, zN) may include at least one of single_occupancy_flag, occupancy_idx, occupancy_map, occupancy_byte, num_points_eq1_flag, num_points_minus2, sub_voxel_partition_flag, sub voxel occupancy_byte, direct_mode_flag, num_direct_points_minus1, point_rem_x[i][j], point_rem_y[i][j], and point_rem_z[i][j].

When NeighborPattern is 0, single_occupancy_flag may be included. single_occupancy_flag field indicates whether the current node contains a single child node. For example, single_occupancy_flag equal to 1 indicates that the current node contains a single child node. single_occupancy_flag equal to 0 indicates that the current node may contain multiple child nodes.

occupancy_idx may be further included according to the value of single_occupancy_flag. occupancy_idx identifies the index of the single occupied child of the current node in the geometry octree child node traversal order.

When the occupancy_idx is present, the following may be applied.

OccupancyMap=1<<occupancy_idx.

occupancy_map is a bitmap that identifies the occupied child nodes of the current node). When occupancy_map is present, the variable OccupancyMap is set equal to the output of the geometry occupancy_map permutation process when invoked with NeighbourPattern and occupancy_map as inputs.

occupancy_byte specifies a bitmap that identifies the occupied child nodes of the current node). When occupancy_byte is present, the variable OccupancyMap is set equal to the output of the geometry occupancy_map permutation process when invoked with NeighbourPattern and occupancy_map as inputs.

array GeometryNodeChildren[i] identifies the index of the i-th occupied child node of the current node.

The variable GeometryNodeChildrenCnt identifies the number of child nodes in the array GeometryNodeChildren[ ]).

num_points_eq1_flag indicates whether the current child node contains a single point. For example, num_points_eq1_flag equal to 1 indicates that the current child node contains a single point. num_points_eq1_flag equal to 0 indicates that the current child node contains at least two points. When num_points_eq1_flag is not present, the value of num_points_eq1_flag may be inferred to be equal to 1.

num_points_minus2 indicates the number of points represented by the current child node.

According to embodiments, when sub_voxel_partition_flag is equal to 1, geometry node (depth, nodeIdx, xN, yN, zN) may further include sub_voxel_flag.

sub_voxel_flag may indicate whether a voxel is divided into one or more sub-voxels. According to embodiments, sub_voxel_flag equal to 1 may indicate that the voxel is divided into one or more sub-voxels. sub_voxel_flag equal to 0 may indicate that the voxel is not divided into one or more sub-voxels.

When sub_voxel_flag field is equal to 1, sub_voxel_occupancy_byte may be further included.

sub_voxel_occupancy_byte specifies occupancy bits generated when a voxel is divided into one or more sub-voxels according to a partitioning method.

direct_mode_flag indicates whether a single child node of the current node is a leaf node and contains one or more delta point coordinates. For example, direct_mode_flag equal to 1 indicates that the single child node of the current node is a leaf node and contains one or more delta point coordinates. In another example, direct_mode_flag equal to 0 indicates that the single child node of the current node is an internal octree node. When direct_mode_flag is not present, the value of direct_mode_flag may be inferred to be equal to 0.

According to embodiments, when direct_mode_flag is equal to 0, the following configuration may be applied.

nodeIdx = NumNodesAtDepth[ depth + 1 ]
for( child = 0; child < GeometryNodeChildrenCnt; child++ ) {
childIdx = GeometryNodeChildren[ child ]
x = NodeX[ depth + 1 ][ nodeIdx ] = 2 × xN + ( childIdx & 4 = = 1)
y = NodeY[ depth + 1 ][ nodeIdx ] = 2 × yN + ( childIdx & 2 = = 1)
z = NodeZ[ depth + 1 ][ nodeIdx ] = 2 × zN + ( childIdx & 1 = = 1)
GeometryNodeOccupancyCnt[ depth + 1 ][ x ][ y ][ z ] = 1
nodeIdx++
}

NumNodesAtDepth[depth+1]=nodeIdx

num_direct_points_minus1 plus 1 indicates the number of points in the current child node.

point_rem_x[i][j], point_rem_y[i][j], and point_rem_z[i][j] indicate the j-th bit of the current child node's i-th point's respective x, y, and z coordinates relative to the origin of the child node identified by the index GeometryNodeChildren[0].

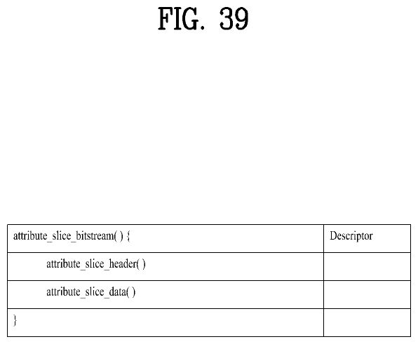

FIG. 39 shows an embodiment of a syntax structure of attribute slice bitstream( ) according to the present disclosure.

The attribute slice bitstream (attribute_slice_bitstream ( )) according to the embodiments may include an attribute slice header (attribute_slice_header( )) and attribute slice data (attribute_slice_data( )).

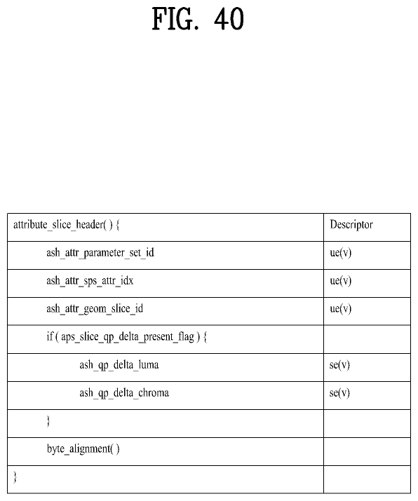

FIG. 40 shows an embodiment of a syntax structure of an attribute slice header (attribute slice header( )) according to the present disclosure. The attribute slice header according to the embodiments includes signaling information for a corresponding attribute slice.

The attribute slice header (attribute slice header( )) according to the embodiments may include an ash attr_parameter_set_id field, an ash_attr_sps_attr_idx field, and an ash_attr_geom_slice_id field.

When the value of the aps_slice_qp_delta_present_flag field of the APS is ‘true’ (e.g., 1), the attribute slice header (attribute slice header( )) according to the embodiments may further include an ash_qp_delta_luma field and an ash_qp_delta_chroma field.

The ash attr_parameter_set_id field specifies a value of the aps_attr_parameter_set_id field of the current active APS (e.g., the aps_attr_parameter_set_id field included in the APS described in FIG. 33).

The ash_attr_sps_attr_idx field identifies an attribute set in the current active SPS. The value of the ash_attr_sps_attr_idx field is in the range from 0 to the sps_num_attribute_sets field included in the current active SPS.

The ash_attr_geom_slice_id field specifies the value of the gsh_slice_id field of the current geometry_slice_header.

The ash_qp_delta_luma field specifies a luma delta quantization parameter (qp) derived from the initial slice qp in the active attribute parameter set.

The ash_qp_delta_chroma field specifies the chroma delta qp derived from the initial slice qp in the active attribute parameter set.

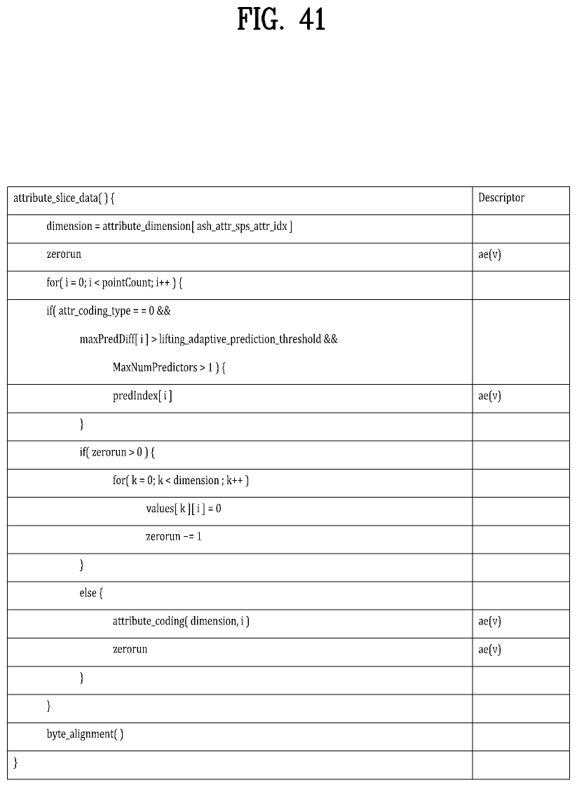

FIG. 41 shows an embodiment of a syntax structure of the attribute slice data (attribute_slice_data( )) according to the present disclosure. The attribute slice data (attribute_slice_data( )) according to the embodiments may carry an attribute bitstream belonging to a corresponding slice.

In the attribute slice data (attribute_slice_data( )) of FIG. 41, dimension=attribute_dimension[ash_attr_sps_attr_idx] represents the attribute dimension (attribute_dimension) of the attribute set identified by the ash_attr_sps_attr_idx field in the corresponding attribute slice header. The attribute_dimension refers to the number of components constituting an attribute. An attribute according to embodiments represent reflectance, color, or the like. Accordingly, the number of components varies among attributes. For example, an attribute corresponding to color may have three color components (e.g., RGB). Accordingly, an attribute corresponding to reflectance may be a mono-dimensional attribute, and the attribute corresponding to color may be a three-dimensional attribute.

The attributes according to the embodiments may be attribute-encoded on a dimension-by-dimension basis.

For example, the attribute corresponding to reflectance and the attribute corresponding to color may be attribute-encoded, respectively. According to embodiments, attributes may be attribute-encoded together regardless of dimensions. For example, the attribute corresponding to reflectance and the attribute corresponding to color may be attribute-encoded together.

In FIG. 41, zerorun specifies the number of 0 prior to residual.

In FIG. 41, i denotes an i-th point value of the attribute. According to an embodiment, the attr_coding_type field and the lifting_adaptive_prediction_threshold field are signaled in the APS.

MaxNumPredictors of FIG. 41 is a variable used in the point cloud data decoding process, and may be acquired based on the value of the lifting_adaptive_prediction_threshold field signaled in the APS as follows.

MaxNumPredictors=lifting_max_num_direct_predictors field+1

Here, the lifting_max_num_direct_predictors field indicates the maximum number of predictors to be used for direct prediction.

According to the embodiments, predIndex[i] specifies the predictor index (or prediction mode) to decode the i-th point value of the attribute. The value of predIndex[i] is in the range from 0 to the value of the lifting_max_num_direct_predictors field.

The variable MaxPredDiff[i] according to the embodiments may be calculated as follows.

minValue = max Value = ã₀
for (j = 0; j < k; j++) {
min Value = Min(min Value, ãⱼ)
max Value = Max(max Value, ãⱼ)
}
MaxPredDiff[i] = max Value − minValue;

Here, let kᵢ be the set of the k-nearest neighbors of the current point i and let [symbol] be their decoded/reconstructed attribute values. The number of nearest neighbors, kᵢ shall be in the range of 1 to lifting_num_pred_nearest_neighbours. According to embodiments, the decoded/reconstructed attribute values of neighbors are derived according to the Predictive Lifting decoding process.

The lifting_num_pred_nearest_neighbours field is signaled in the APS of FIG. 33 and indicates the maximum number of nearest neighbors to be used for prediction.

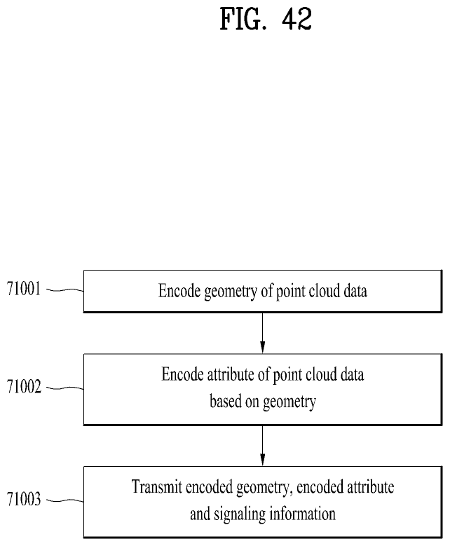

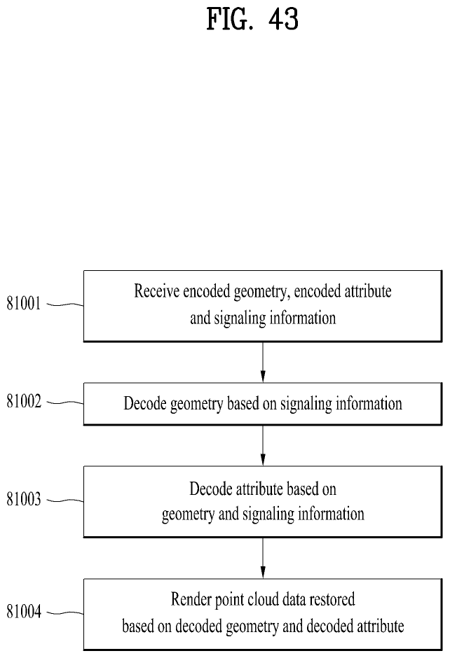

FIG. 42 is a flowchart of a method of transmitting point cloud data according to embodiments.

The point cloud data transmission method according to the embodiments may include a step 71001 of encoding geometry contained in the point cloud data, a step 71002 of encoding an attribute contained in the point cloud data based on input and/or reconstructed geometry, and a step 71003 of transmitting a bitstream including the encoded geometry, the encoded attribute, and signaling information.

The steps 71001 and 71002 of encoding the geometry and attribute contained in the point cloud data may perform some or all of the operations of the point cloud video encoder 10002 of FIG. 1, the encoding process 20001 of FIG. 2, the point cloud video encoder of FIG. 4, the point cloud video encoder of FIG. 12, the point cloud encoding process of FIG. 14, the point cloud video encoder of FIG. 15 or the geometry encoder and the attribute encoder of FIG. 17.

According to an embodiment, in step 71001 of encoding geometry, duplicated point merging is adaptively performed according to the number of points included in a voxel in merging a plurality of points included in the voxel. For example, when the current node is a leaf node and the number of duplicated points included in the voxel is greater than the maximum number of duplicated points that may be included in the voxel, the voxel is partitioned into one or more sub-voxels. In addition, in partitioning the voxel into one or more sub-voxels, one of a binary tree, a quadtree, or an octree may be used according to a sub-voxel partitioning method. According to embodiments, when the number of points belonging to a partitioned sub-voxel exceeds a threshold (i.e., the maximum number of duplicated points that may be included in one sub-voxel), the sub-voxel may be partitioned into one or more sub-voxels again. That is, sub-voxel partitioning and sub-voxel occupancy bit generation may be repeatedly performed until the number of points included in a sub-voxel is less than the threshold (that is, the maximum number of points that may be included in one sub-voxel).

According to embodiments, when the current node is a leaf node and the number of duplicated points included in the voxel is less than the maximum number of duplicated points that may be included in one voxel, the voxel is not partitioned into sub-voxels, and the points included in the voxel are merged into one point.

According to embodiments, when the current node is a leaf node and the number of duplicated points included in the voxel is greater than or equal to the maximum number of duplicated points that may be included in the voxel, the voxel is partitioned into one or more sub-voxels. In this case, when the number of points included in the partitioned sub-voxel is less than the maximum number of duplicated points that may be included in one sub-voxel, the points belonging to the sub-voxel are merged into one point.

According to embodiments, when the number of points included in the partitioned sub-voxel is greater than or equal to the maximum number of duplicated points that may be included in one sub-voxel, sub-voxel partitioning continues to be performed until the number of included points becomes less than the maximum number of duplicated points that may be included in one sub-voxel. Then, the points belonging to the last partitioned sub-voxel are merged into one point.

According to embodiments, in partitioning a voxel into one or more sub-voxels, one of sorting according to the Morton code generation scheme, sorting according to the octree occupancy bit generation order, or an arbitrary sorting method (e.g., top-to-bottom, left-to-right, or front-to-back order) may be selected and applied to the order of the sub-voxels. The sorting method according to the embodiments may also be applied when a sub-voxel is partitioned into one or more sub-voxels. In addition, a bitstream of occupancy bits indicating whether points are present in the sub-voxel in order of sorting according to the selected sorting method is transmitted.

According to embodiments, occupancy bits generated in the leaf node or the last node of the virtual tree are carried in the geometry slice data.

For the duplicated point processing described above, duplicated point processing related option information including the sub_voxel_partition_flag information, the sub-voxel_partition_method, the max_duplicated_point information, the include_sub_voxel_for_attribute_coding_flag information, and the sub_voxel_order_method may be provided. The duplicated point processing related option information may be included in at least one of the GPS, the TPS, the GSH, or the geometry_slice_data.

According to embodiments, when the node partitioned in the geometry encoding step 71001 is a leaf node and duplicated point merging and voxel partitioning are performed, additional geometry information may be generated and provided to the attribute encoding step 71002 according to whether to use sub-voxel information for encoding attribute information (i.e., include_sub_voxel_for_attribute_coding_flag information).

In generating the additional geometry information according to the embodiments, a position to which the additional geometry information is to be added may be determined according to a sub-voxel sorting method that is predefined (or included in the signaling information).

In an embodiment, in the attribute encoding step 71002, attribute encoding is performed based on the reconstructed geometry information (i.e., geometry information about a reconstructed voxel or geometry information about a reconstructed sub-voxel).

In steps 71001 and 71002 according to embodiments, encoding may be performed on the basis of a slice or a tile containing one or more slices.

Step 71003 may be performed by the transmitter 10003 of FIG. 1, the transmitting process 20002 of FIG. 2, transmission processor 12012 of FIG. 12 or transmission processor 51008 of FIG. 15.

FIG. 36 is a flowchart of a method of receiving point cloud data according to embodiments.

According to embodiments, a point cloud data reception method may include step 81001 of receiving encoded geometries, encoded attributes, and signaling information, step 81002 of decoding the geometries based on the signaling information, step 81003 of decoding the attributes based on the signaling information and the decoded/reconstructed geometries, and step 81004 of rendering point cloud data restored based on the decoded geometries and the decoded attributes.

Step 81001 according to embodiments may be performed by the receiver 10005 of FIG. 1, the transmitting process 20002 or the decoding process 20003 of FIG. 2, the receiver 13000 or the reception processor 13001 of FIG. 13 or the reception processor 61001 of FIG. 20.

In steps 81002 and 81003 according to embodiments, decoding may be performed on the basis of a slice or a tile containing one or more slices.

According to embodiments, step 81002 may perform some or all of the operations of the point cloud video decoder 10006 of FIG. 1, the decoding process 20003 of FIG. 2, the point cloud video decoder of FIG. 11, the point cloud video decoder of FIG. 13, the geometry decoder of FIG. 20 or the geometry decoder of FIG. 21.

According to embodiments, step 81003 may perform some or all of the operations of the point cloud video decoder 10006 of FIG. 1, the decoding process 20003 of FIG. 2, the point cloud video decoder of FIG. 11, the point cloud video decoder of FIG. 13, the attribute decoder of FIG. 20 or the attribute decoder of FIG. 21.

For duplicate point processing according to embodiments, signaling information, for example, at least one of a geometry parameter set, a tile parameter set, a geometry slice header, or geometry slice data may contain duplicated point processing related option information including sub_voxel_partition_flag information, sub_voxel_partition_method, max_duplicated_point information, include_sub_voxel_for_attribute_coding_flag information, and sub_voxel_order_method.

According to embodiments, in step 81002 of decoding geometry, voxels or sub-voxels are reconstructed based on voxel occupancy bits or sub-voxel occupancy bits based on the duplicated point processing related option information.

According to embodiments, geometry information is reconstructed by performing geometry information prediction using points acquired based on the reconstructed voxels or reconstructed sub-voxels. Inverse quantization and coordinates inverse transformation are performed based on the reconstructed geometry information to reconstruct the geometry information.

According to embodiments, the reconstructed geometry information provided to the attribute decoding step 81003 may or may not include the reconstructed sub-voxel geometry information depending on the include_sub_voxel_for_attribute_coding_flag information. According to embodiments, the reconstructed geometry information provided to the attribute decoding step 81003 includes the reconstructed sub-voxel geometry information when the value of the include_sub_voxel_for_attribute_coding_flag information is 1, and does not include the reconstructed sub-voxel geometry information when the value is 0.

According to embodiments, in the attribute decoding step 81003, LODs are generated using the voxel geometry information reconstructed based on the voxel occupancy bits or the sub-voxel geometry information reconstructed based on the sub-voxel occupancy bits. The Morton code-based sorting may also have an effect on the search for neighbor points in the attribute decoding step 81003. That is, in calculating the distance between points, the distance value may be calculated based on the non-rounded position value of the sub-voxel.

According to embodiments, in the attribute decoding step 81003, once LODs are generated and neighbor points are determined, a predicted attribute value of each point is obtained based on the prediction mode of each point, and attribute values of the points are restored by adding the predicted attribute value of each point to a received residual attribute value of the corresponding point. When the residual attribute values are zero run-coded, zero run-length decoding is performed. Then, attribute values of the points are restored by adding the predicted attribute value of each point to the residual attribute value of the corresponding point.

In the step 81004 of rendering the point cloud data according to the embodiments, the point cloud data may be rendered according to various rendering methods. For example, the points of the point cloud content may be rendered onto a vertex having a certain thickness, a cube of a specific minimum size centered on the vertex position, or a circle centered on the vertex position. All or part of the rendered point cloud content is provided to the user through a display (e.g. a VR/AR display, a general display, etc.).

The step 81004 according to the embodiments may be performed by the renderer 10007 of FIG. 1, the rendering process 20004 of FIG. 2, or the renderer 13011 of FIG. 13.

Each part, module, or unit described above may be a software, processor, or hardware part that executes successive procedures stored in a memory (or storage unit). Each of the steps described in the above embodiments may be performed by a processor, software, or hardware parts. Each module/block/unit described in the above embodiments may operate as a processor, software, or hardware. In addition, the methods presented by the embodiments may be executed as code. This code may be written on a processor readable storage medium and thus read by a processor provided by an apparatus.

In the specification, when a part “comprises” or “includes” an element, it means that the part further comprises or includes another element unless otherwise mentioned. Also, the term “ . . . module (or unit)” disclosed in the specification means a unit for processing at least one function or operation, and may be implemented by hardware, software or combination of hardware and software.

Although embodiments have been explained with reference to each of the accompanying drawings for simplicity, it is possible to design new embodiments by merging the embodiments illustrated in the accompanying drawings. If a recording medium readable by a computer, in which programs for executing the embodiments mentioned in the foregoing description are recorded, is designed by those skilled in the art, it may fall within the scope of the appended claims and their equivalents.

The apparatuses and methods may not be limited by the configurations and methods of the embodiments described above. The embodiments described above may be configured by being selectively combined with one another entirely or in part to enable various modifications.

Although preferred embodiments have been described with reference to the drawings, those skilled in the art will appreciate that various modifications and variations may be made in the embodiments without departing from the spirit or scope of the disclosure described in the appended claims. Such modifications are not to be understood individually from the technical idea or perspective of the embodiments.

Various elements of the apparatuses of the embodiments may be implemented by hardware, software, firmware, or a combination thereof. Various elements in the embodiments may be implemented by a single chip, for example, a single hardware circuit. According to embodiments, the components according to the embodiments may be implemented as separate chips, respectively. According to embodiments, at least one or more of the components of the apparatus according to the embodiments may include one or more processors capable of executing one or more programs. The one or more programs may perform any one or more of the operations/methods according to the embodiments or include instructions for performing the same. Executable instructions for performing the method/operations of the apparatus according to the embodiments may be stored in a non-transitory CRM or other computer program products configured to be executed by one or more processors, or may be stored in a transitory CRM or other computer program products configured to be executed by one or more processors. In addition, the memory according to the embodiments may be used as a concept covering not only volatile memories (e.g., RAM) but also nonvolatile memories, flash memories, and PROMs. In addition, it may also be implemented in the form of a carrier wave, such as transmission over the Internet. In addition, the processor-readable recording medium may be distributed to computer systems connected over a network such that the processor-readable code may be stored and executed in a distributed fashion.

In this specification, the term “I” and “,” should be interpreted as indicating “and/or.” For instance, the expression “A/B” may mean “A and/or B.” Further, “A, B” may mean “A and/or B.” Further, “A/B/C” may mean “at least one of A, B, and/or C.” Also, “A/B/C” may mean “at least one of A, B, and/or C.”

Further, in this specification, the term “or” should be interpreted as indicating “and/or.” For instance, the expression “A or B” may mean 1) only A, 2) only B, or 3) both A and B. In other words, the term “or” used in this document should be interpreted as indicating “additionally or alternatively.”

Various elements of the embodiments may be implemented by hardware, software, firmware, or a combination thereof. Various elements in the embodiments may be executed by a single chip such as a single hardware circuit. According to embodiments, the element may be selectively executed by separate chips, respectively. According to embodiments, at least one of the elements of the embodiments may be executed in one or more processors including instructions for performing operations according to the embodiments.

Terms such as first and second may be used to describe various elements of the embodiments. However, various components according to the embodiments should not be limited by the above terms. These terms are only used to distinguish one element from another. For example, a first user input signal may be referred to as a second user input signal. Similarly, the second user input signal may be referred to as a first user input signal. Use of these terms should be construed as not departing from the scope of the various embodiments. The first user input signal and the second user input signal are both user input signals, but do not mean the same user input signals unless context clearly dictates otherwise.

The terms used to describe the embodiments are used for the purpose of describing specific embodiments, and are not intended to limit the embodiments. As used in the description of the embodiments and in the claims, the singular forms “a”, “an”, and “the” include plural referents unless the context clearly dictates otherwise. The expression “and/or” is used to include all possible combinations of terms. The terms such as “includes” or “has” are intended to indicate existence of figures, numbers, steps, elements, and/or components and should be understood as not precluding possibility of existence of additional existence of figures, numbers, steps, elements, and/or components.

As used herein, conditional expressions such as “if” and “when” are not limited to an optional case and are intended to be interpreted, when a specific condition is satisfied, to perform the related operation or interpret the related definition according to the specific condition.

### MODE FOR INVENTION

As described above, related contents have been described in the best mode for carrying out the embodiments.

### INDUSTRIAL APPLICABILITY

It will be apparent to those skilled in the art that various modifications and variations can be made in the present embodiments without departing from the spirit or scope of the embodiments. Thus, it is intended that the embodiments cover the modifications and variations of the embodiments provided they come within the scope of the appended claims and their equivalents.

1. A method of transmitting point cloud data, the method comprising:
acquiring the point cloud data;
encoding geometry information of the point cloud data;
encoding attribute information of the point cloud data based on the geometry information; and
transmitting a bitstream containing the encoded geometry information, the encoded attribute information, and signaling information.

2. The method of claim 1, wherein the encoding of the geometry information comprises:
voxelizing the geometry information;
partitioning the voxel into sub-voxels according to a number of points included in the voxel when a plurality of points are included in a voxel through voxelization;
generating occupancy bits of the partitioned sub-voxels; and
reconstructing a geometry by performing geometry information prediction based on the generated occupancy bits.

3. The method of claim 2, wherein the encoding of the attribute information comprises:
generating levels of detail (LODs) by sorting all points of the reconstructed geometry based on a Morton code;
searching for neighbor points for each of the points based on the LODs;
acquiring a predicted attribute value of each of the points based on a prediction mode of each of the points; and
acquiring a residual attribute value based on the predicted attribute value and an original attribute value for each of the points.

4. The method of claim 3,
wherein the signaling information includes duplicated point processing related option information,
wherein the duplicated point processing related option information includes at least one of information for indicating whether the voxel is partitioned into the sub-voxels, information for indicating a partitioning method for the sub-voxels, information for indicating a sorting method for the sub-voxels, or information for indicating whether to apply points of the sub-voxels to attribute encoding.

5. The method of claim 4, wherein the signaling information including the duplicated point processing related option information is at least one of a geometry parameter set, a tile parameter set, or a geometry slice header.

6. An apparatus for transmitting point cloud data, the apparatus comprising:
an acquirer configured to acquire the point cloud data;
a geometry encoder configured to encode geometry information of the point cloud data;
an attribute encoder configured to encode attribute information of the point cloud data based on the geometry information; and
a transmitter configured to transmit a bitstream containing the encoded geometry information, the encoded attribute information, and signaling information.

7. The apparatus of claim 6, wherein the geometry encoder comprises:
a voxelization processor configured to voxelize the geometry information;
a partitioner configured to partition the voxel into sub-voxels according to a number of points included in the voxel when a plurality of points are included in a voxel through voxelization;
an occupancy bit generator configured to generate occupancy bits of the partitioned sub-voxels; and
a reconstructor configured to reconstruct a geometry by performing geometry information prediction based on the generated occupancy bits.

8. The apparatus of claim 7, wherein the attribute encoder comprises:
an LOD configurator configured to generate levels of detail (LODs) by sorting all points of the reconstructed geometry based on a Morton code;
a neighbor set configurator configured to search for neighbor points for each of the points based on the LODs;
an attribute information predictor configured to acquire a predicted attribute value of each of the points based on a prediction mode of each of the points; and
a residual attribute information acquirer configured to acquire a residual attribute value based on the predicted attribute value and an original attribute value for each of the points.

9. The apparatus of claim 8,
wherein the signaling information includes duplicated point processing related option information,
wherein the duplicated point processing related option information includes at least one of information for indicating whether the voxel is partitioned into the sub-voxels, information for indicating a partitioning method for the sub-voxels, information for indicating a sorting method for the sub-voxels, or information for indicating whether to apply points of the sub-voxels to attribute encoding.

10. The apparatus of claim 9, wherein the signaling information including the duplicated point processing related option information is at least one of a geometry parameter set, a tile parameter set, or a geometry slice header.

11. A method of receiving point cloud data, the method comprising:
receiving a bitstream containing geometry information, attribute information, and signaling information;
decoding the geometry information based on the signaling information;
decoding the attribute information based on the signaling information and the geometry information; and
rendering point cloud data restored based on the decoded geometry information and the decoded attribute information.

12. The method of claim 11, wherein the decoding of the geometry information comprises:
reconstructing points based on occupancy bits of received sub-voxels based on the signaling information; and
reconstructing a geometry by performing geometry information prediction based on the reconstructed points.

13. The method of claim 12, wherein the decoding of the attribute information comprises:
generating levels of detail (LODs) by sorting all points of the reconstructed geometry based on a Morton code;
searching for neighbor points for each of the points based on the LODs;
acquiring a predicted attribute value of each of the points based on a prediction mode of each of the points; and
restoring original attribute values based on the predicted attribute value of each of the points and received residual attribute values.

14. The method of claim 13, wherein the signaling information includes duplicated point processing related option information,
wherein the duplicated point processing related option information includes at least one of information for indicating whether the voxel is partitioned into the sub-voxels, information for indicating a partitioning method for the sub-voxels, information for indicating a sorting method for the sub-voxels, or information for indicating whether to apply points of the sub-voxels to attribute encoding.

15. The method of claim 14, wherein the signaling information including the duplicated point processing related option information is at least one of a geometry parameter set, a tile parameter set, or a geometry slice header.

16. An apparatus for receiving point cloud data, the apparatus comprising:
a receiver configured to receive a bitstream containing geometry information, attribute information, and signaling information;
a geometry decoder configured to decode the geometry information based on the signaling information;
an attribute decoder configured to decode the attribute information based on the signaling information and the geometry information; and
a renderer configured to render point cloud data restored based on the decoded geometry information and the decoded attribute information.

17. The apparatus of claim 16, wherein the geometry decoder comprises:
a point reconstructor configured to reconstruct points based on occupancy bits of received sub-voxels based on the signaling information; and
a geometry reconstructor configured to reconstruct a geometry by performing geometry information prediction based on the reconstructed points.

18. The apparatus of claim 17, wherein the attribute decoder comprises:
an LOD configurator configured to generate levels of detail (LODs) by sorting all points of the reconstructed geometry based on a Morton code;
a neighbor set configurator configured to search for neighbor points for each of the points based on the LODs;
an attribute information predictor configured to acquire a predicted attribute value of each of the points based on a prediction mode of each of the points; and
an attribute information restorer configured to restore original attribute values based on the predicted attribute value of each of the points and received residual attribute values.

19. The apparatus of claim 18, wherein the signaling information includes duplicated point processing related option information,
wherein the duplicated point processing related option information includes at least one of information for indicating whether the voxel is partitioned into the sub-voxels, information for indicating a partitioning method for the sub-voxels, information for indicating a sorting method for the sub-voxels, or information for indicating whether to apply points of the sub-voxels to attribute encoding.

20. The apparatus of claim 19, wherein the signaling information including the duplicated point processing related option information is at least one of a geometry parameter set, a tile parameter set, or a geometry slice header.
